(19) United States
(12) Patent Application Publication
(10) Pub. No.: US 2014/0180943 A1
(43) Pub. Date: Jun. 26, 2014

(54) System and Methods for Identifying Possible Associations and Monitoring Impacts of Actual Associations Between Synergistic Persons, Opportunities and Organizations

(71) Applicants: Duane B. Priddy, JR., Alpharetta, GA (US); Jeffrey C. Street, Suwanee, GA (US)

(72) Inventors: Duane B. Priddy, JR., Alpharetta, GA (US); Jeffrey C. Street, Suwanee, GA (US)

(21) Appl. No.: 14/137,960

(22) Filed: Dec. 20, 2013

Related U.S. Application Data
(60) Provisional application No. 61/740,387, filed on Dec. 20, 2012.

(51) Int. Cl. G06Q 50/00; G06Q 10/00

(52) U.S. Cl. CPC G06Q 50/01; G06Q 10/00
USPC 705/319

(57) ABSTRACT

A system, including apparatuses and methods, and a service employing such system for identifying opportunities and enabling persons to become associated with opportunities in which persons can make an impact, for identifying individual and collective synergies and commonalities between persons, opportunities, organizations, groups and partners, for capturing and monitoring the impact of persons associated in opportunities, and for visually presenting the impact of persons, opportunities, organizations, and the system through multi-level aggregation, or roll-up, of key performance indicator data. The system orders synergistic matches and permits user selection, via a slider control, of the extent of synergy to be used in selecting and displaying matches. The system also permits the custom weighting of key performance indicators, or metrics, by different users to account for the relative importance of various metrics to such different users.

### FIELD OF THE INVENTION

The present invention relates generally to the field of systems, including apparatuses and methods, for social networking and, more specifically, to systems for identifying individual and collective synergies and commonalities between persons, opportunities, organizations, and/or groups of the same for associating persons in collaborative opportunities where an impact can be made, and to capture, visualize and monitor the impacts of such associations.

### BACKGROUND

Many organizations, including businesses, churches, charities, or other types of associations where people come together, are ineffective at understanding people due to the multi-facets and complexities of human dynamics. As a consequence, such organizations have difficulty mobilizing people to participate in opportunities that are aligned with their interests. Traditionally, this is sometimes accomplished by direct interaction in a face to face conversation, requiring a person to be physically on location at a specific time. However, a person may not have established a comfort level for open dialog concerning their interests, or have enough time to convey the complexities of their background. And, capturing a person's interests and complexities in written form is often difficult and time-consuming for the organization trying to understand a person, regardless of whether the organization is associating and on-boarding a new person to the organization or a person who has been historically associated with the organization.

A person's interests and a person's synergies and commonalities with other persons, opportunities, and organizations may be characterized or determined, at least partially, using a large number of factors. Such factors may include, but not be limited to, one or more of the following: interests; hobbies; expertise; education; employment; industry; beliefs; problems; needs; human, team or organizational traits (as identified, expressed or determined, for example, through personality profiles, skills, strengths, and custom assessments); past and present involvement in organizations; experiences; geographical location; products; services; patents; technologies; innovations; ideas; financial (either need based or contributor based—for example, investor or donor); ethnicity; languages spoken; number of common factors or criteria; related connections with other people, organizations, or opportunities; and, the impact of other people, organizations, or opportunities. Unfortunately, this large number of factors has rendered the prediction of potential synergies, commonalities, and alignments by traditional methods inaccurate and unreliable.

Therefore, and as a result of the larger number of relevant factors and multiple layers of complexities, there is a need in the industry for a system, methods, and service for: easily associating people with opportunities and organizations who have commonalities for the purpose of new associations being formed; people to easily identify and assess, in a private manner, those other people, organizations and opportunities in which they might have an interest in learning more about, or eventually engaging; people, organizations or opportunities to easily identify synergies, commonalities or alignments with other people, organizations or opportunities, and to further narrow and refine the identified synergies, commonalities or alignments through the use of various criterion; people to see the impact of their individual contributions to an opportunity, that is further aggregated into an organization level, and eventually a global collective level; assessing the contributions of individuals to opportunities; enabling organizations to assess the contributions of opportunities comprised of individuals; enabling the global collective assessment of the contributions of organizations comprised of opportunities; and, that resolves these and other difficulties, shortcomings, and problems with current systems and methods.

### SUMMARY

Broadly described, the present invention comprises a system, including apparatuses and methods, and a service employing such system for identifying opportunities and enabling persons to become associated with opportunities in which persons can make an impact, for identifying individual and collective synergies and commonalities between persons, opportunities and organizations, for capturing and monitoring the impact of persons associated in opportunities, and for reporting on activities performed by persons so associated in a systematic manner that uniquely identifies the synergies, commonalities or alignments as a result of the collective summary for all of such activities.

Advantageously and according to example embodiment described herein, the system and methods thereof identify and associate persons with opportunities and organizations who have commonalities for the purpose of forming new associations. The system and methods also enable persons to easily identify and assess, in a private manner, those other persons, organizations and opportunities with whom they may be interested in learning more about, or eventually engaging or being associated with. Additionally, the system and methods identify the synergies, commonalities, or alignments of persons, organizations or opportunities with other persons, organizations or opportunities and are operable to employ user provided and other criteria to narrow the list of identified persons, organizations and opportunities having such synergies, commonalities or alignments. In addition, the system and methods capture impacts produced by persons on an opportunity, roll-up and aggregate and weight the impacts for opportunities and organizations, and visually present the individual, aggregated, and weighted impacts to allow assessment of the contributions of persons, opportunities and organizations.

Other advantages and benefits of the present invention will become apparent upon reading and understanding the present specification when taken in conjunction with the appended drawings.

### BRIEF DESCRIPTION OF THE DRAWINGS

FIG. 1 displays a pictorial representation of a relationship model of a system, in accordance with an example embodiment of the present invention, for identifying possible associations and for capturing and monitoring individual and collective global impacts of actual associations, between persons, opportunities and organizations having synergies, commonalities or alignments.

FIG. 2 displays a pictorial representation of possible synergistic associations including any two or more combinations between a person, opportunity, and organization in accordance with the example embodiment of the present invention.

FIG. 3 displays a logic diagram representation of the information technology and telecommunications structure of the system, according to the example embodiment of the present invention, and an environment therefore.

FIGS. 4A-29 display pictorial representations of member dashboard user interface pages of the system, according to the example embodiment of the present invention, that are used by the system to interact with members via their respective user devices and to receive, edit and display member data.

FIGS. 30-43 display pictorial representations of member user interface pages of the system, according to the example embodiment of the present invention, that are used by the system to interact with members or other users in order to initiate searches for synergistic matches with other members and to present search results and related information.

FIGS. 44-56 display pictorial representations of organization user interface pages of the system, according to the example embodiment of the present invention, that are used by the system to interact with members or other users in order to initiate searches for synergistic matches with organizations and to present search results and related information.

FIGS. 57-94 display opportunity user interface pages of the system, according to the example embodiment of the present invention, that are used the system to interact with members or other users in order to initiate searches for synergistic matches with opportunities and to present search results and related information.

FIGS. 95-96 display administration user interface pages of the system, according to the example embodiment of the present invention, that are used by the system to interact with system administrators in order to receive/edit organization data pertaining to organizations, and to post/establish opportunities and collect opportunity data related thereto.

FIG. 97 displays a pictorial representation of the data elements of member data related to members of the system, according to the example embodiment, that is received, created, stored, displayed, and/or manipulated by the system.

FIG. 98 displays a pictorial representation of the data elements of organization data related to organizations of the system, according to the example embodiment, that is received, created, stored, displayed, and/or manipulated by the system.

FIG. 99 displays a pictorial representation of the data elements of opportunity data related to opportunities of the system, according to the example embodiment, that is received, created, stored, displayed, and/or manipulated by the system.

FIG. 100 displays a pictorial representation of a sample privacy setting of the system and the effects thereof, according to the example embodiment of the present invention, on controlling the viewing of, and data for, a member, organization, or opportunity by a system user.

FIGS. 101A-101F display a flowchart representation of an operating method of the system according to the example embodiment of the present invention.

FIG. 102 displays a pictorial representation of a collective impact visualization, according to the example embodiment of the present invention, resulting from impacts of associations between persons, opportunities and organizations as evidenced by captured activities, learnings, and ideas.

FIG. 103 displays a pictorial representation of user interaction page of the system, according to an alternate embodiment of the present invention, showing the geographical locations of identified persons, opportunities, and/or organizations with related information.

### DETAILED DESCRIPTION OF THE DRAWINGS

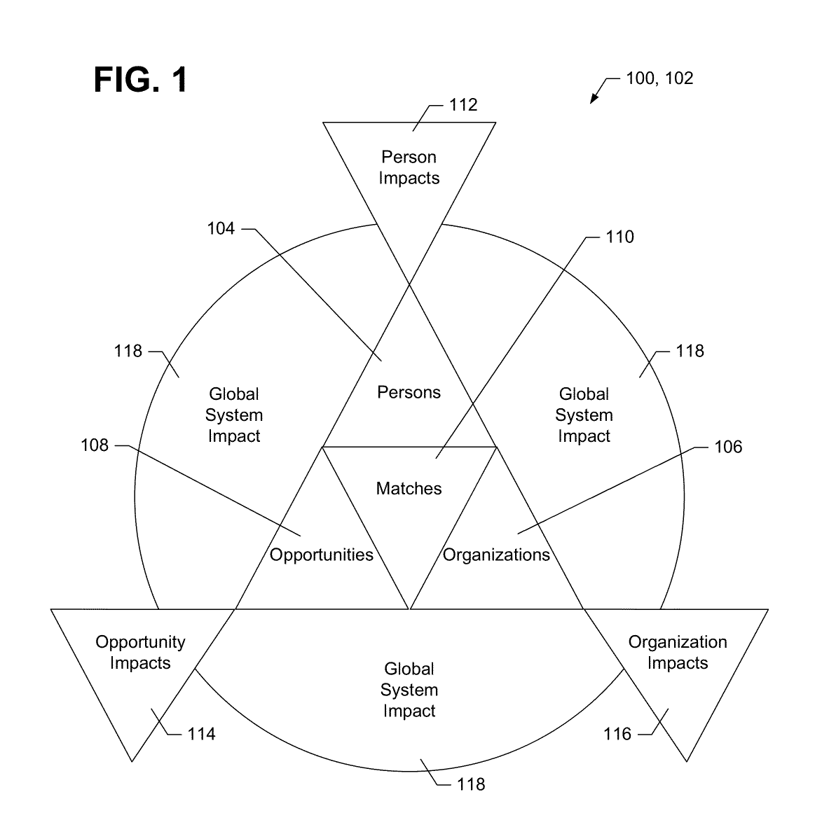

Referring now to the drawings in which like numerals represent like elements or steps throughout the several views, FIG. 1 displays a pictorial representation of a system for identifying possible associations and for capturing and monitoring individual and collective global impacts of actual associations between persons, opportunities and organizations having synergies, commonalities or alignments 100 (also referred to herein as the “system 100”) and a relationship model 102 created, used and implemented by the system 100 according to an example embodiment of the present invention described herein. The relationship model 102 includes persons 104, organizations 106, and opportunities 108. As used herein, the term “person” comprises a human of any race, nationality, or creed, and generally refers to someone who has provided information about themselves to the system 100. Persons 104 are, therefore, often also referred to herein synonymously as “members 104”. The term “organization” includes a place of business or industry, churches and religious establishments, charitable entities, governmental bodies, schools or academic organizations, neighborhoods, tradeshows, movements, or other associations or groups where persons come together or organize in either physical environments or virtual/online environments. For clarity, it should be understood that while organizations include groups or collections of persons 104, the term “groups” as used herein may also include collections of organizations 106, collections of opportunities 108, or a collection of persons 104, organizations 106 and/or opportunities 108. The term “opportunity” includes an initiative or movement where one or more people come together to carry out a task for the benefit of another person, organization, or new opportunity or project, in either physical environments or virtual/online environments. Opportunities or projects may either be in the same space and time within a physical location, or separated by space and time (for example and without limitation, internet related collaboration and teleconferencing). Opportunities may also be business benefit related and include, without limitation, a donor cause or investment idea, a training course, an online brainstorming event, and a meeting between people either in the form of a virtual online or physical meeting.

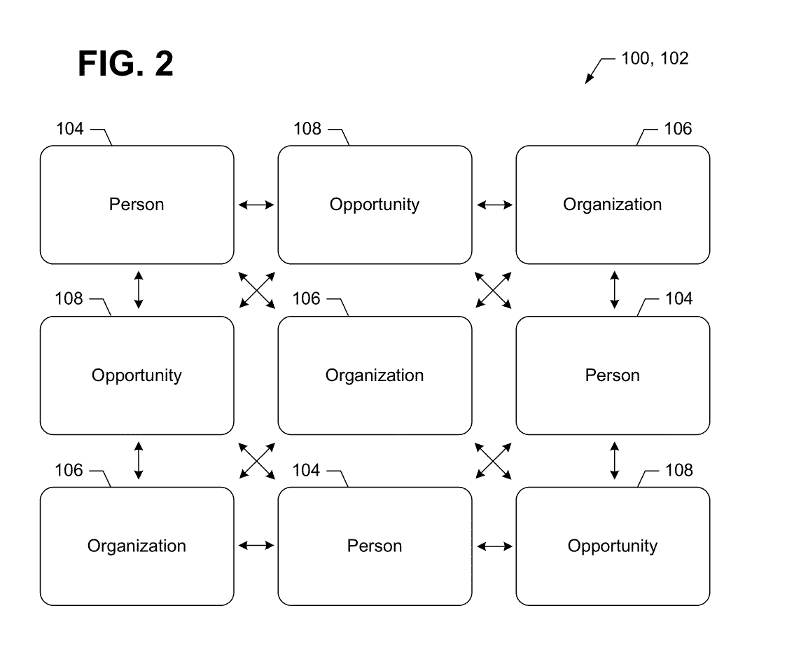

The system 100 evaluates the persons 104, organizations 106, and opportunities 108 and identifies certain persons 104, organizations 106, and/or opportunities 108 as having one or more synergies, commonalities, or alignments. Each combination of a person 104, organization 106, and/or opportunity 108 having at least one synergy, commonality, or alignment comprises a “match 110”. More particularly and as illustrated in FIG. 2, the system 100 searches for and matches (i) persons 104 with persons 104, (ii) persons 104 with organizations 106 or other groups, (iii) persons 104 with opportunities 108 or needs, and (iv) persons 104 with stories (and those persons 104, organizations 106 or groups involved in or associated with the events of such stories), having synergies, commonalities, or alignments. To do so, the system 100 collects and utilizes data describing certain pre-identified characteristics of persons 104, organizations 106, and opportunities 108, together with previously system-collected availability data for such persons 104 (generally, in the form of calendar date and/or time data indicating when such persons 104, organizations 106, and opportunities 108 are available for participation, involvement or engagement), previously system-collected or then present geographical location data indicating the geographical location of a person 104, organization 106, or opportunity 108, and/or other information optionally input by persons 104 at runtime. Together, the characteristics, availability, and geographical location comprise and are sometimes referred to herein as “classification tags” or “match tags”. According to the example embodiment, such classification tags may include, but not be limited to: interests; hobbies; expertise; education; employment; industry; beliefs; problems; needs; human, team or organizational traits (as identified, expressed or determined, for example, through personality profiles, skills, strengths, and custom assessments); past and present involvement in organizations; experiences; availability; geographical location; products; services; patents; technologies; innovations; ideas; financial (either need based or contributor based—for example, investor or donor); ethnicity; languages spoken; connections with other people, organizations, or opportunities; and, the impact of other people, organizations, or opportunities.

Referring back to FIG. 1, the system 100 also determines the extent, or degree, of synergy, commonality, or alignment in each match 110 and orders, or ranks, the identified matches 110 based on such extent, and dynamically presents such matches to a system user based on the extent of synergy, commonality, or alignment present in each match 110 and on received runtime user input identifying the extent of synergy, commonality, or alignment to be used in selecting matches 110 for display. After the system user is presented with and reviews more detailed information about the persons 104, organizations 106, or opportunities 108 related to the presented matches 110 and after the system 100 receives input from the system user identifying one or more synergistic persons 104, organizations 106, or opportunities 108 with which the user desires to engage, participate or join, the system 100 appropriately links the system user with such persons 104, organizations 106, or opportunities 108 and tracks the impact made by the user's participation (sometimes referred to herein as “person impact 112”) in opportunities 108 using key performance indicators, or metrics, established in advance. As used herein, the term “impact” includes, without limitation, a step or progress towards something new or improved, the capturing of the events or activities that occurred, or a measure of the benefit created.

Additionally, the system 100 aggregates the person impact 112 made on each opportunity 108 by each person 104 participating in the opportunity 108 to determine an “opportunity impact 114” for each opportunity 108. Similarly, the system 100 aggregates the opportunity impact 114 for all opportunities 108 of an organization 106 to determine an “organization impact 116” for each organization 106 participating in the system 100. In order to enable persons 104 and organizations 106 to assess person impacts 112 and organization impacts 116 (and the organization impacts 116 of an organization's partners) based on metrics that are most important to them, the system 100 is adapted to receive and track custom key performance indicators for each opportunity 108. In addition, the system 100 is adapted to receive different weighting factors from each person 104 and each organization 106 for application to the key performance indicators for an opportunity 108, and to determine person impacts 112 and organization impacts 114 by applying such received weighting factors to the actual key performance indicators tracked by the system 100. Because the weighting factors must total one hundred percent (100%), the resulting weighted key performance indicators are normalized. Further, the system 100 aggregates organization impacts 114 to determine a global impact 118 for the entire system 100.

Before proceeding further, it should also be understood and appreciated that the system 100 additionally supports “partners” comprising another person 104, organization 106, or group of persons 104 or organizations 106, and is capable of tracking, separating, consolidating, and presenting information and data related to partners, to opportunities 108 performed by or with partners, and to impacts produced by partners. From a business perspective, a partner may be thought of as and include a client, customer, or colleague, or a group of clients, customers or colleagues. In order to become a partner, the system 100 requires a person 104, organization 106, or group of persons 104 or organizations 106 to be “verified”, or endorsed, by another person 104 or organization 106 using the verification features of the system 100.

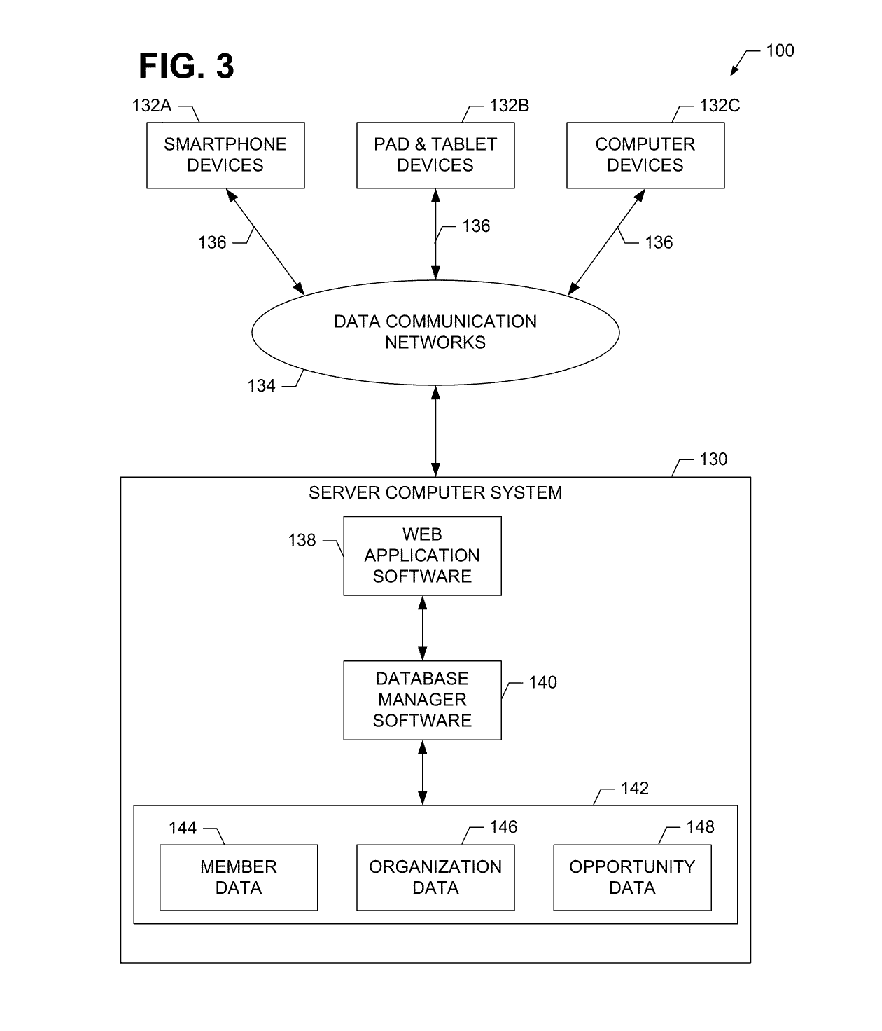

FIG. 3 displays a logic diagram representation of the information technology and telecommunications structure of the system 100 and an environment therefore according to the example embodiment described herein. As illustrated in FIG. 3, the system 100 comprises a server computer system 130 that bi-directionally communicates programming and/or data with user devices 132 via one or more data communication network(s) 134 and communication links 136 in order to implement the system's methods and functionality. The data communication network(s) 134 include networks having wired and/or wireless infrastructure and, generally, include the data communication network 134 commonly referred to as the Internet. The communication links 136 may comprise wired and/or wireless communication links using radio, optical, infrared, and/or other technologies available now or in the future.

According to the example embodiment, the user devices 132 include devices configured with web browser software that is operable to establish a bi-directional communication session with the server computer system 130, to receive programming from the server computer system 130 and execute the same in order to display web pages and related data and to perform other tasks, and to receive user input and communicate the same to the server computer system 130. In other embodiments, the user devices 132 include devices configured with native application software, or “apps”, that is operable to establish a bi-direction communication session with the server computer system 130, to display appropriate graphical user interface screens and data, to receive user input and communicate the same to the server computer system 130, and to perform other tasks. Additionally, the user devices 132 are adapted and operable to determine their then current geographical location and communicate data representative of such geographical location to the server computer system 130. To determine their then current geographical location, the user devices 132 may be equipped with and use global positioning system (GPS) hardware and software, or other hardware and software using, for example and not limitation, optical technology, beacon technology, Bluetooth technology, near-field technology, or other wired and/or wireless technology. Generally, such user devices 132 include, without limitation, smartphone devices 132A, pad and tablet devices 132B, and computer devices 132C such as wearable smart devices, desktop and laptop computers.

The server computer system 130 comprises hardware, software, and data configured to provide the functionality described herein and including, without limitation, to establish communication sessions with the user devices 132, to communicate programming and data with the user devices 132 via the data communication network(s) 134 and communication links 136, to determine the then current geographical location of a user device 132 based on a uniform resource locator (URL), to collect, store and retrieve data used by and within the system 100, and to provide the other functionality described herein. In accordance with the example embodiment, the hardware of the server computer system 130 may logically comprise one or more processing units, volatile and non-volatile memory, multiple data storage devices, and multiple communication interfaces. However, the server computer system 130 may physically comprise one or more server computers that are communicatively coupled to one another and to one or more data storage arrays.

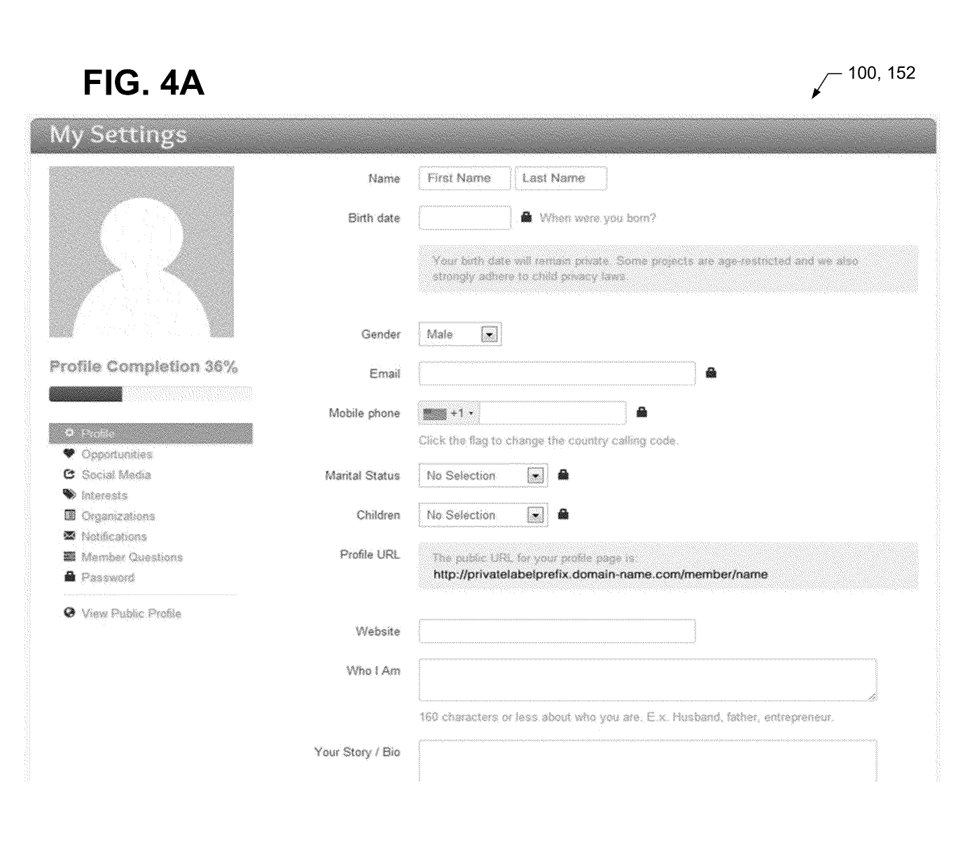

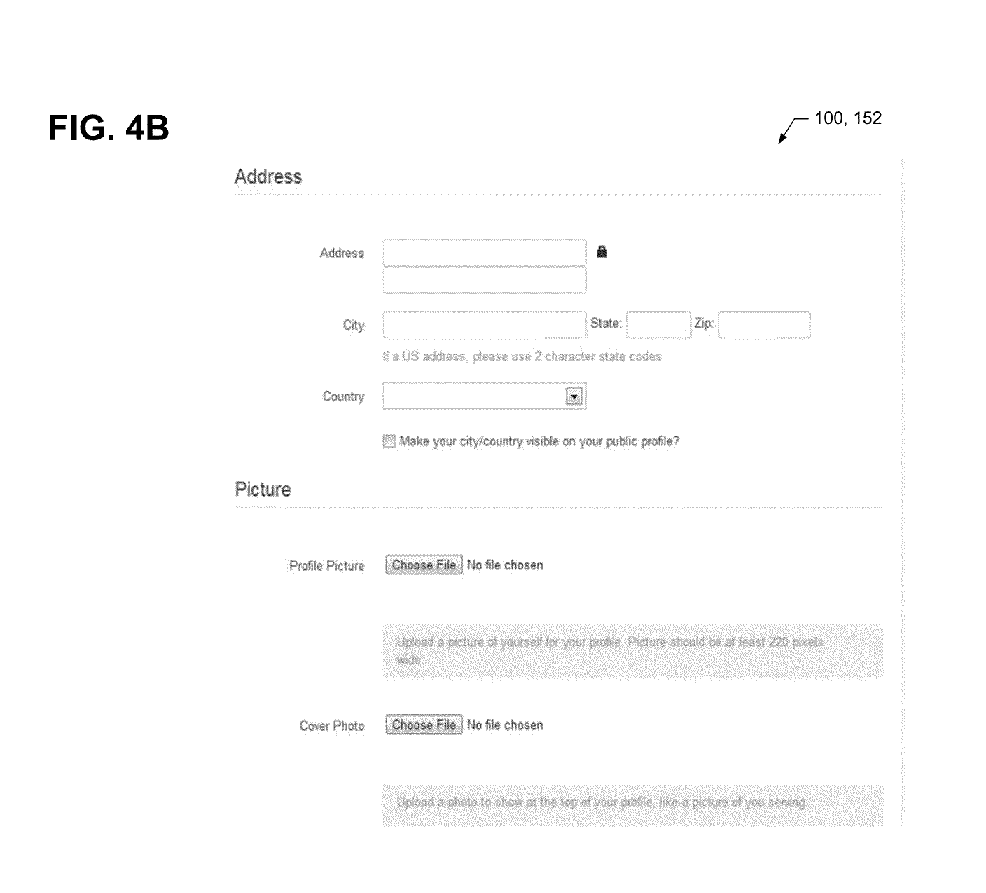

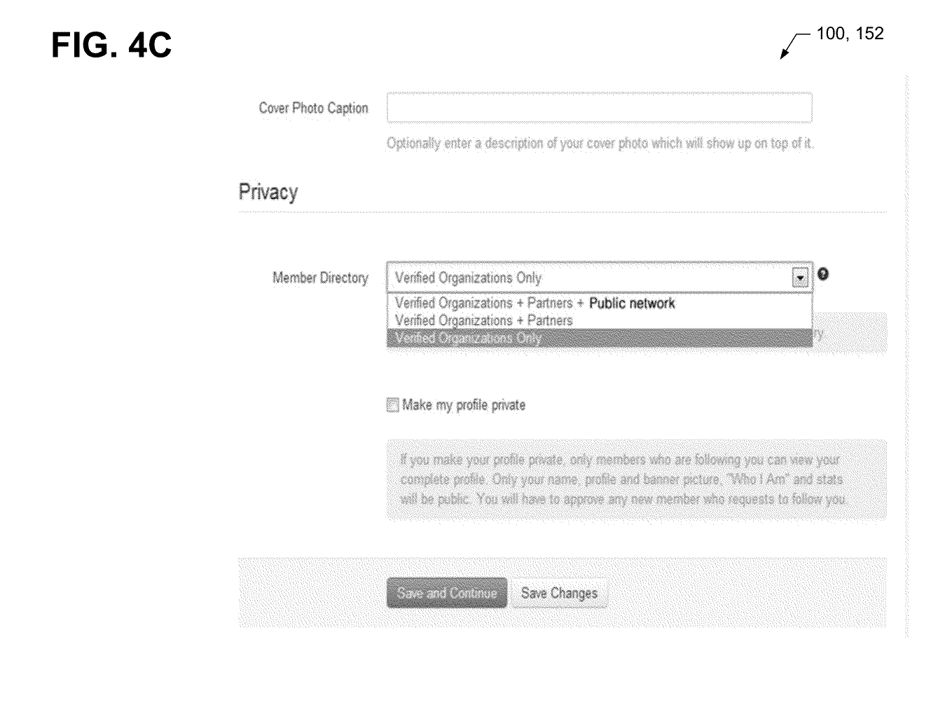

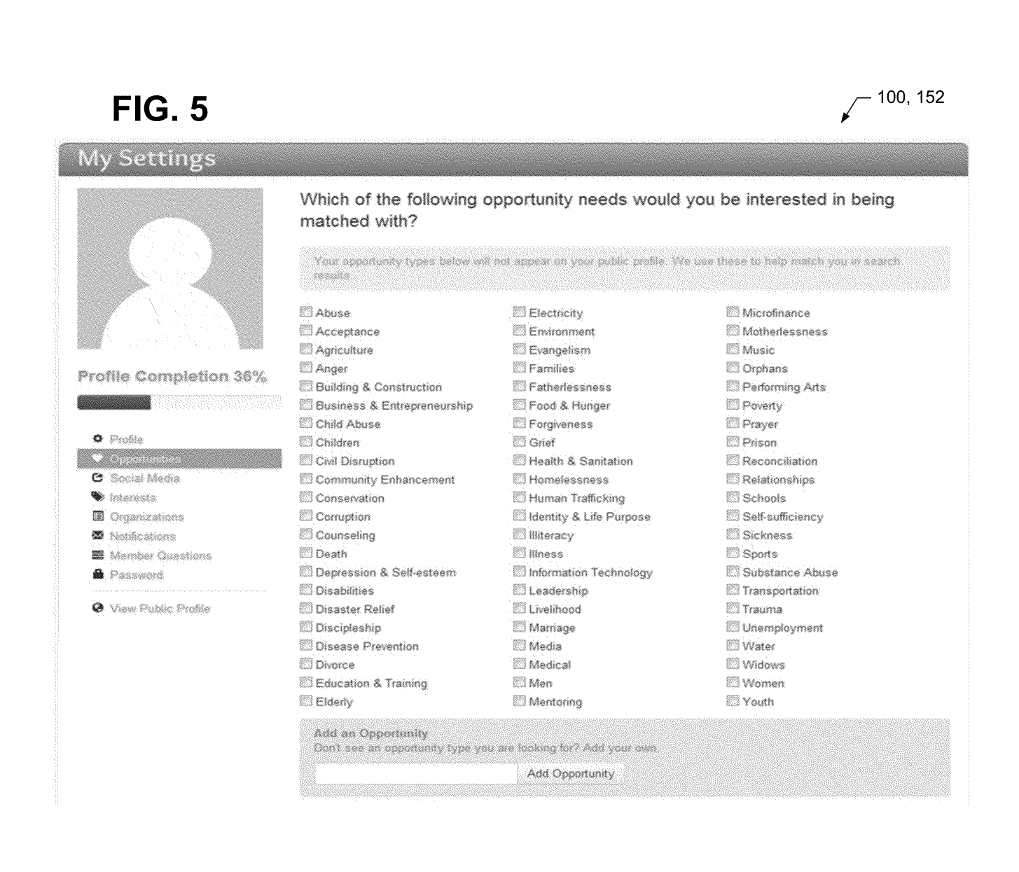

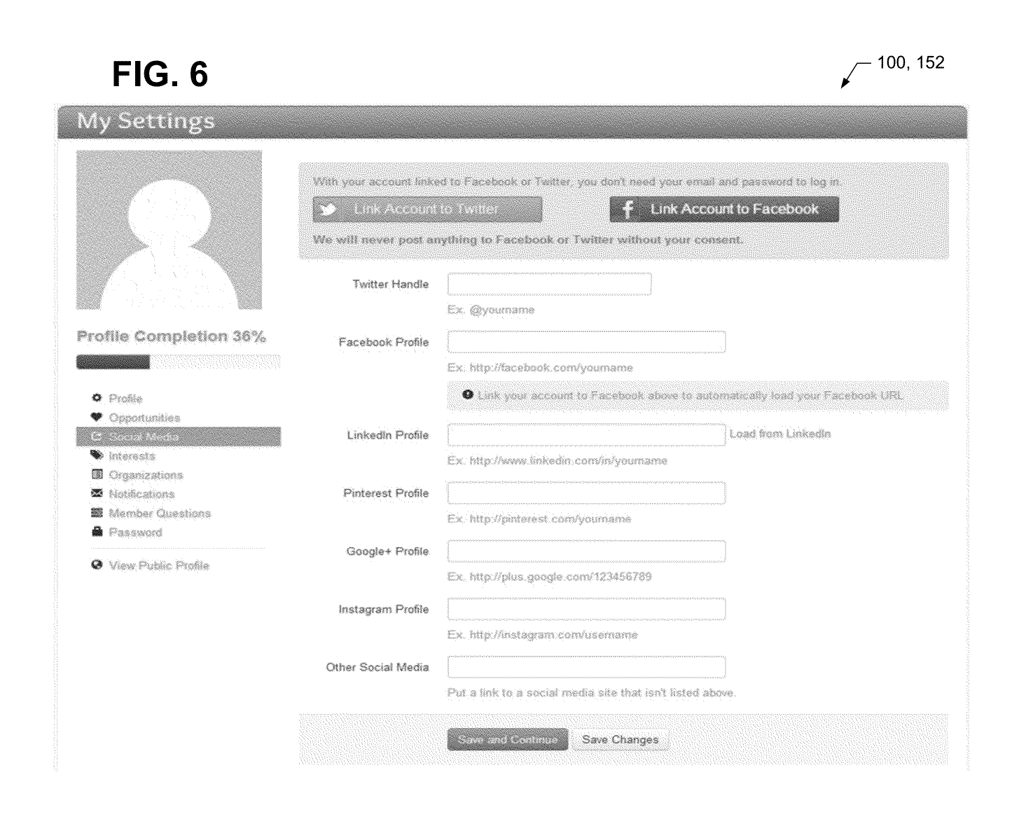

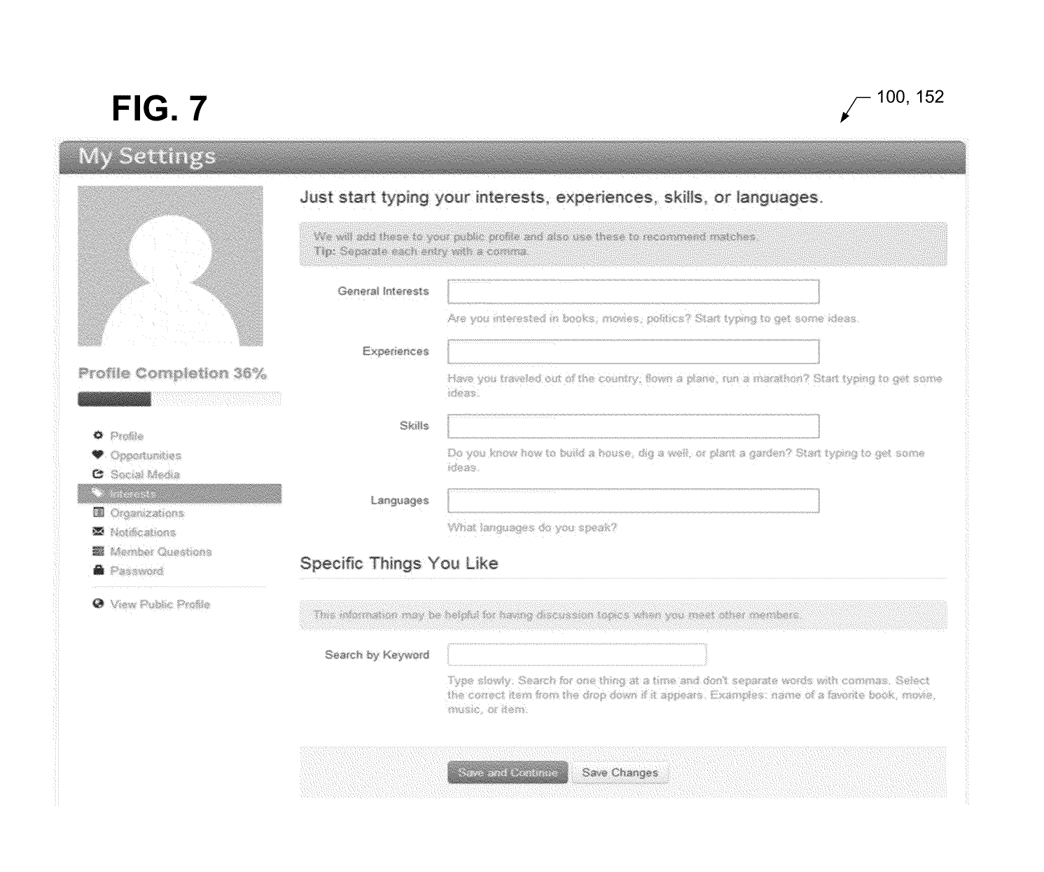

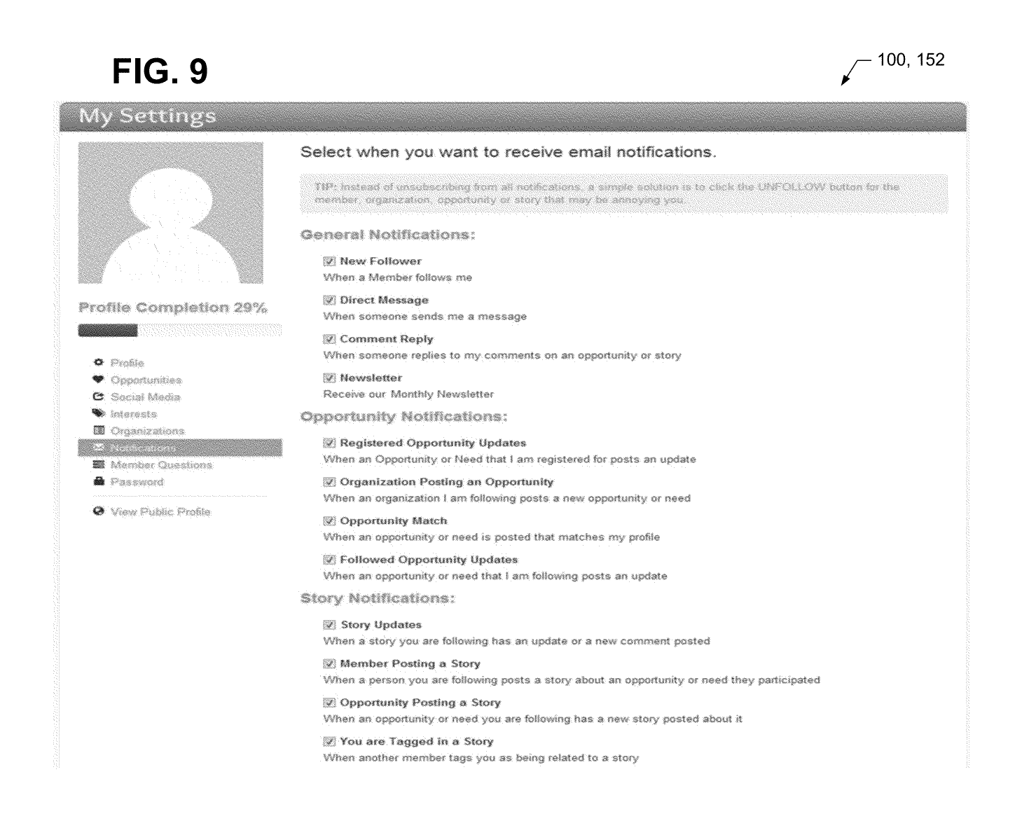

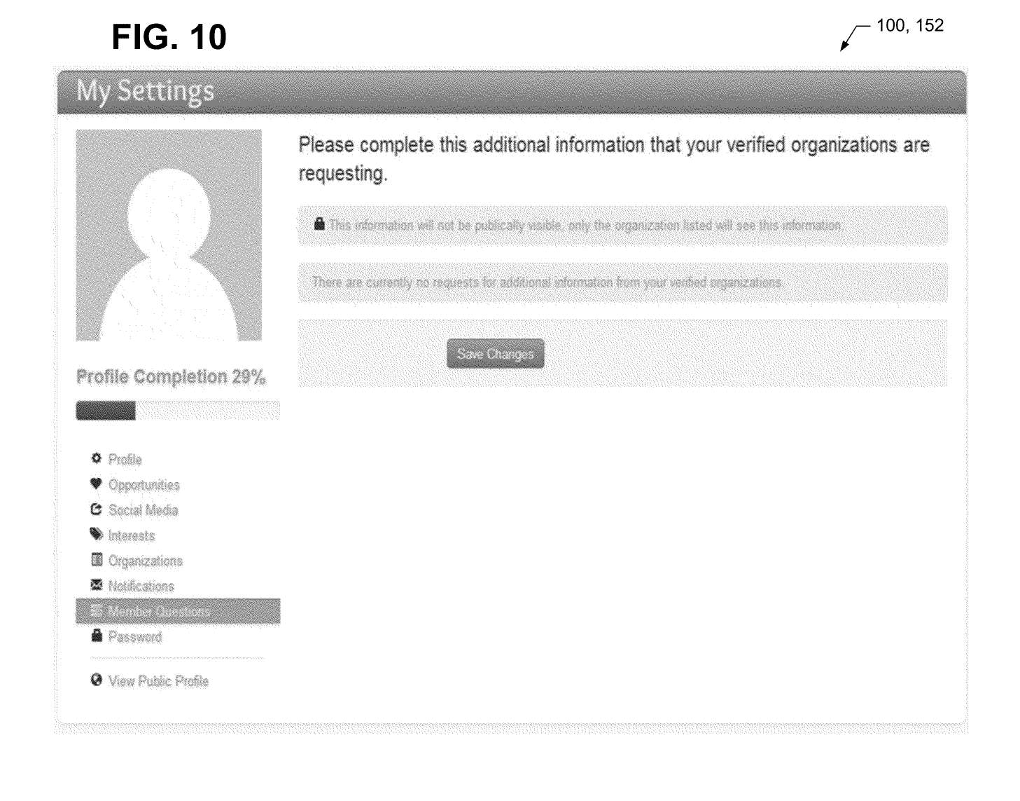

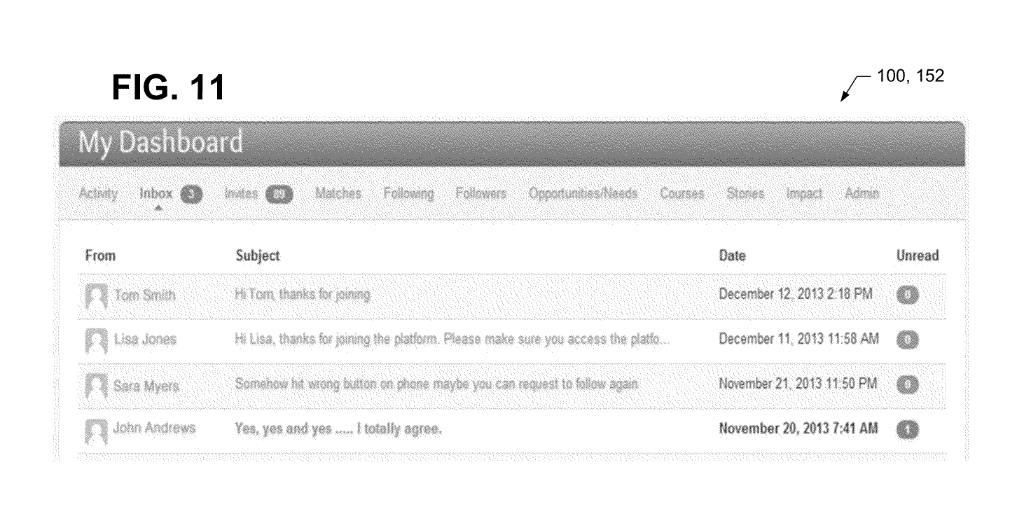

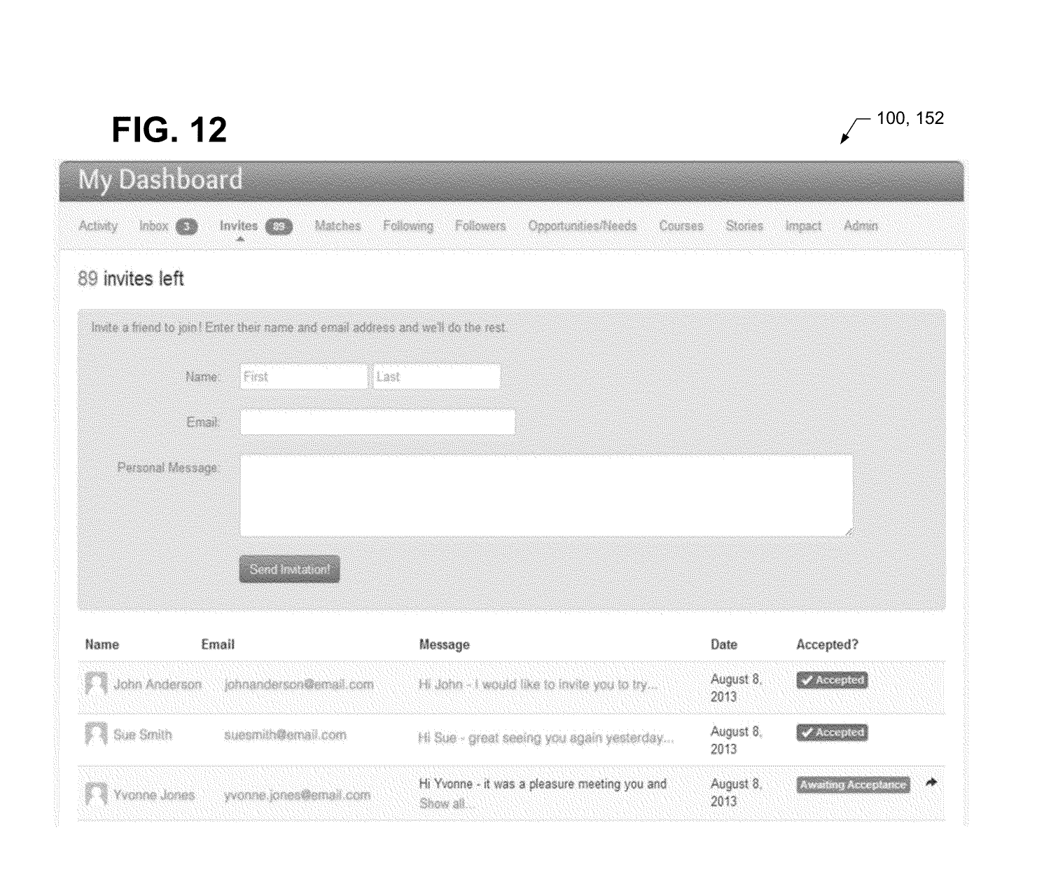

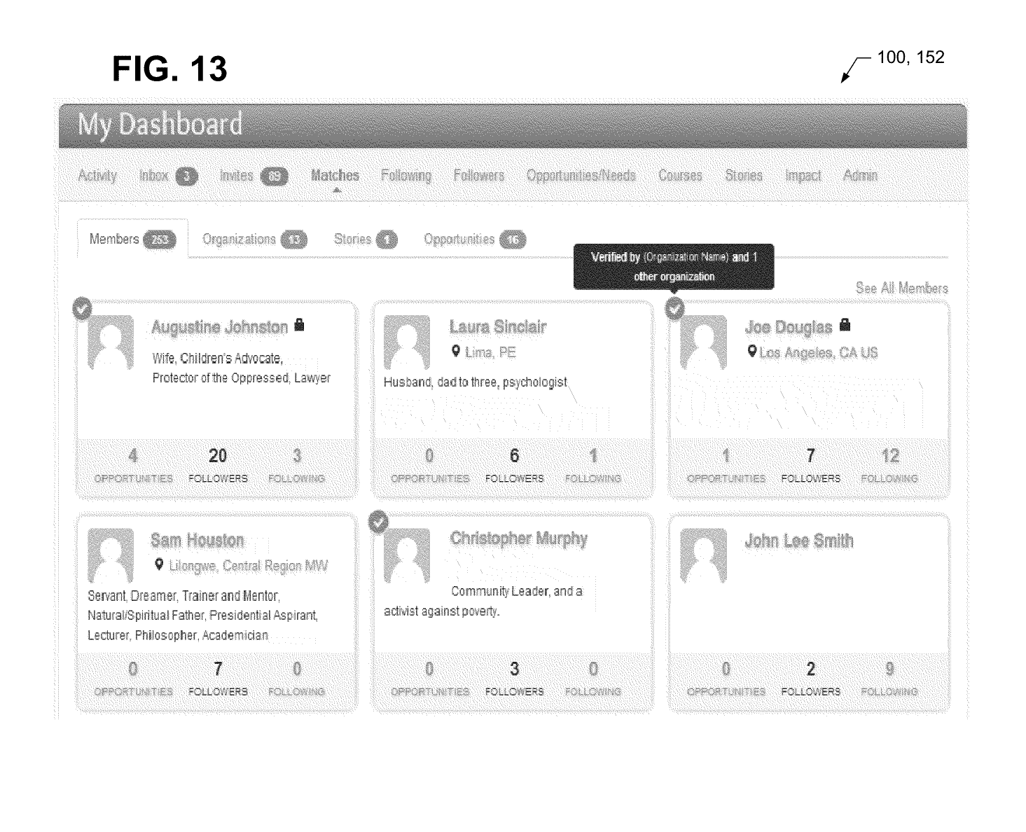

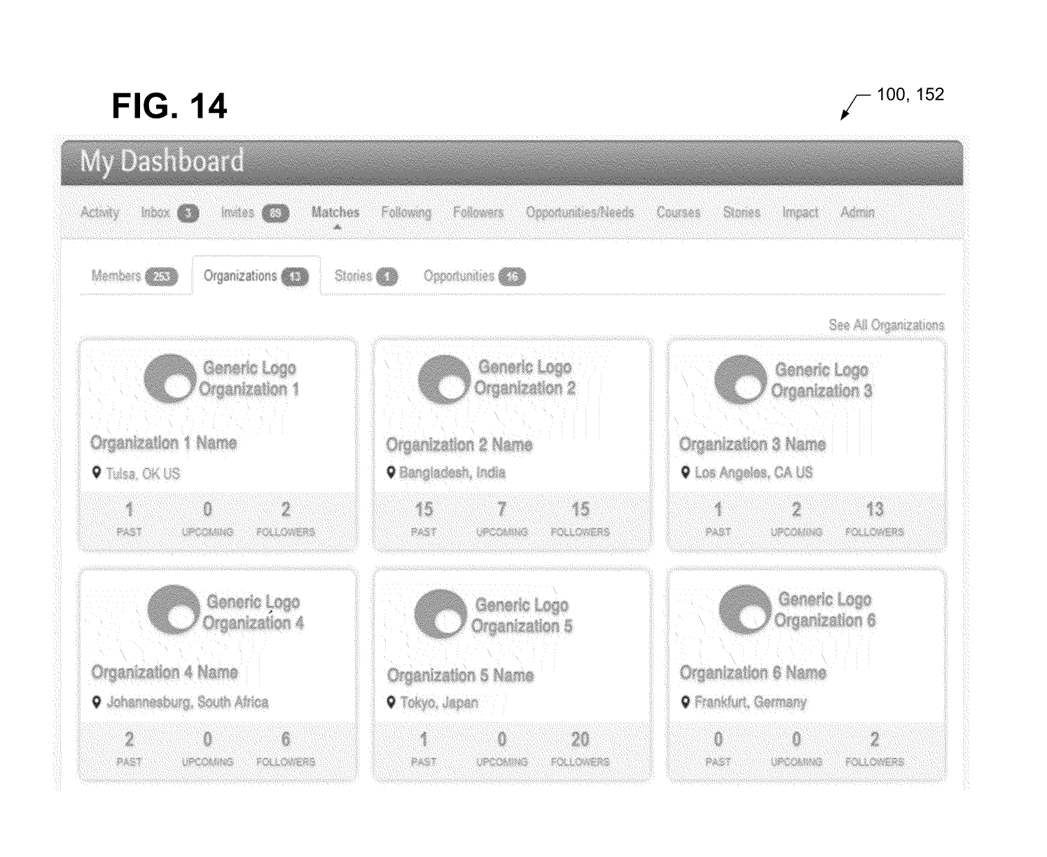

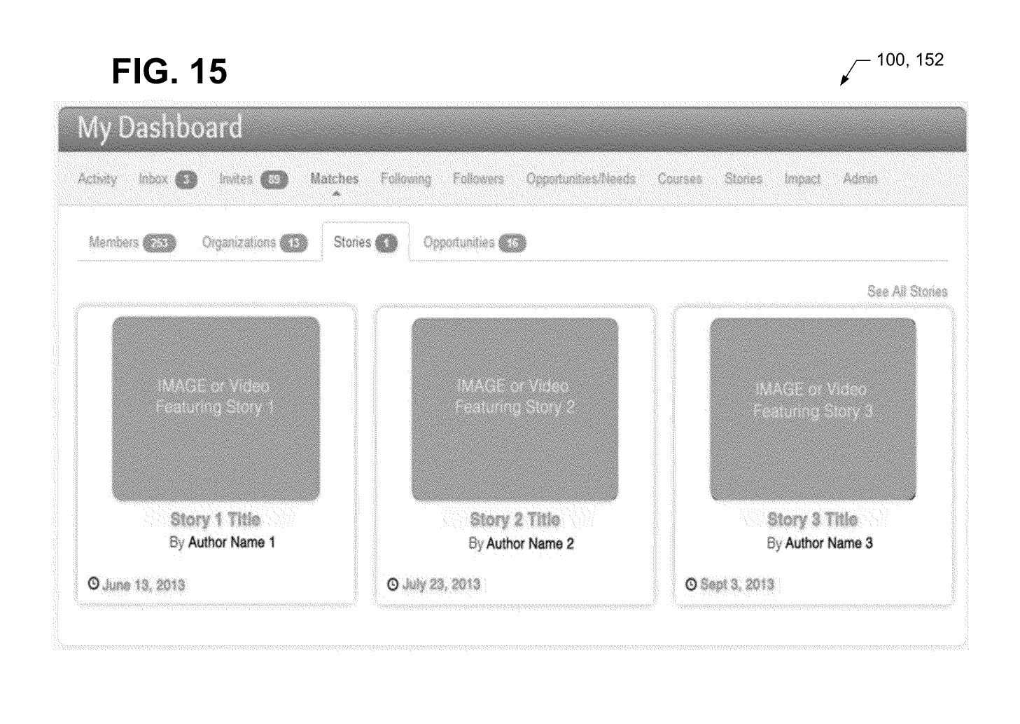

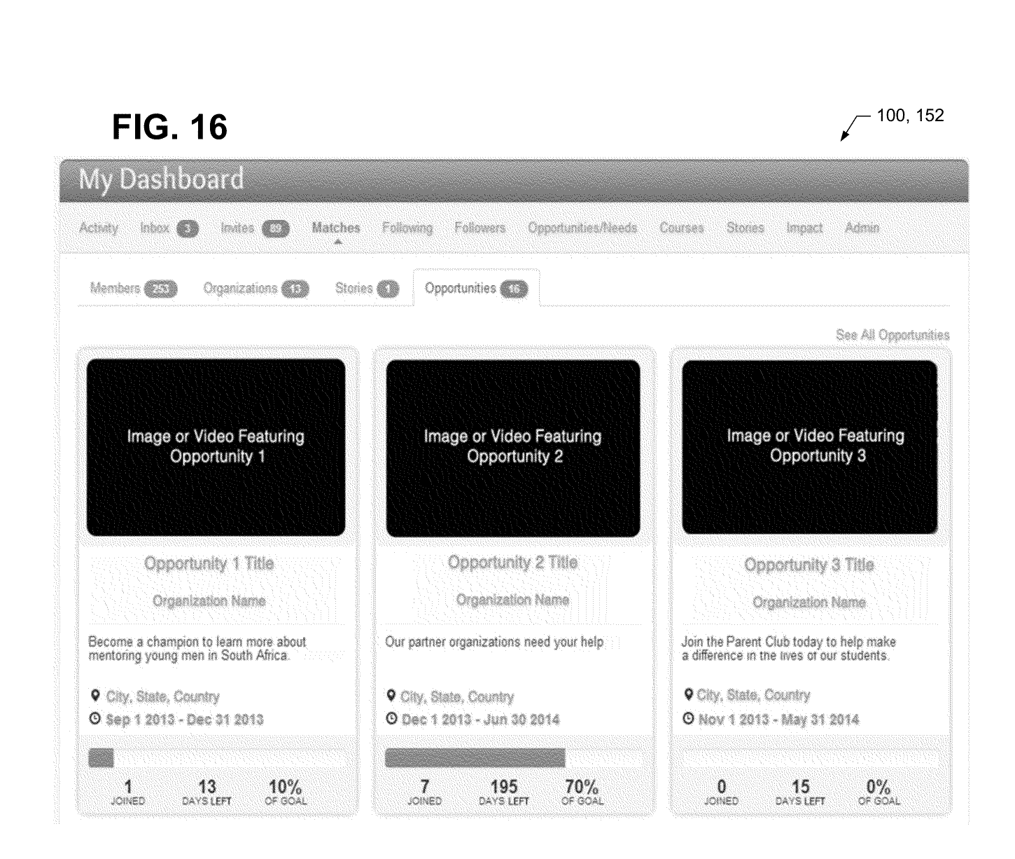

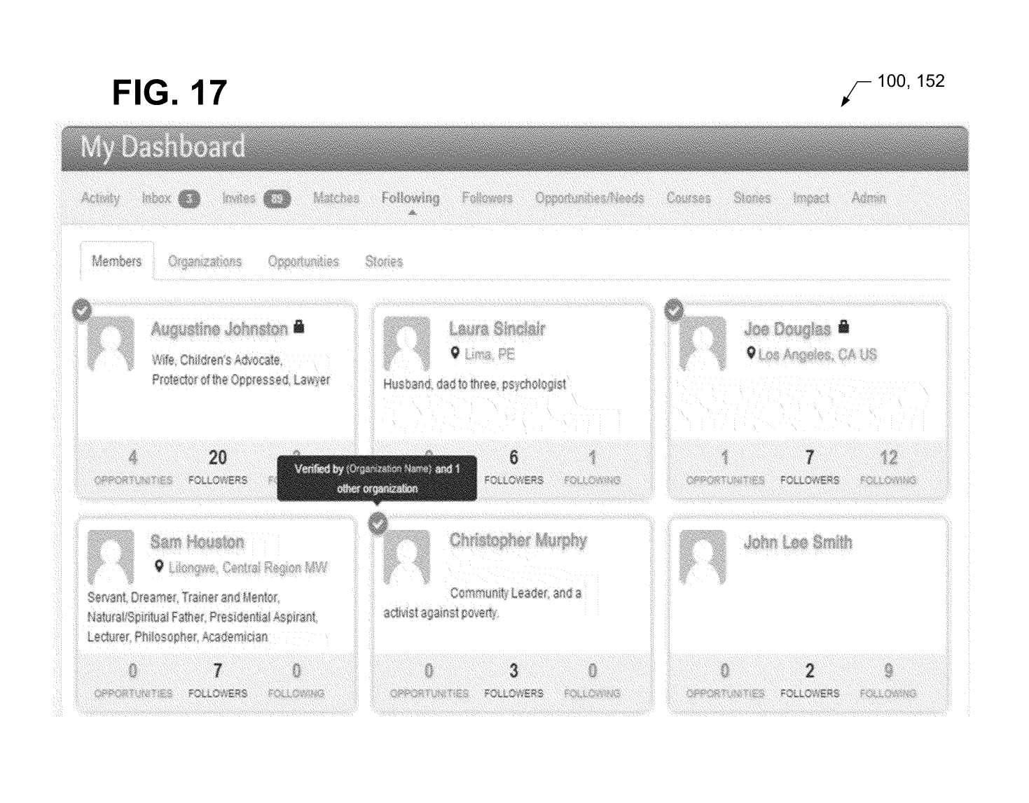

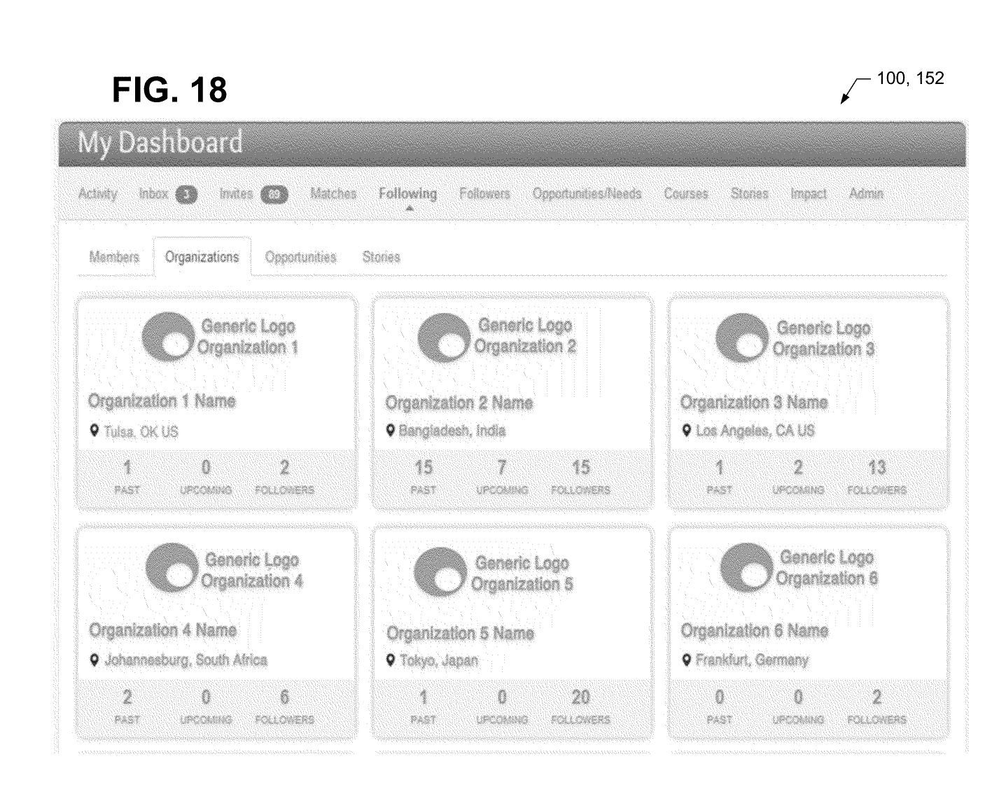

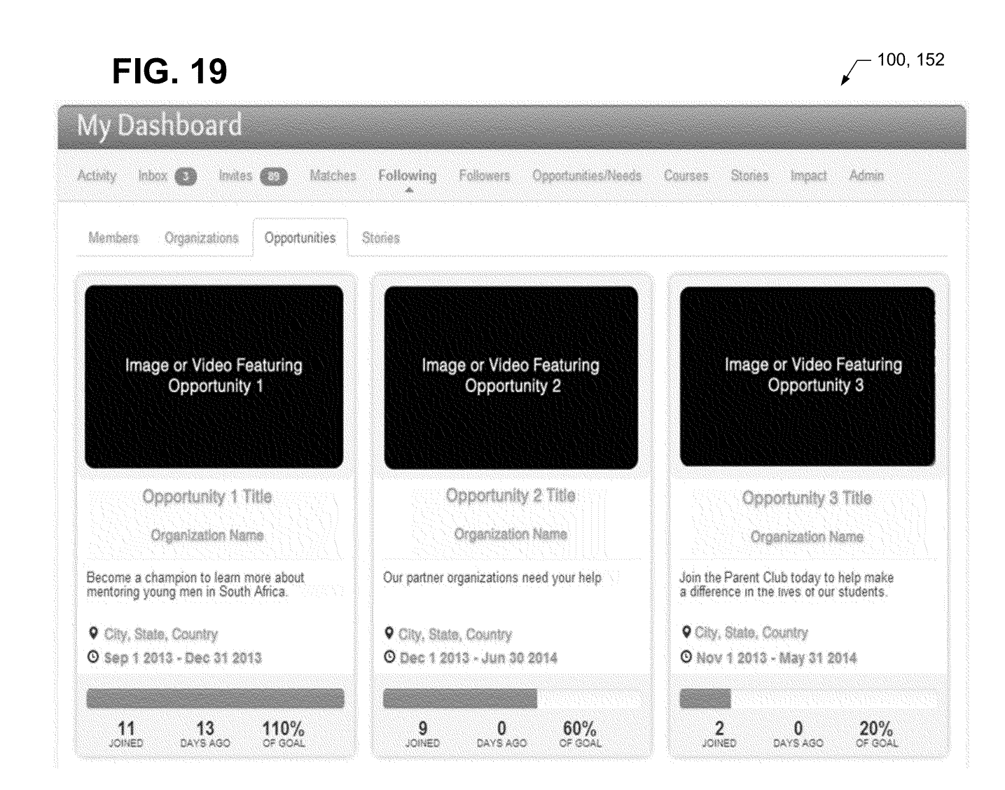

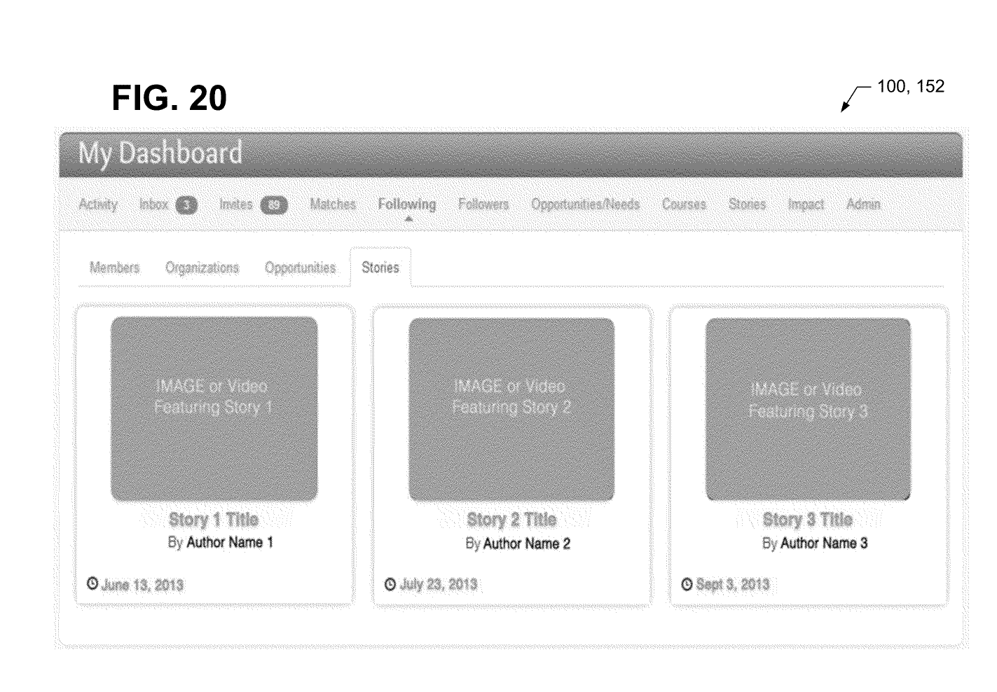

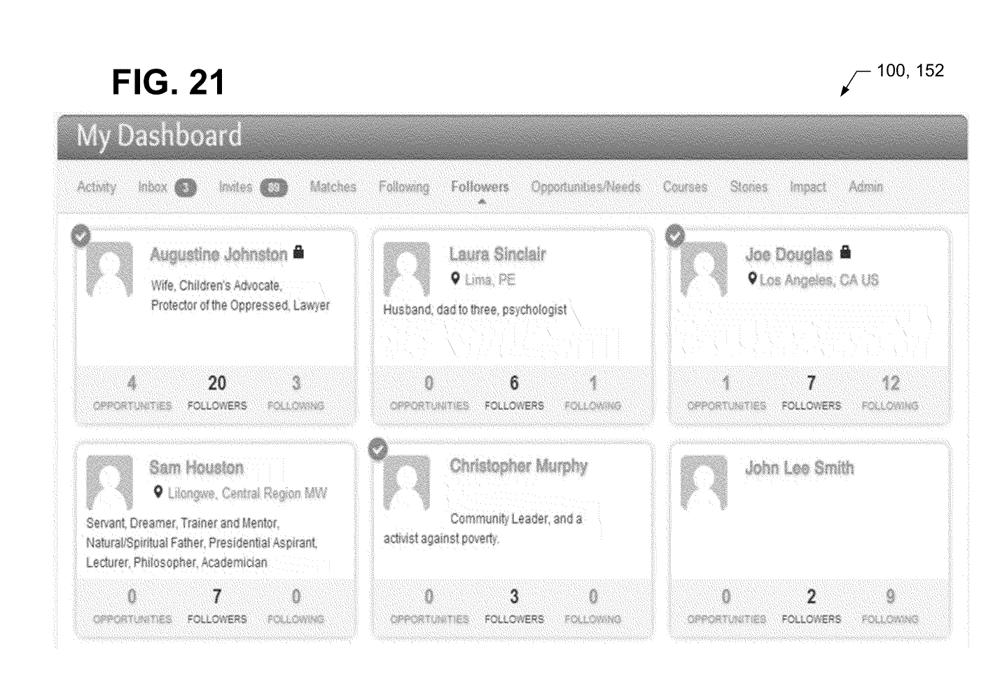

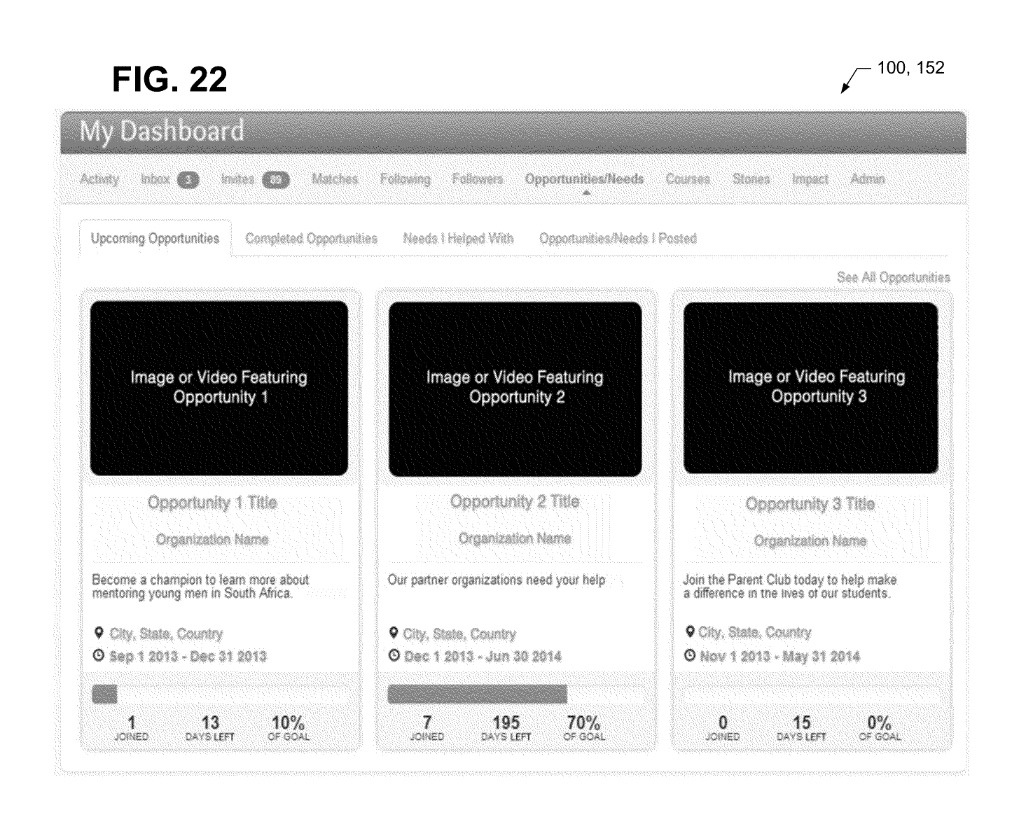

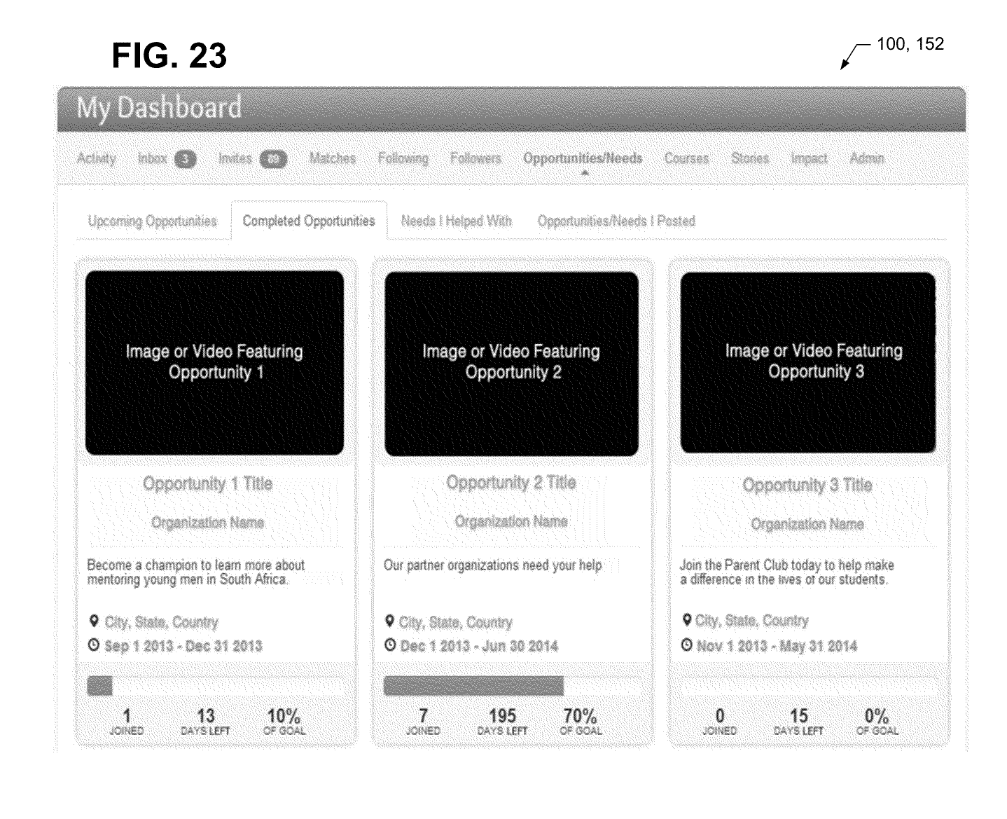

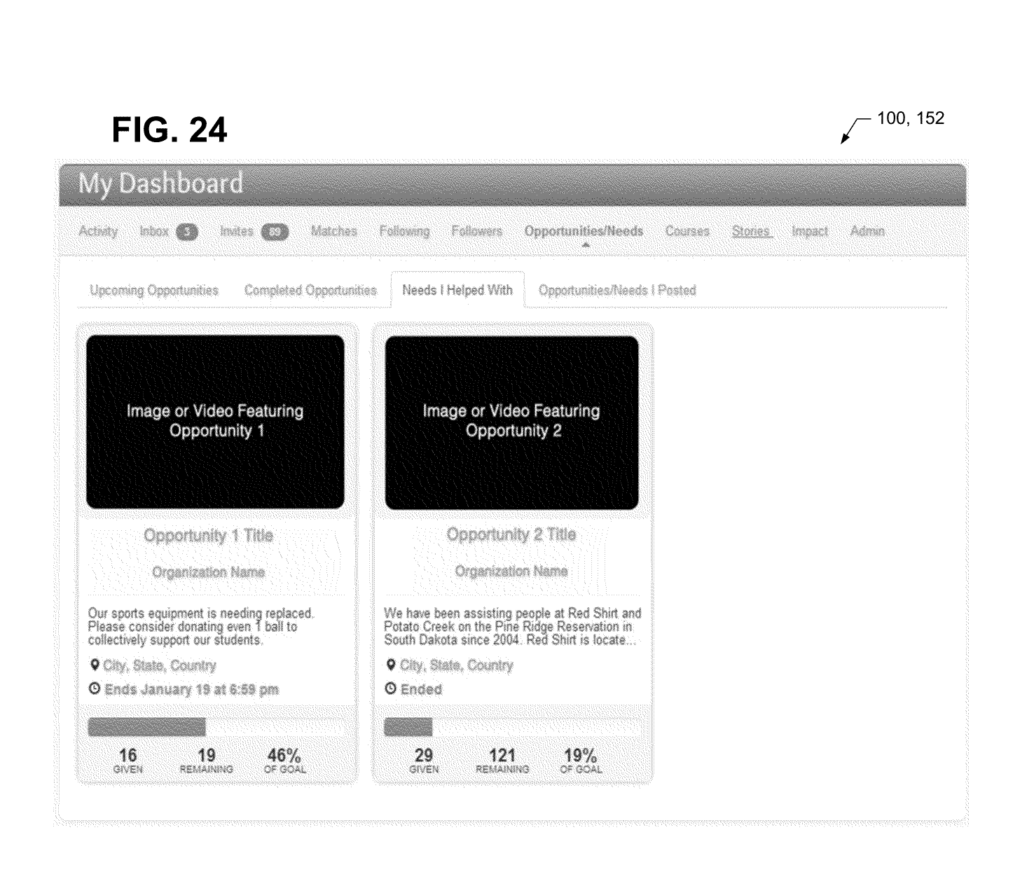

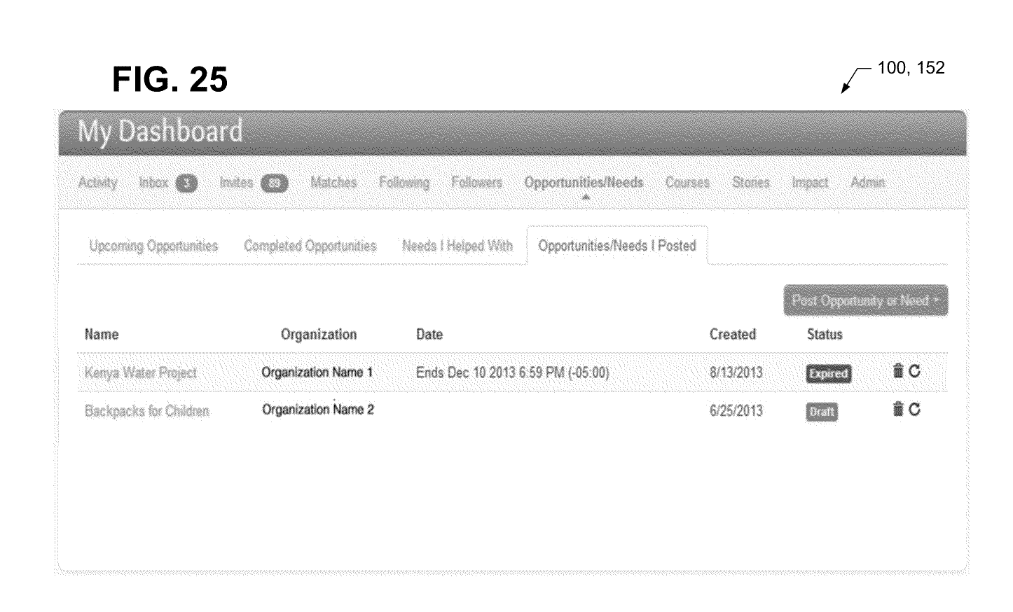

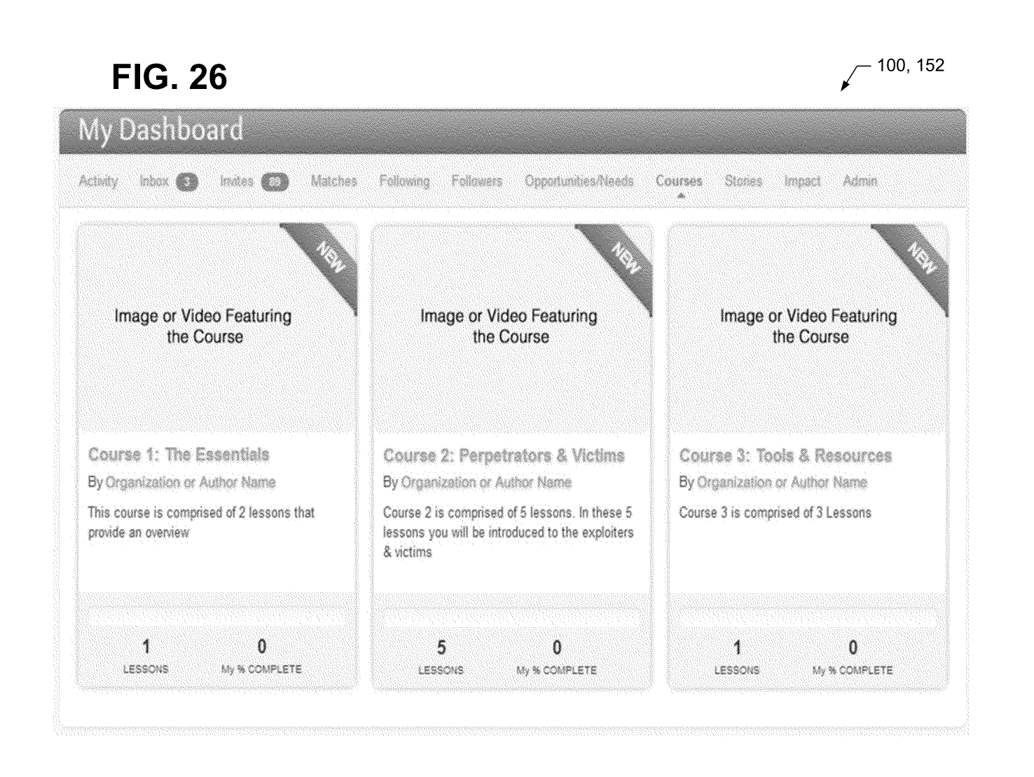

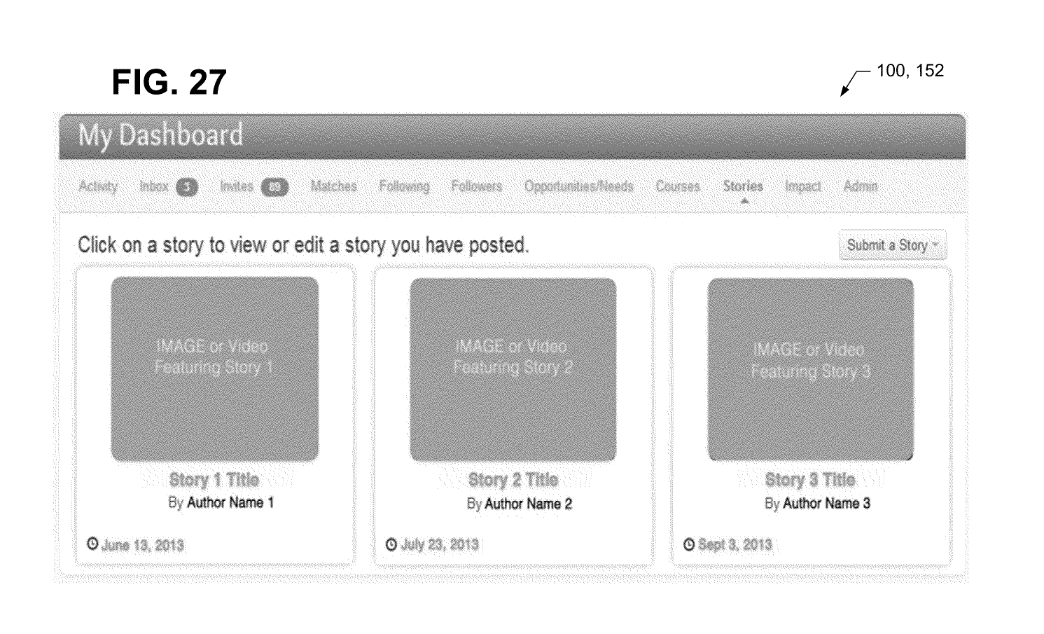

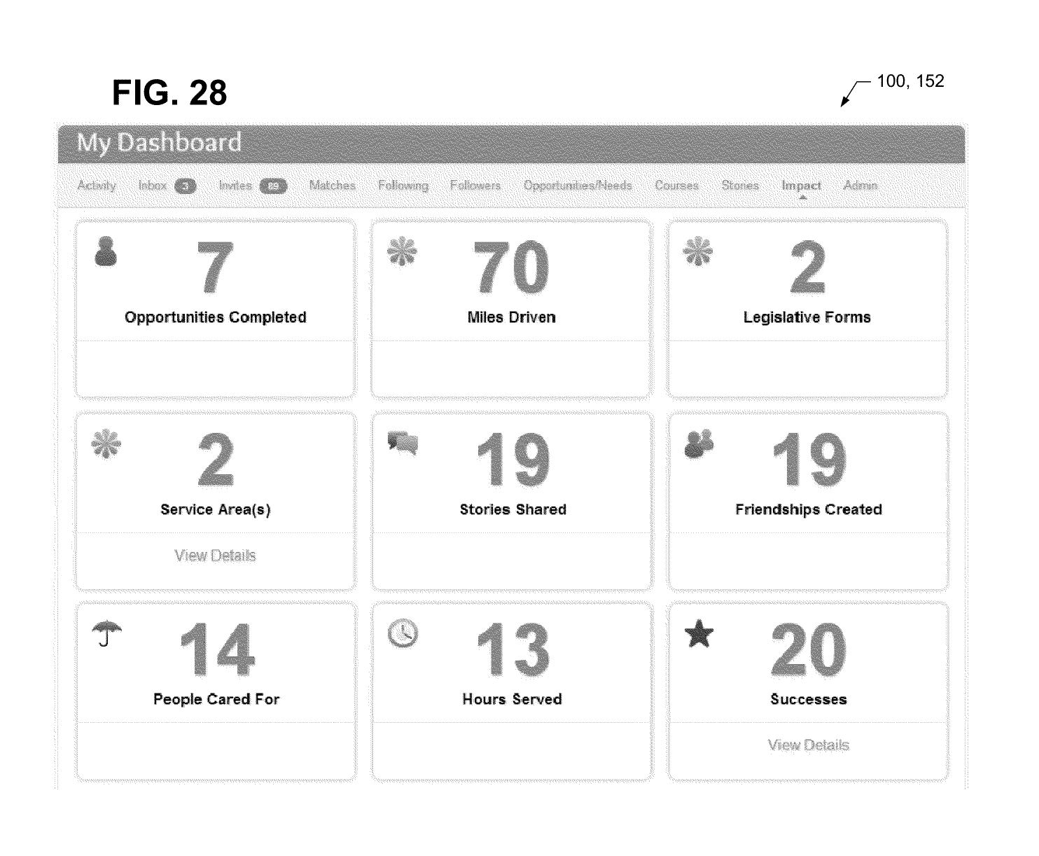

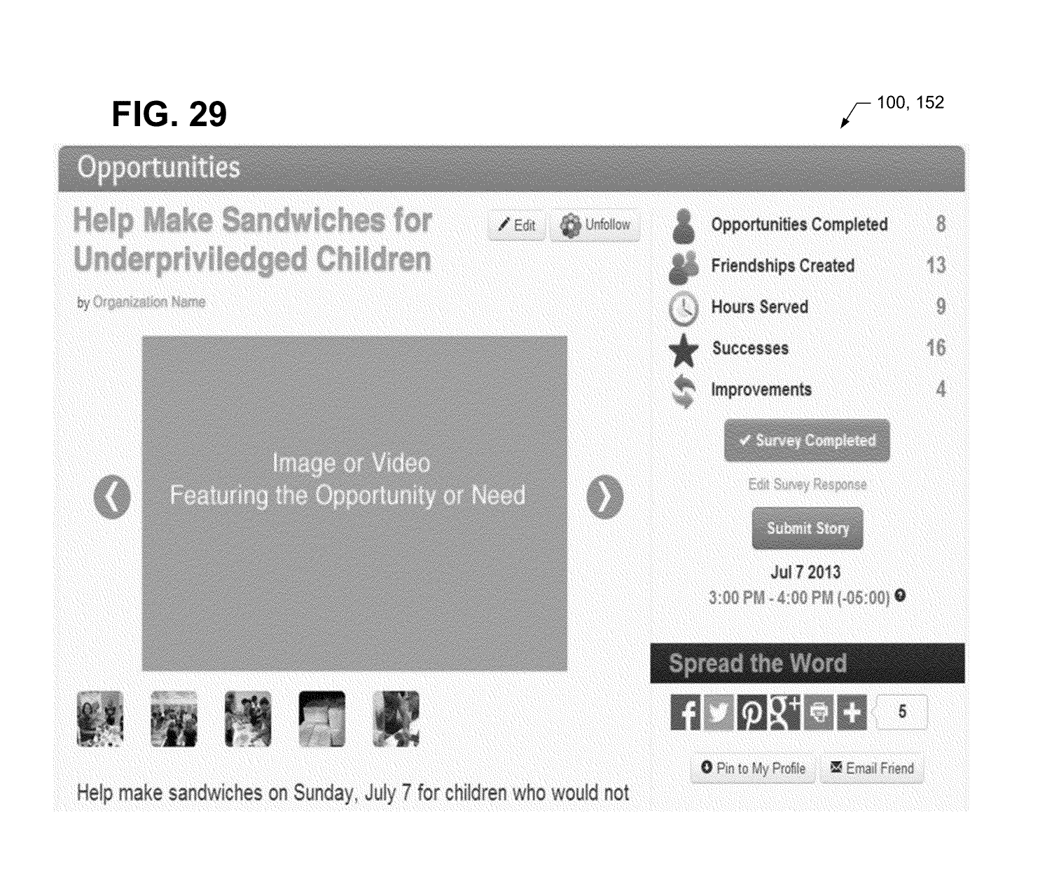

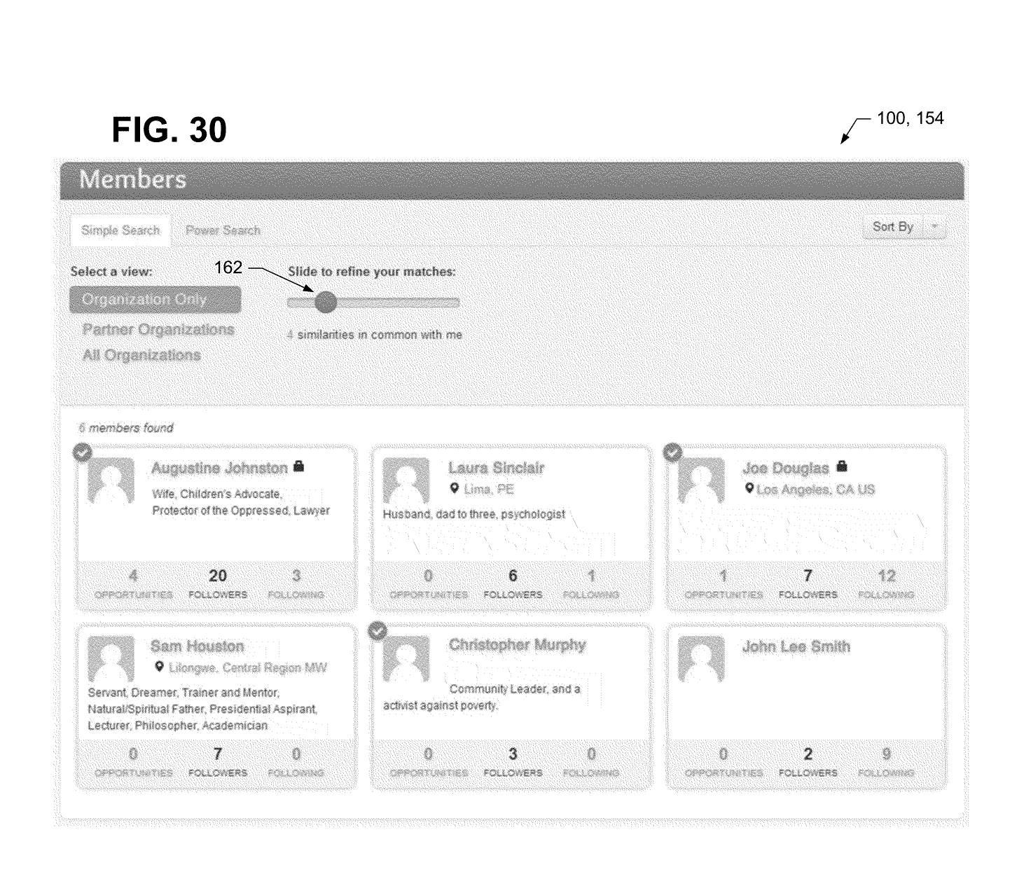

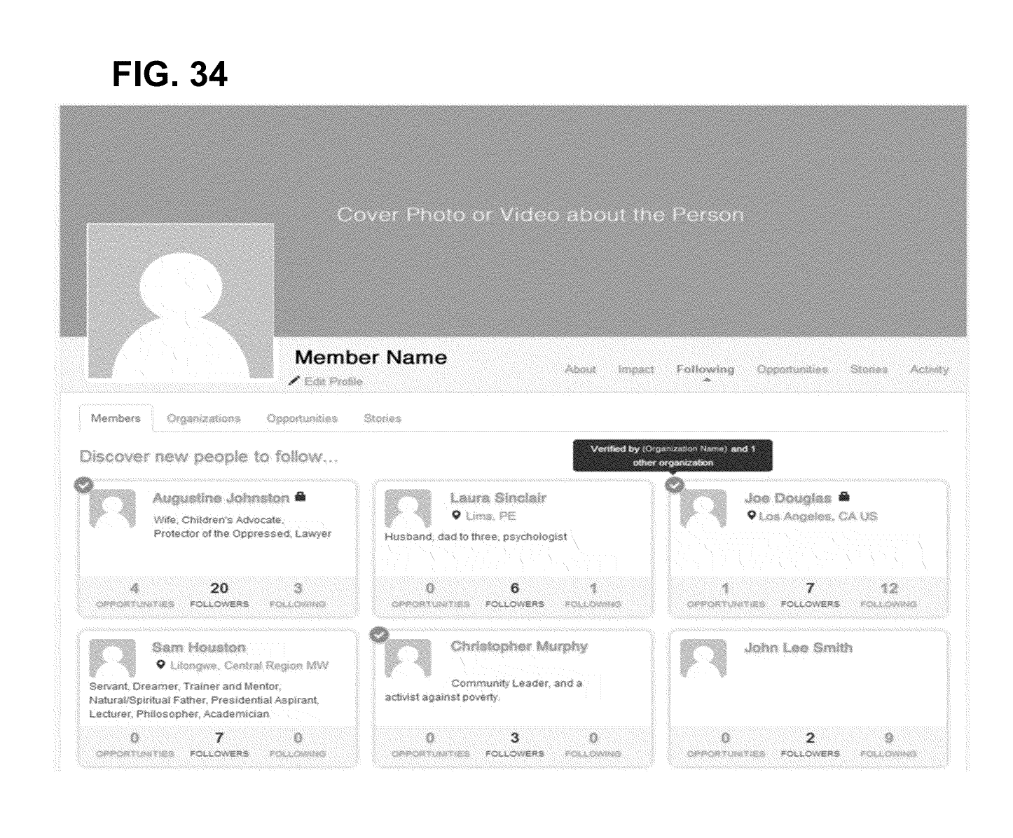

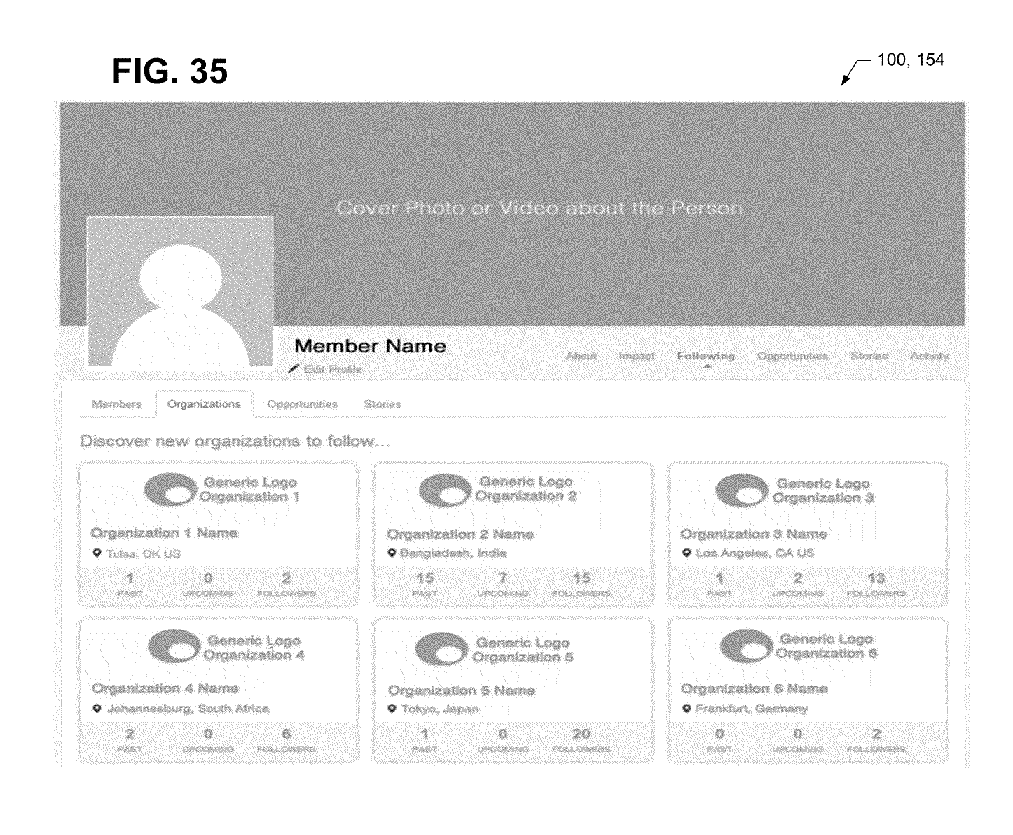

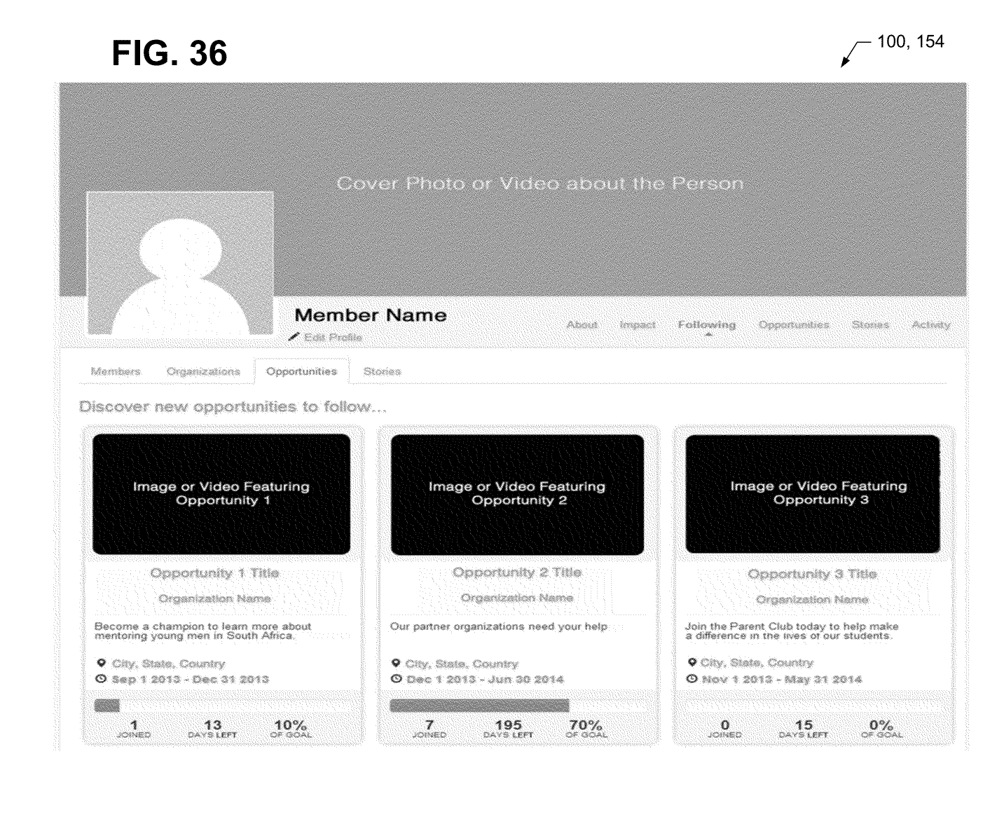

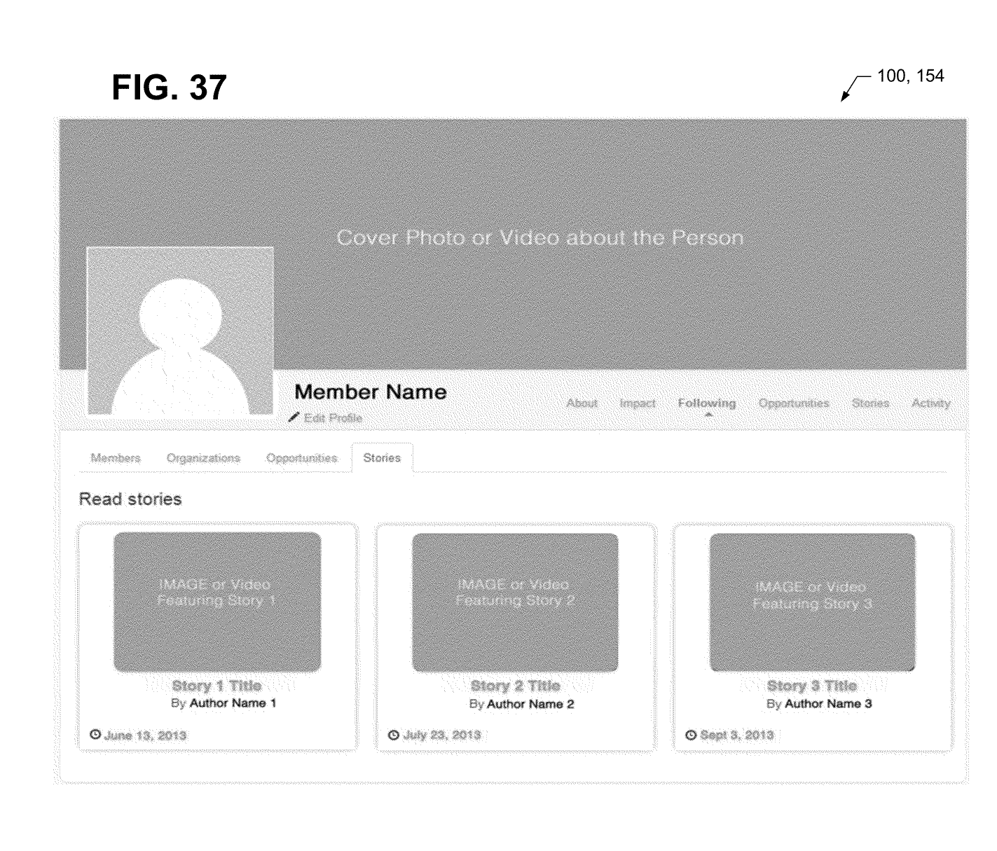

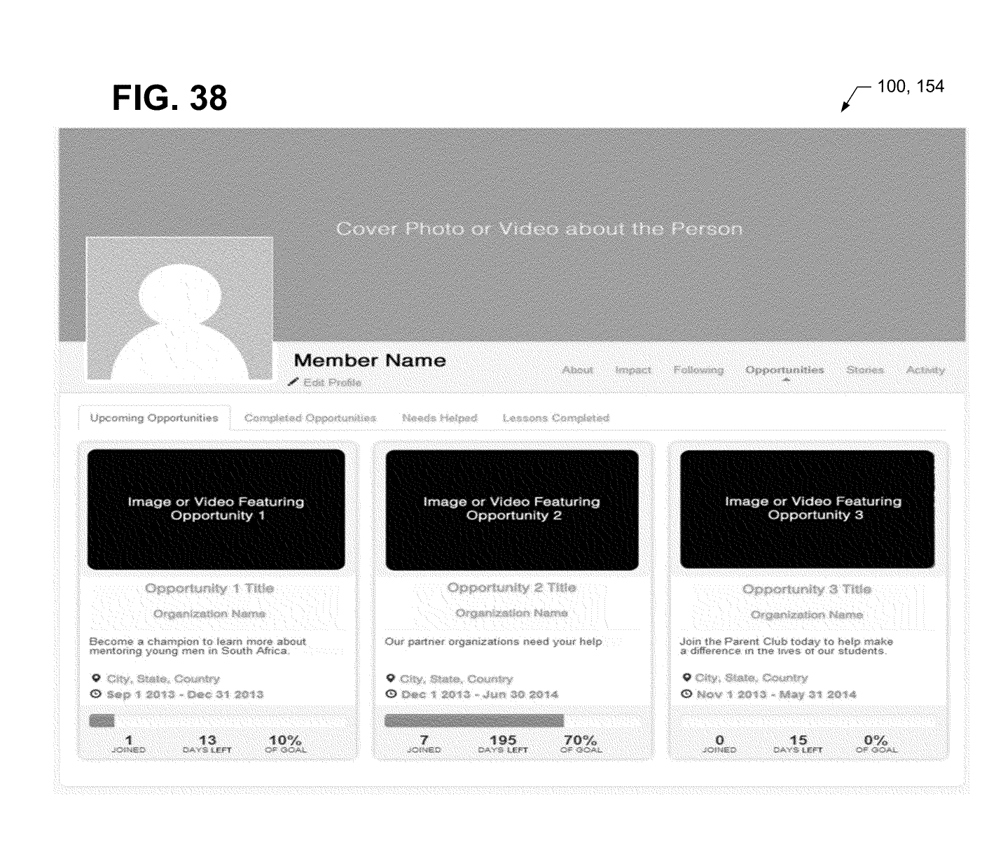

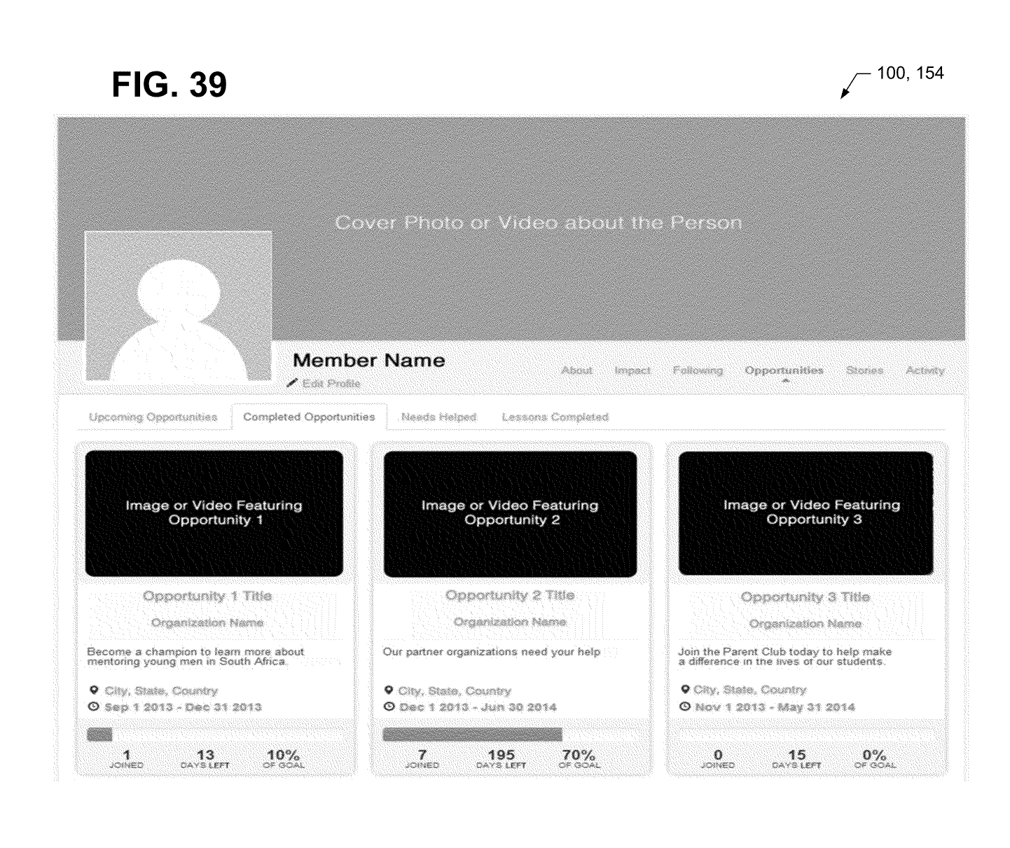

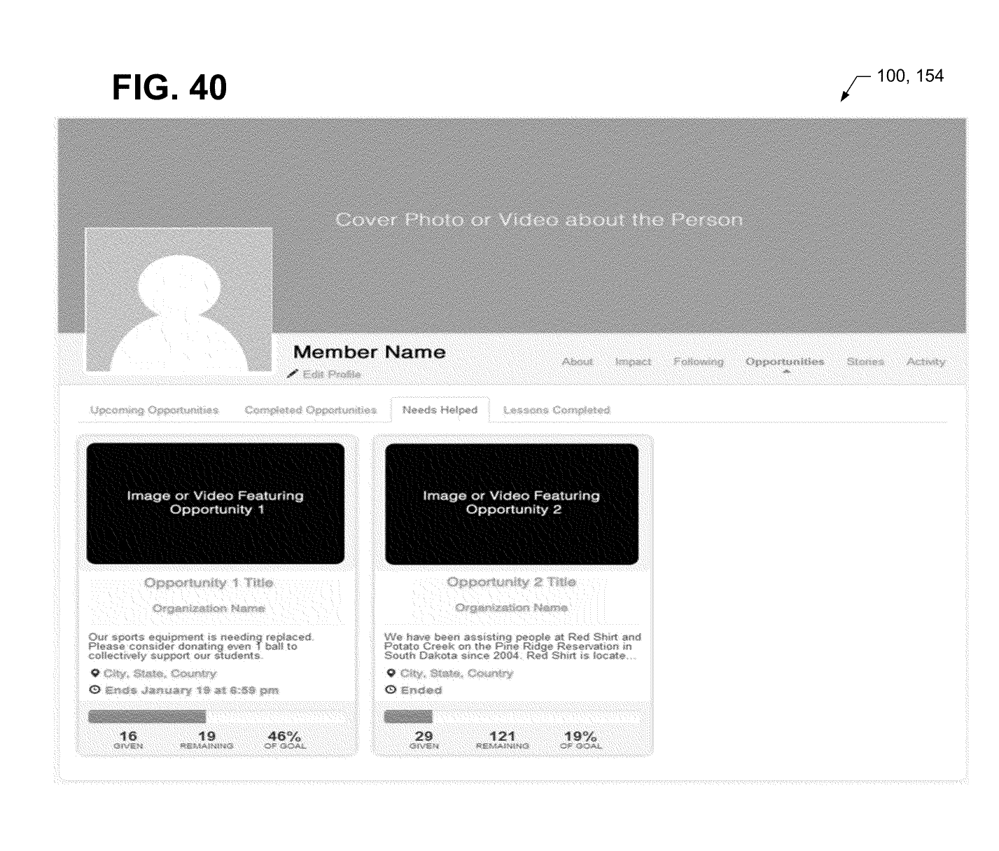

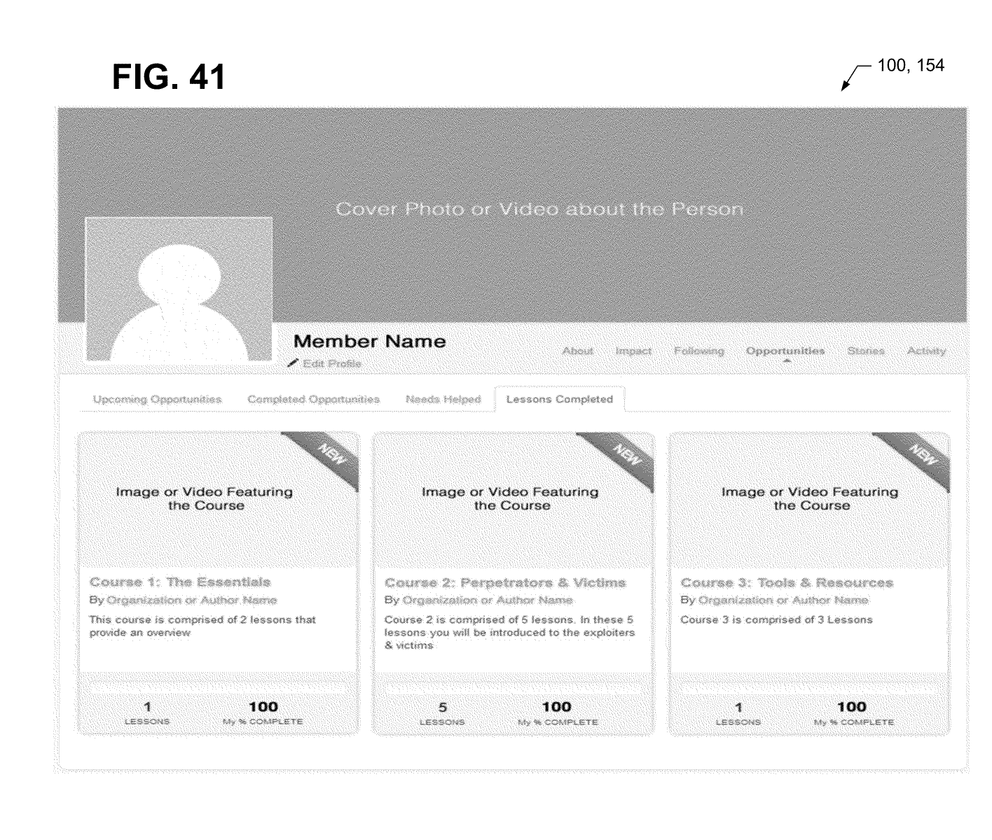

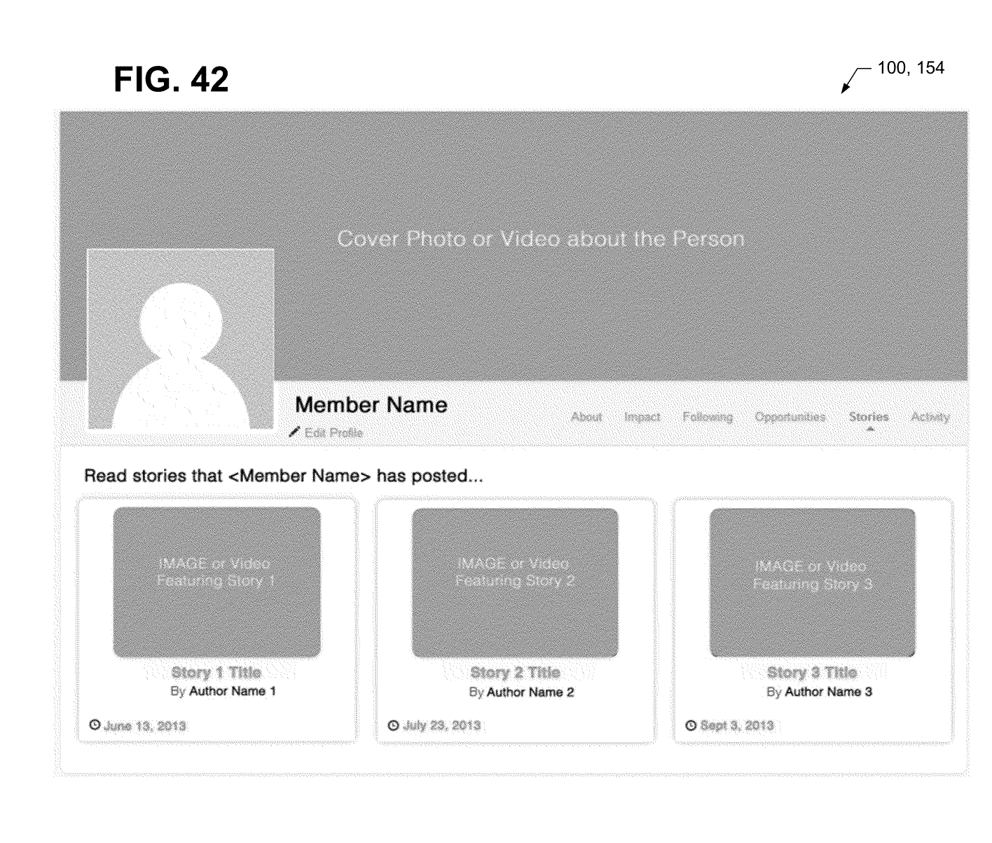

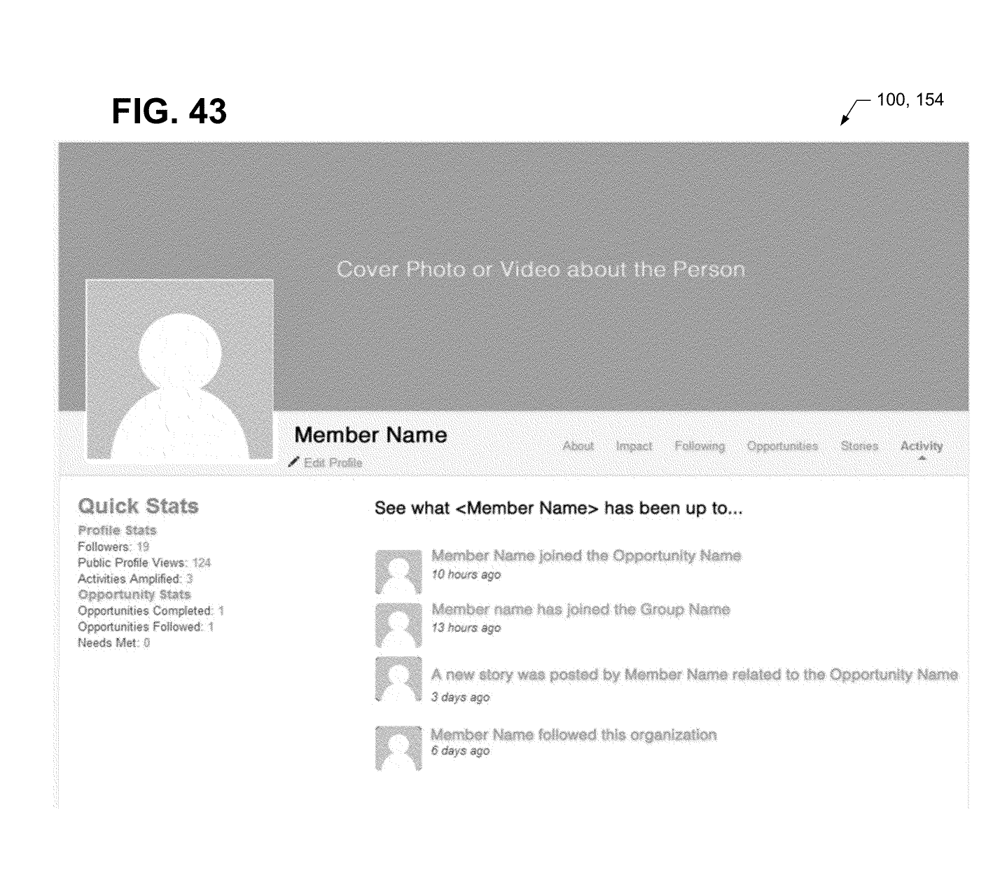

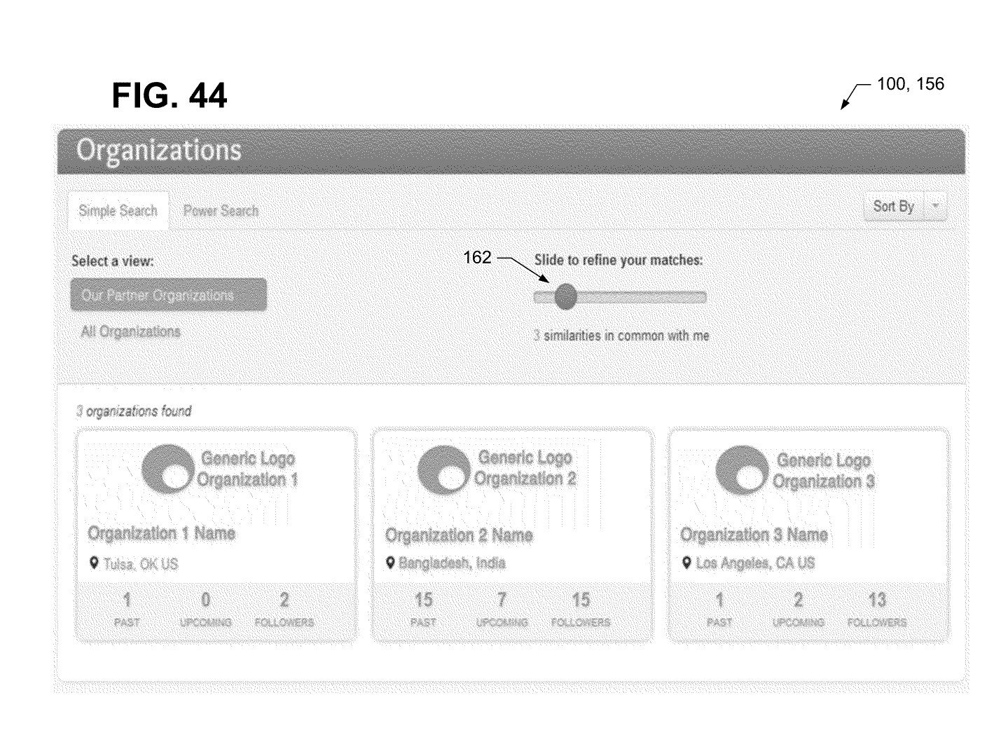

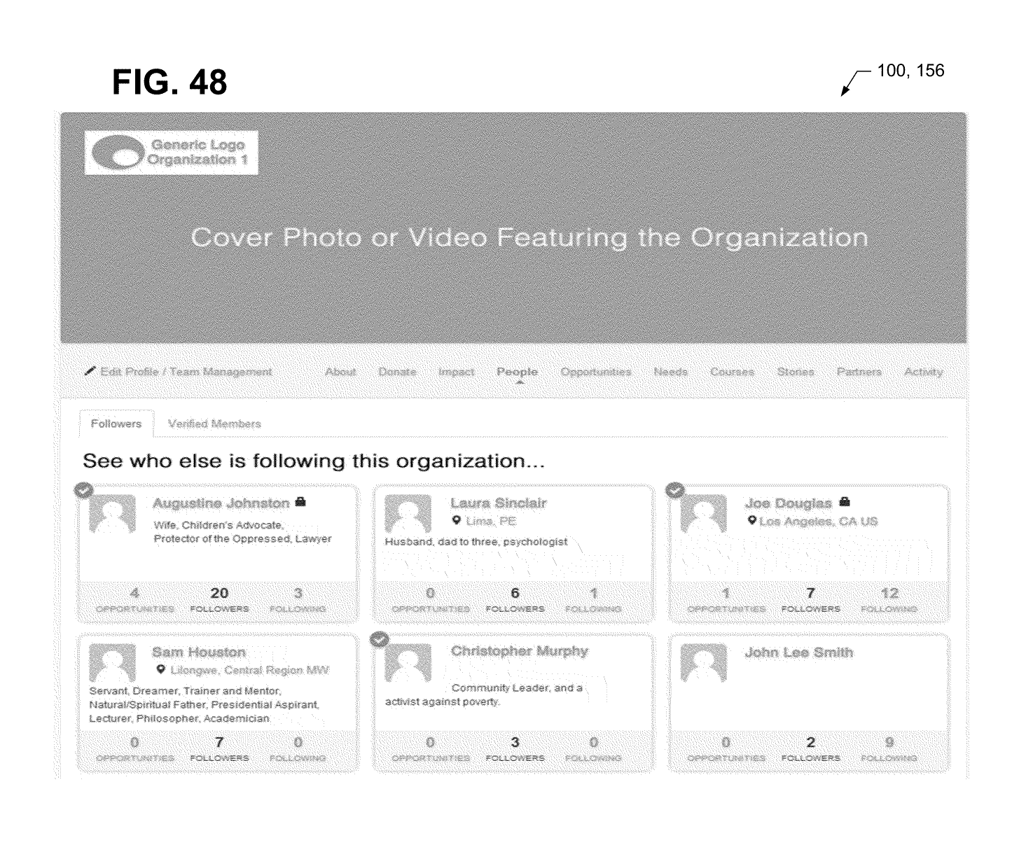

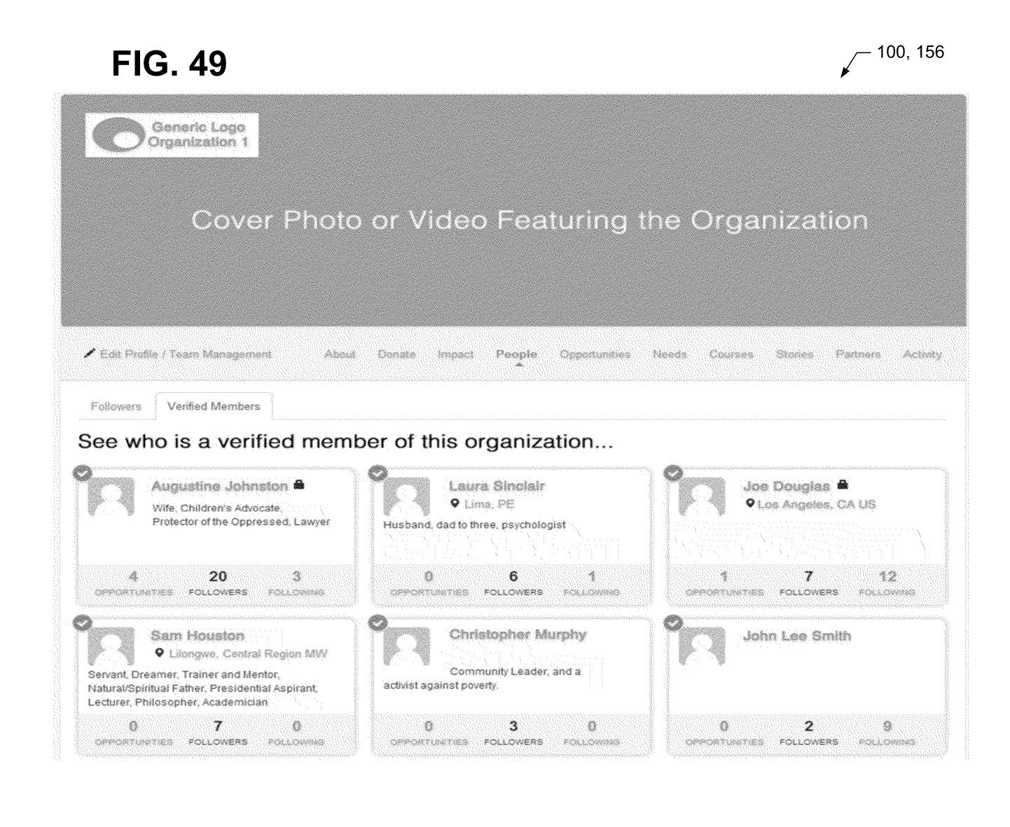

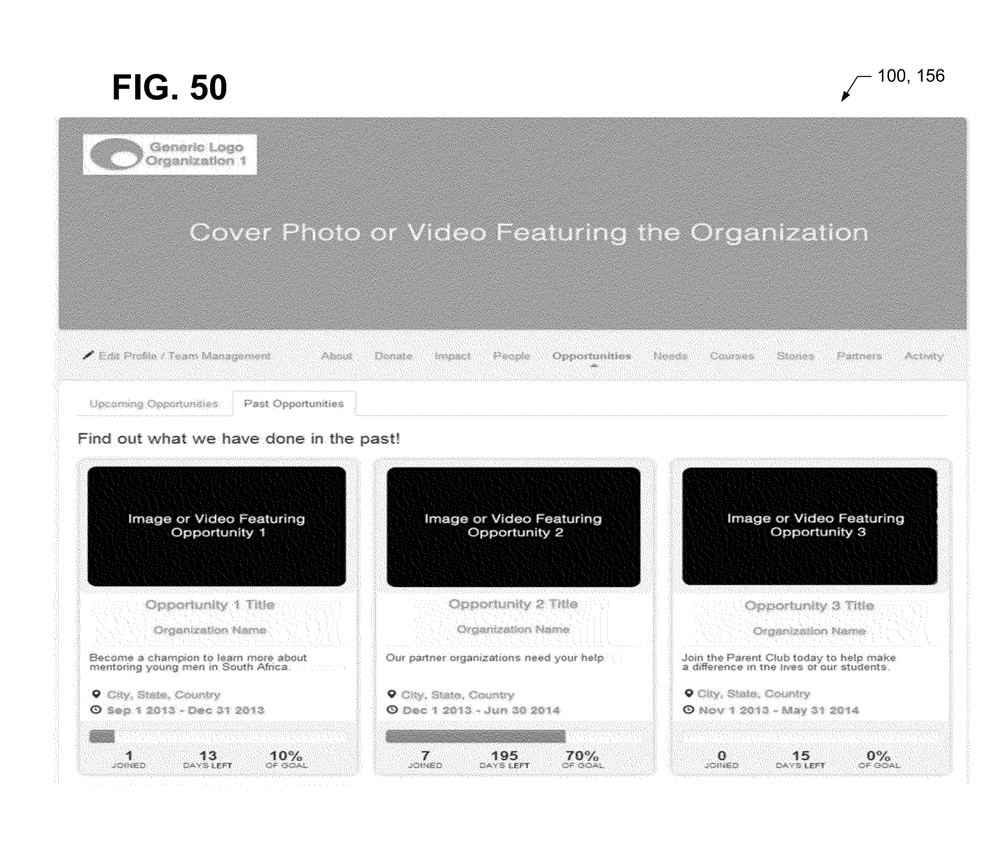

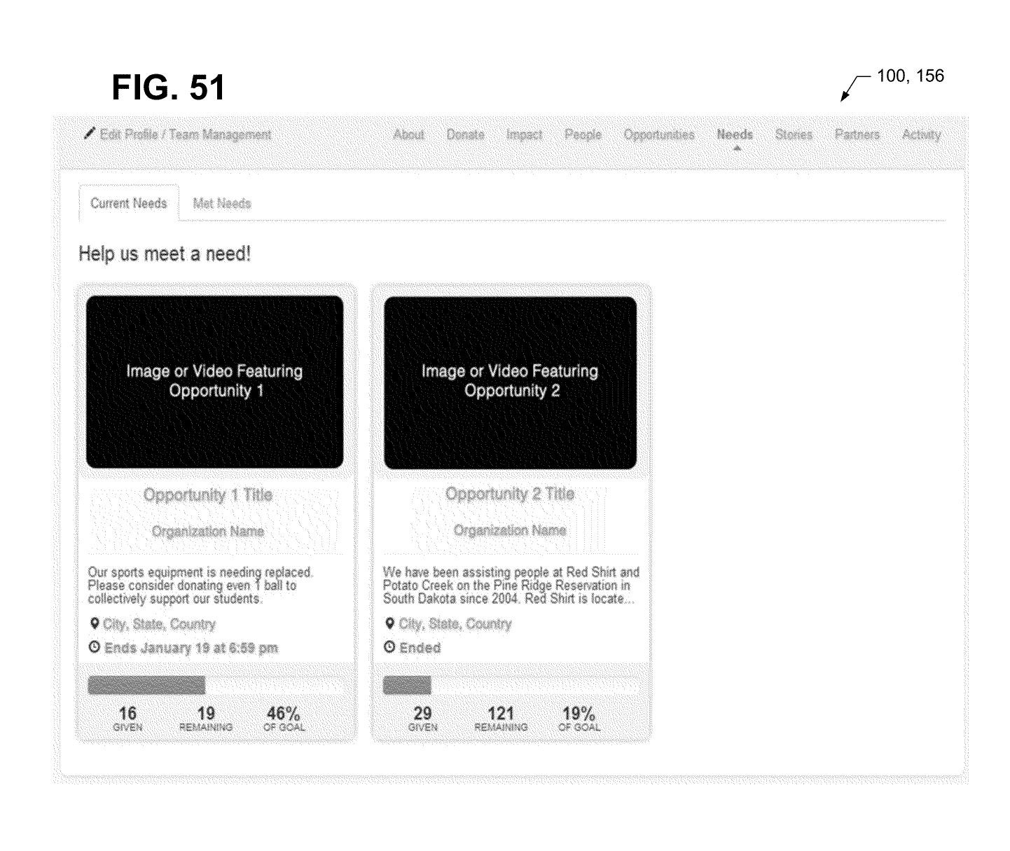

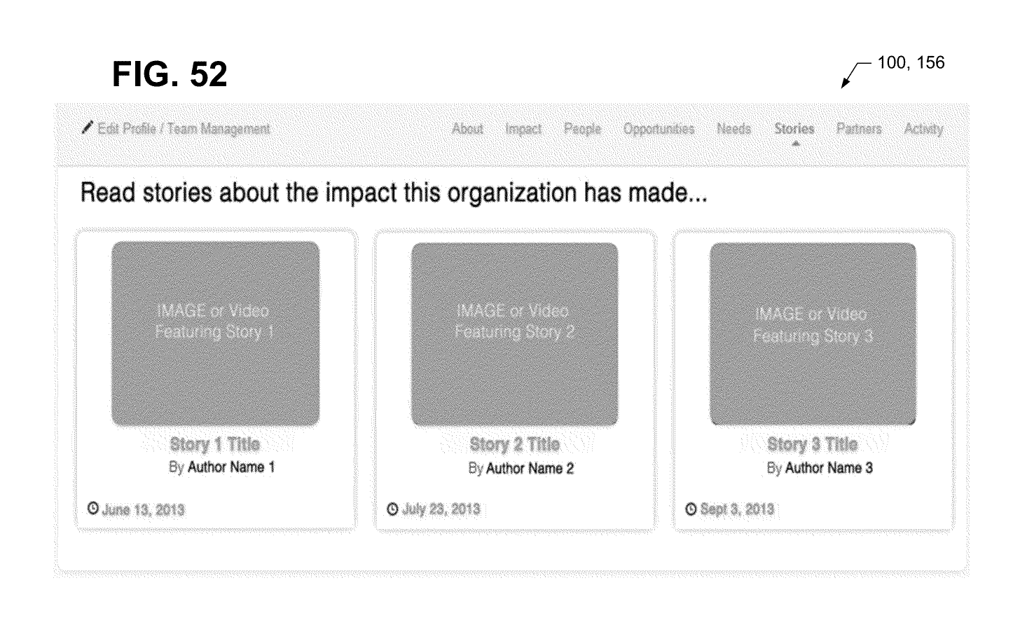

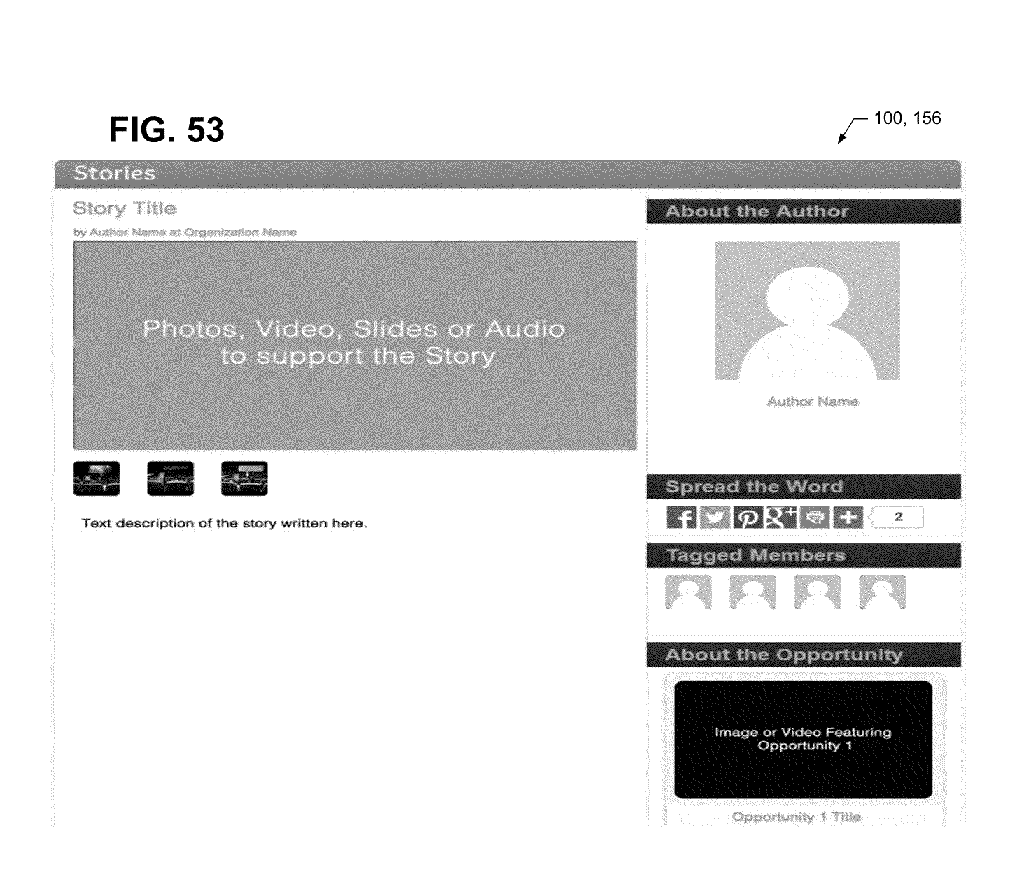

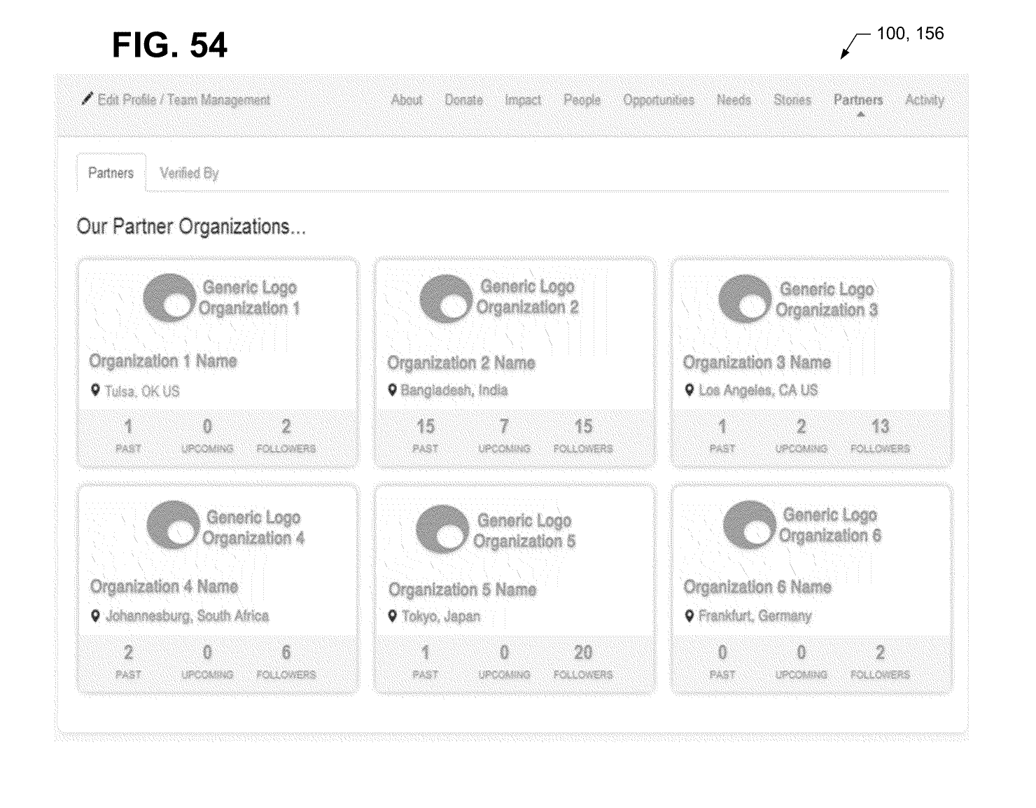

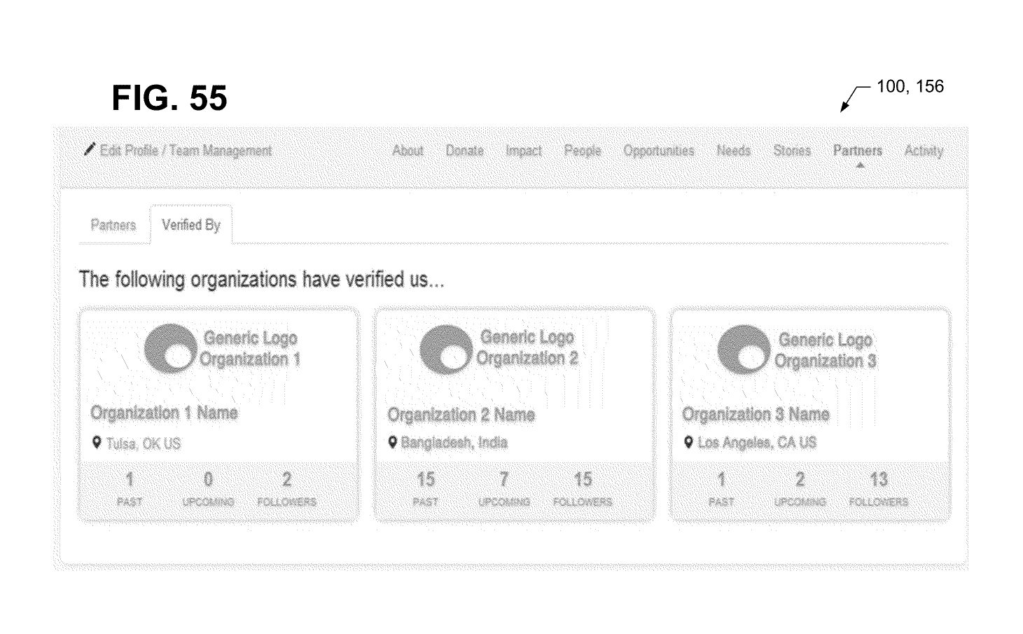

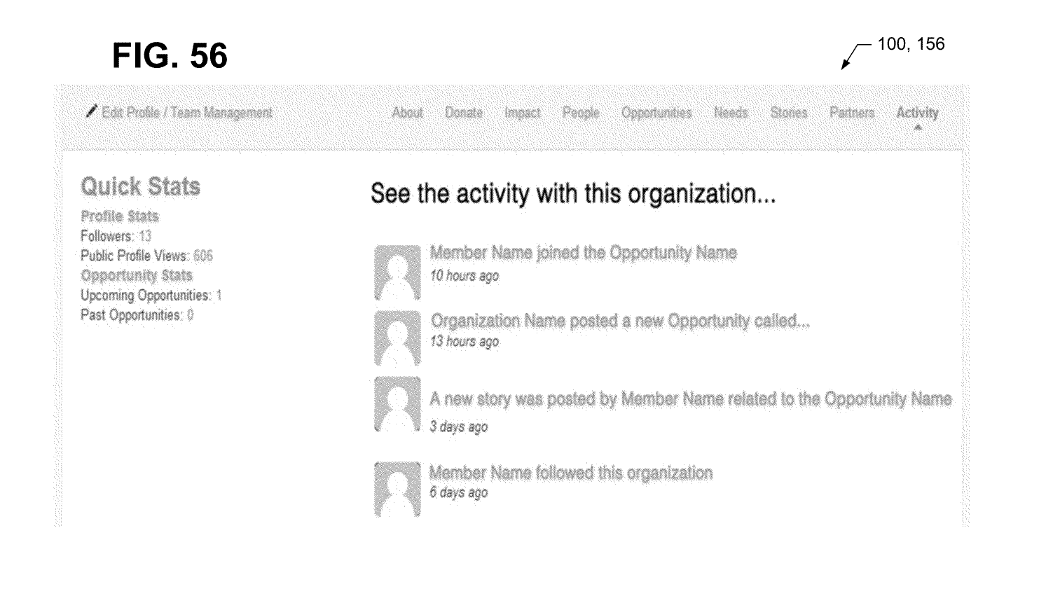

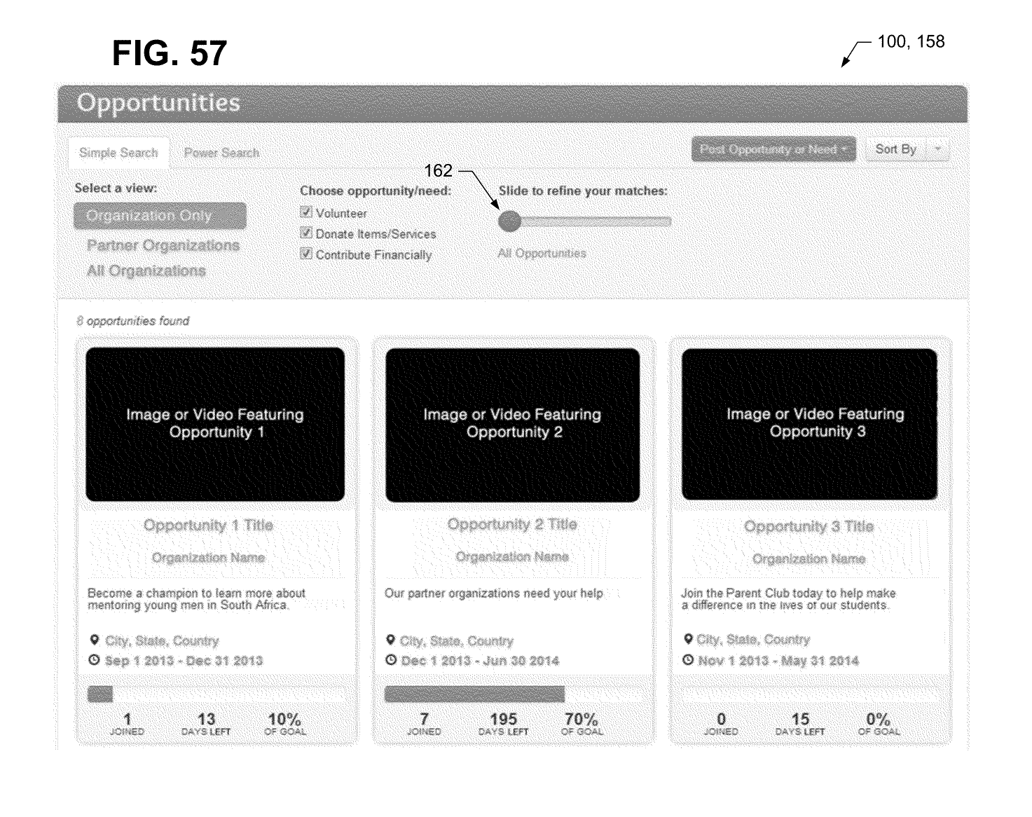

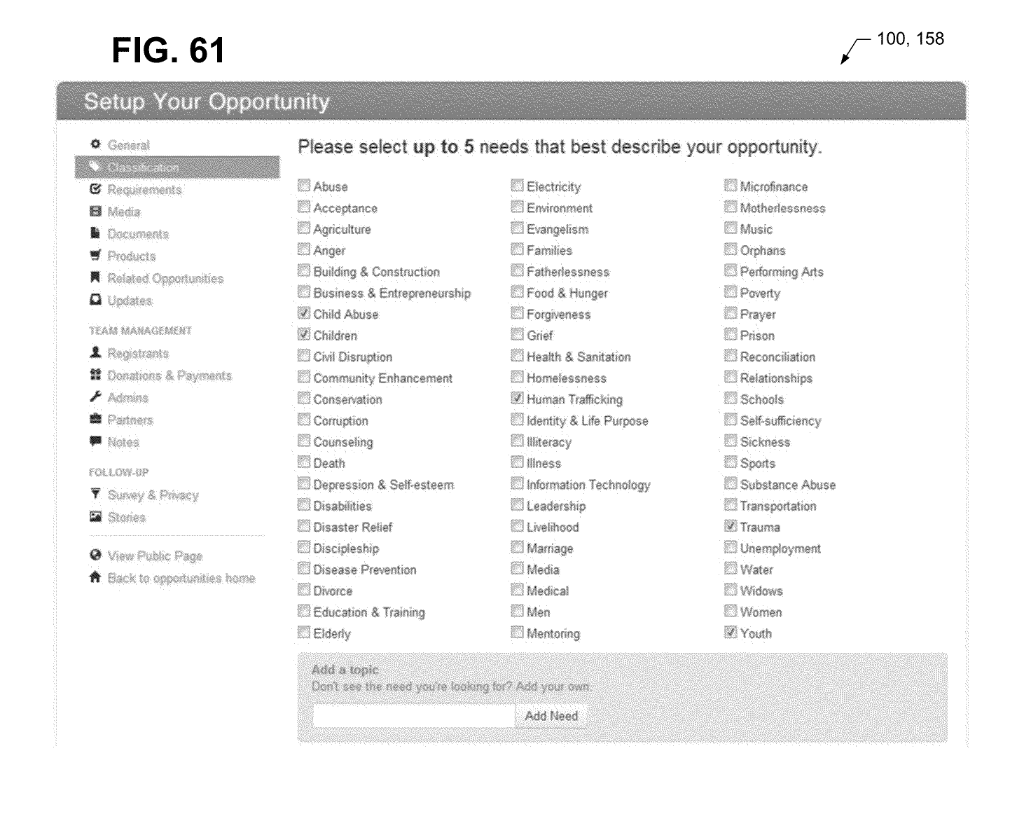

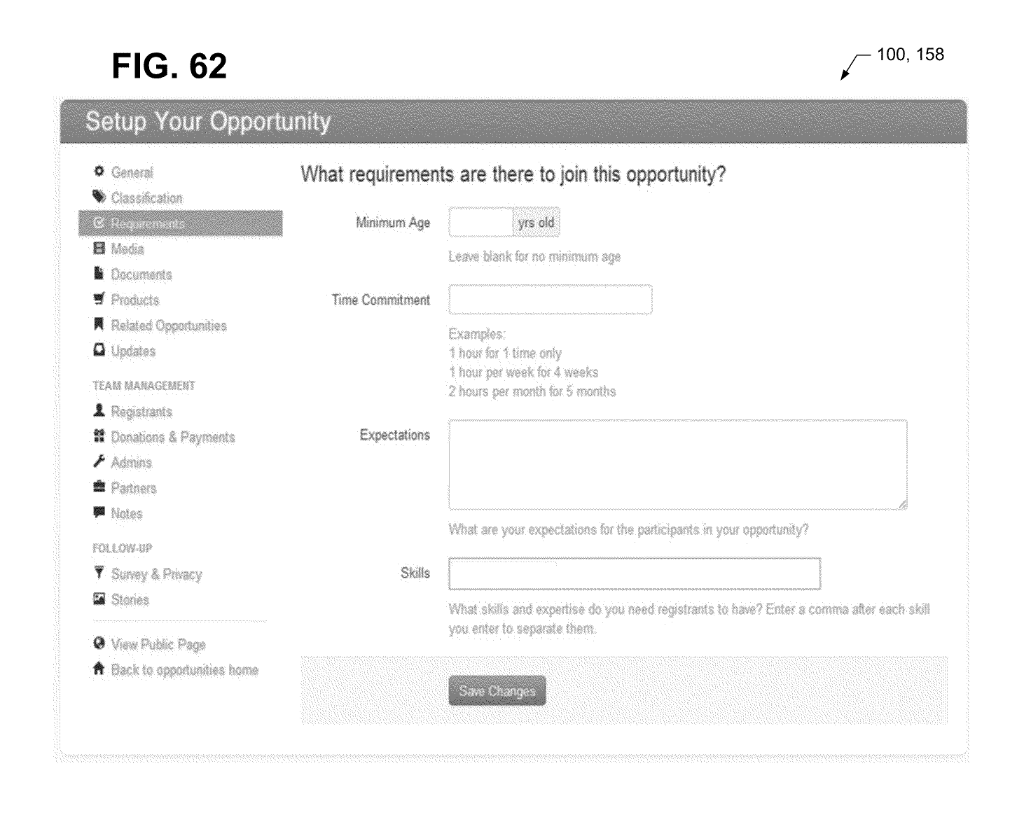

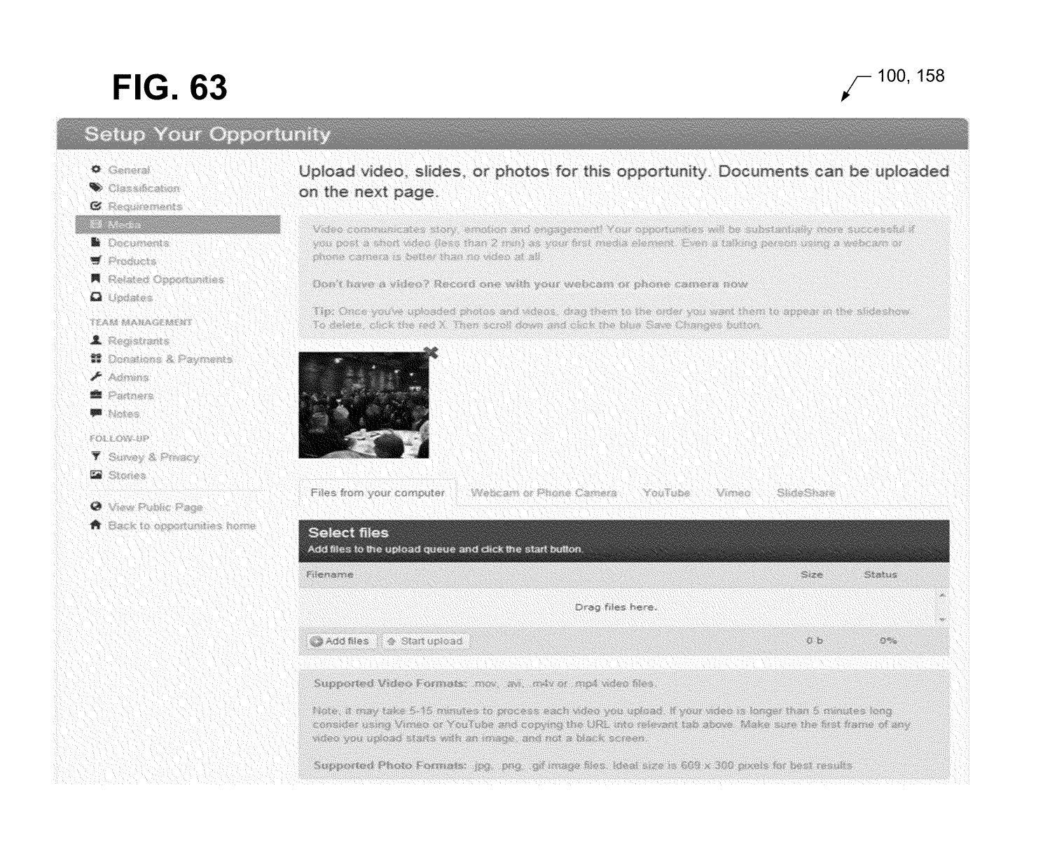

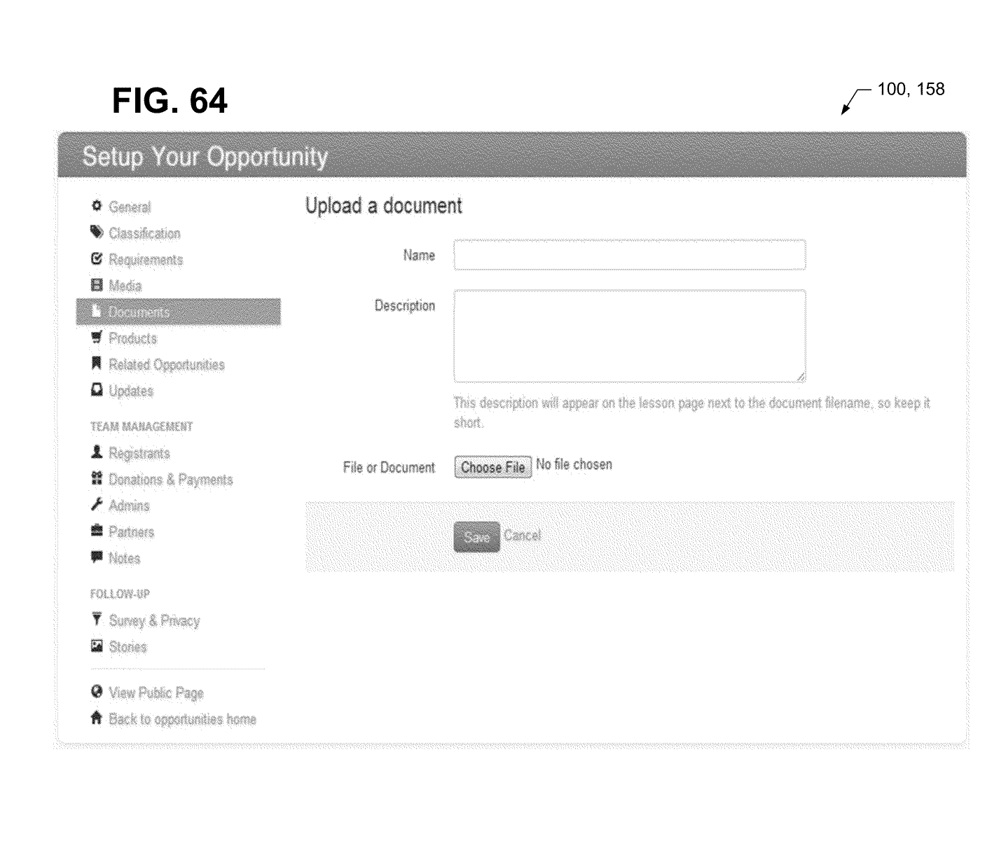

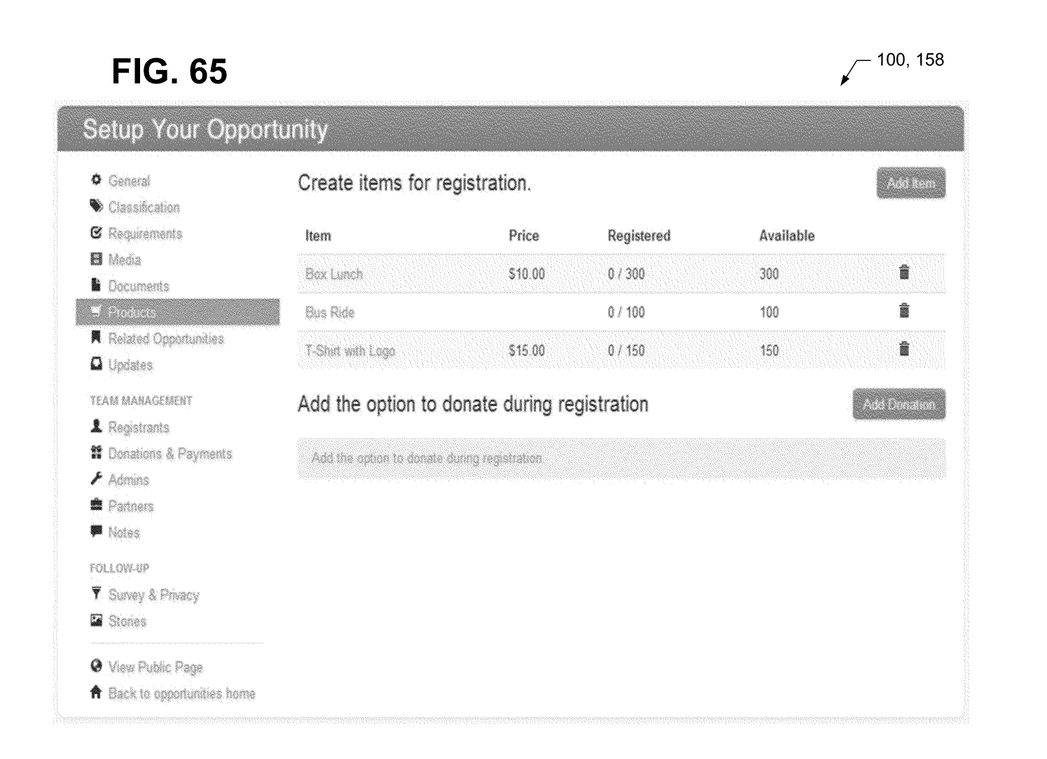

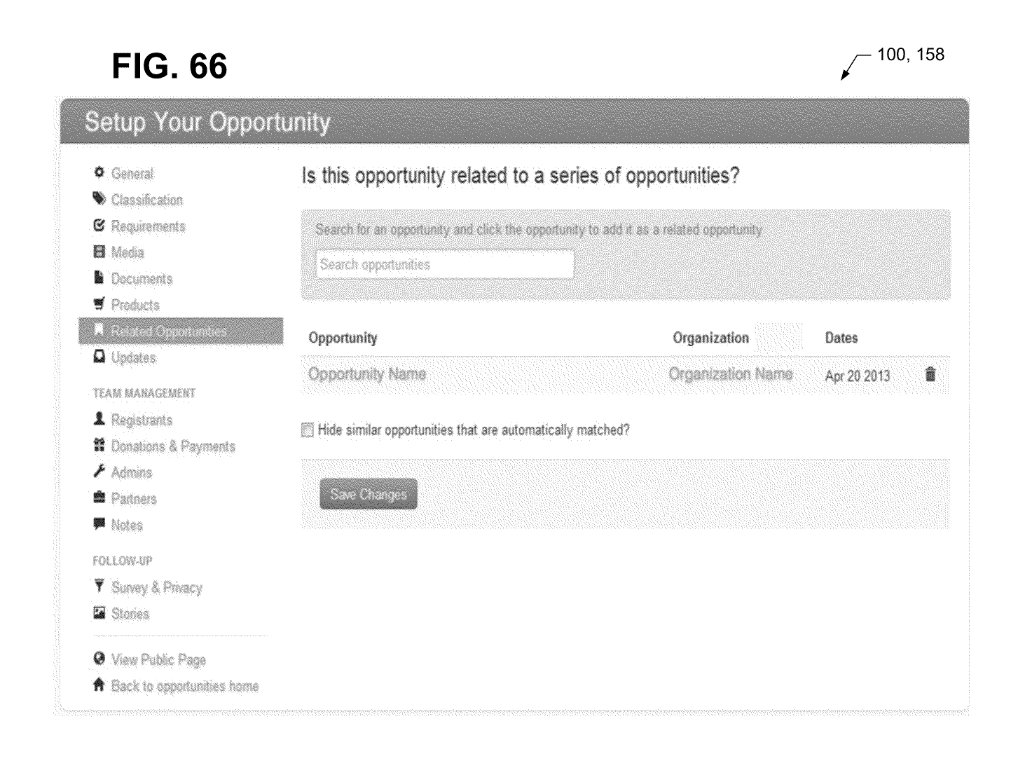

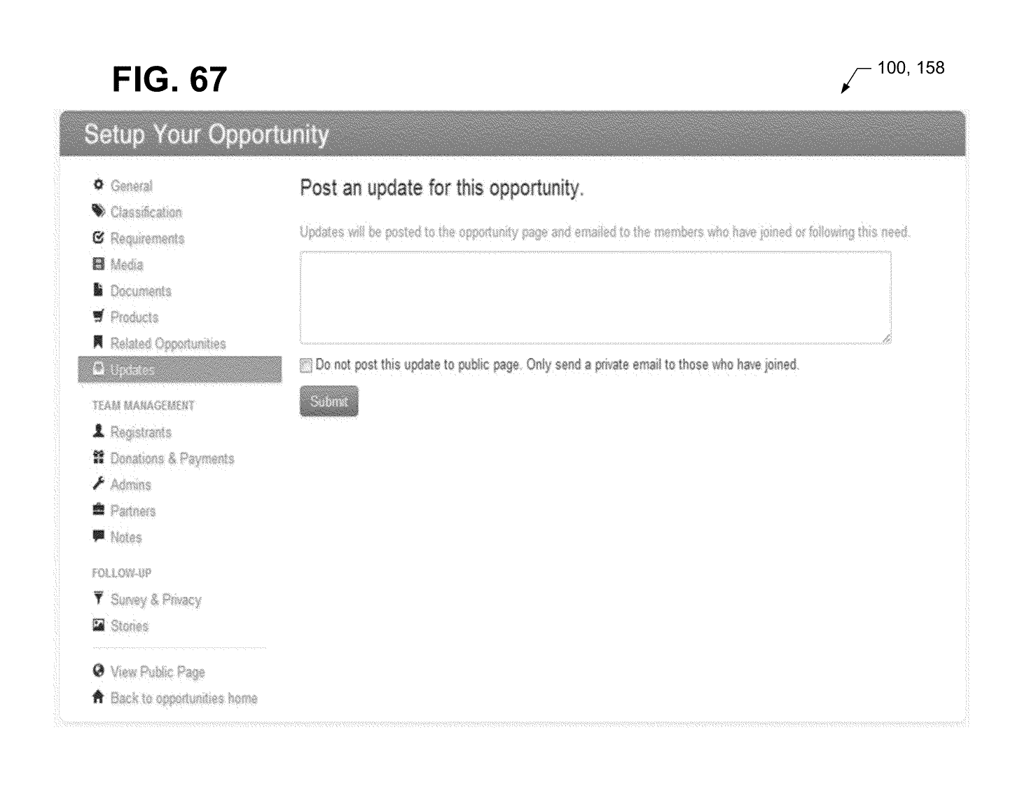

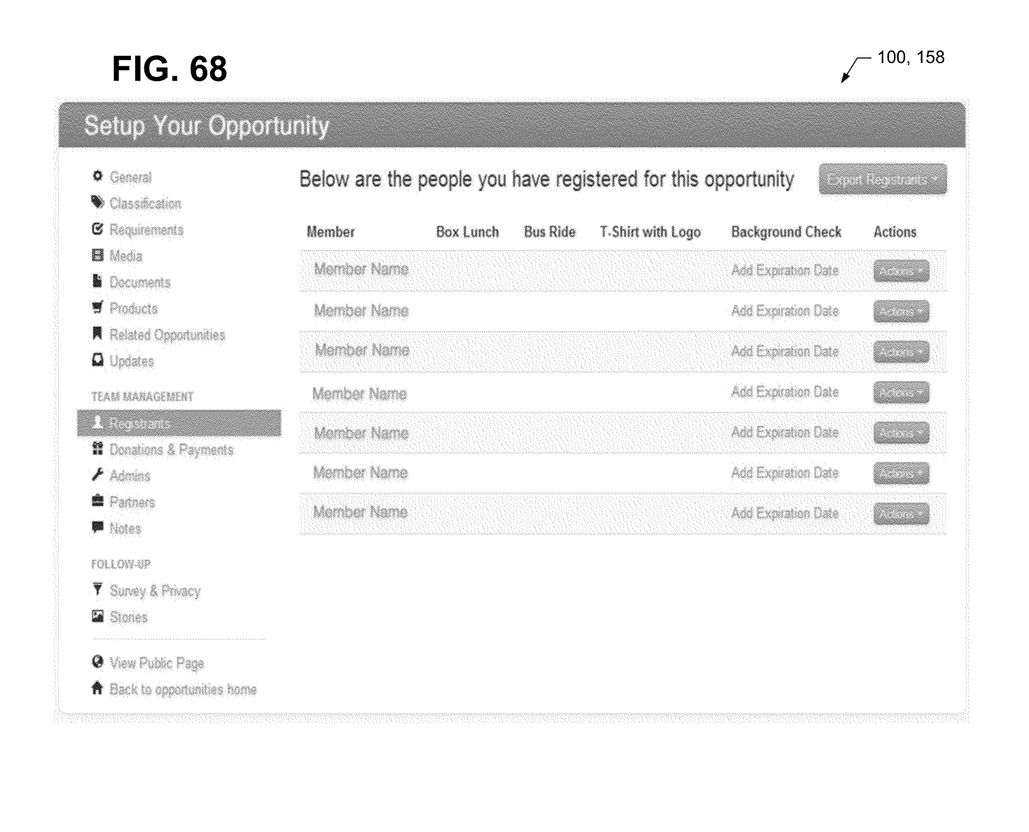

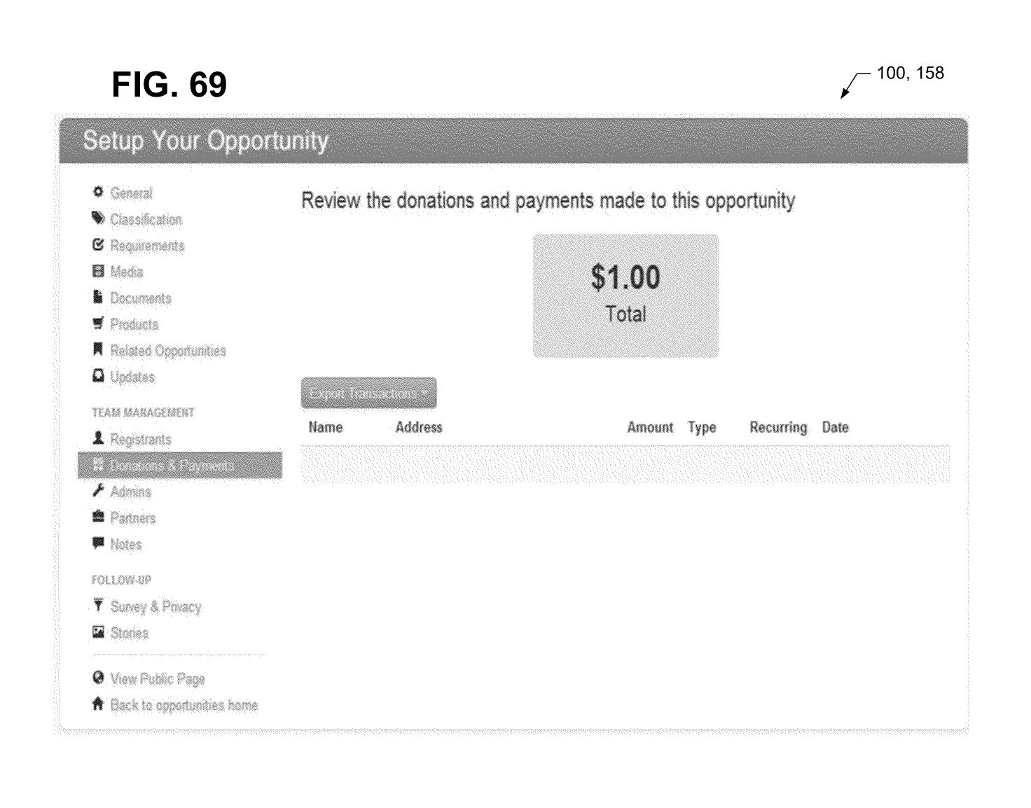

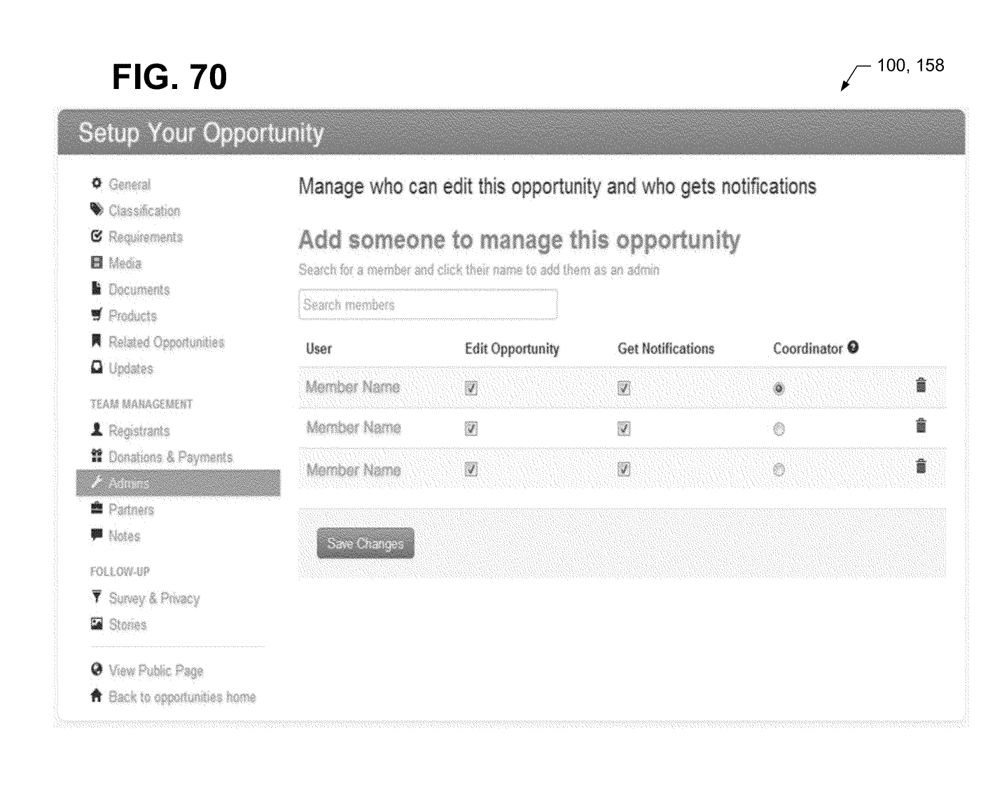

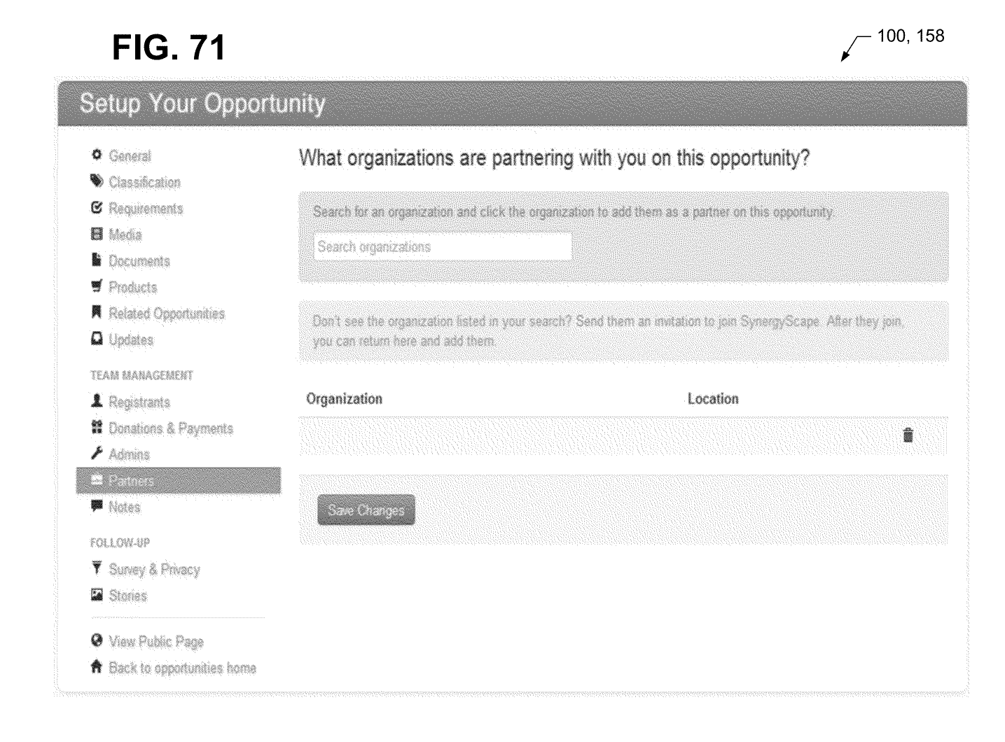

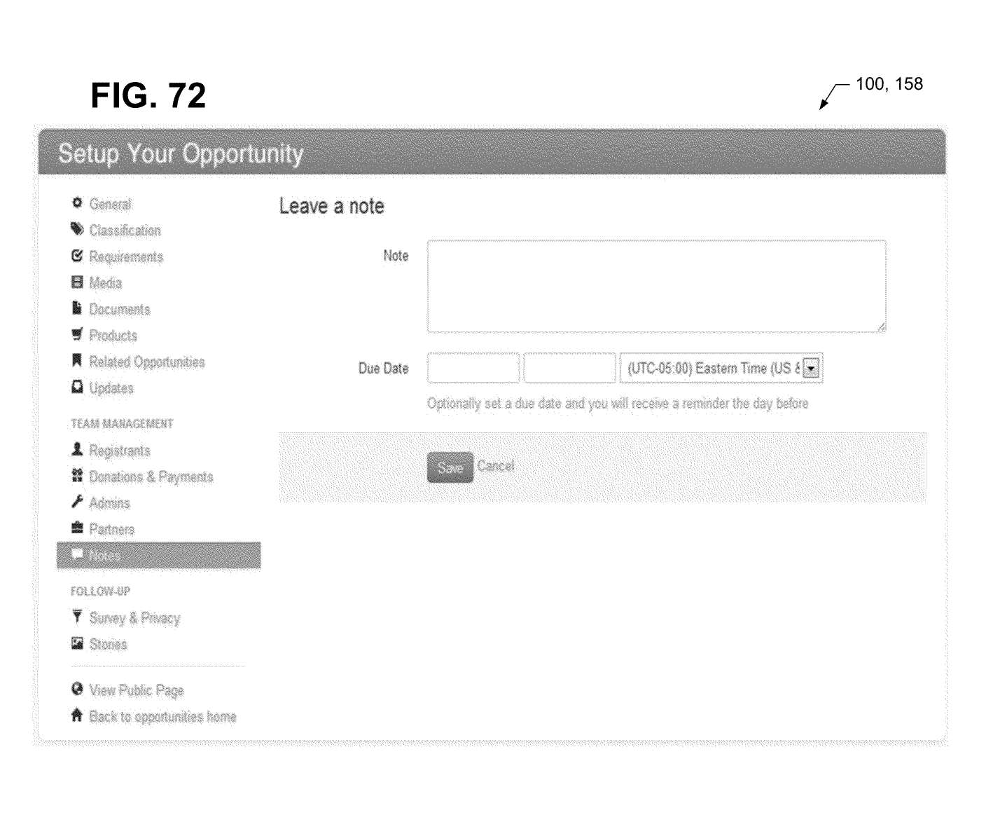

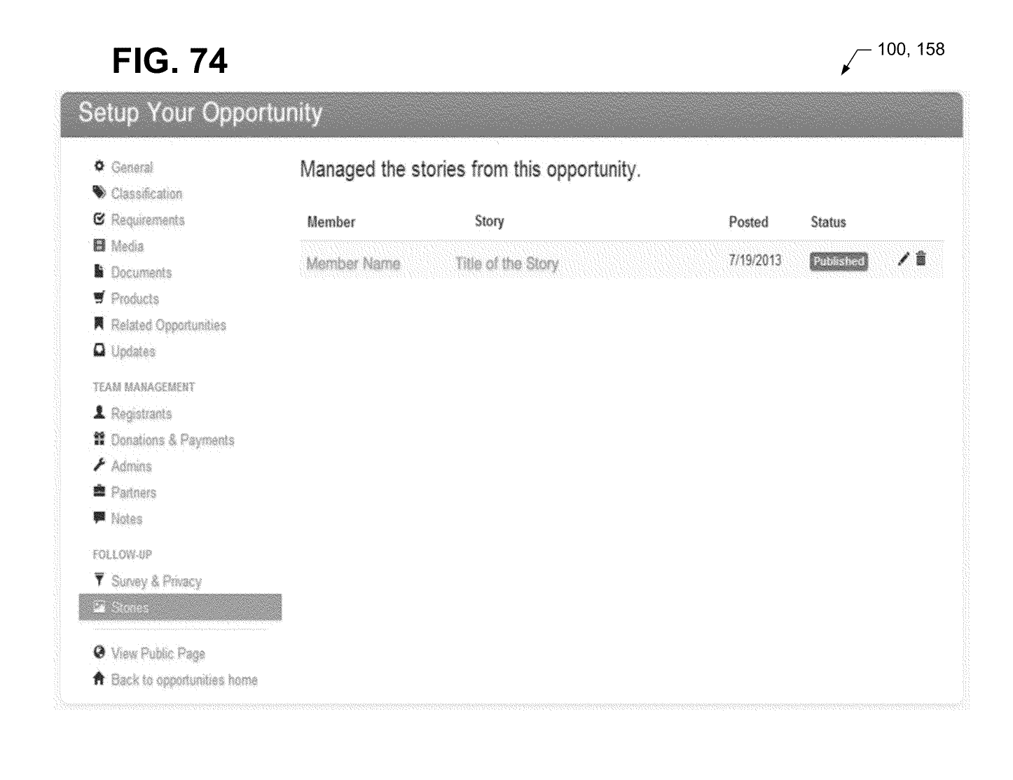

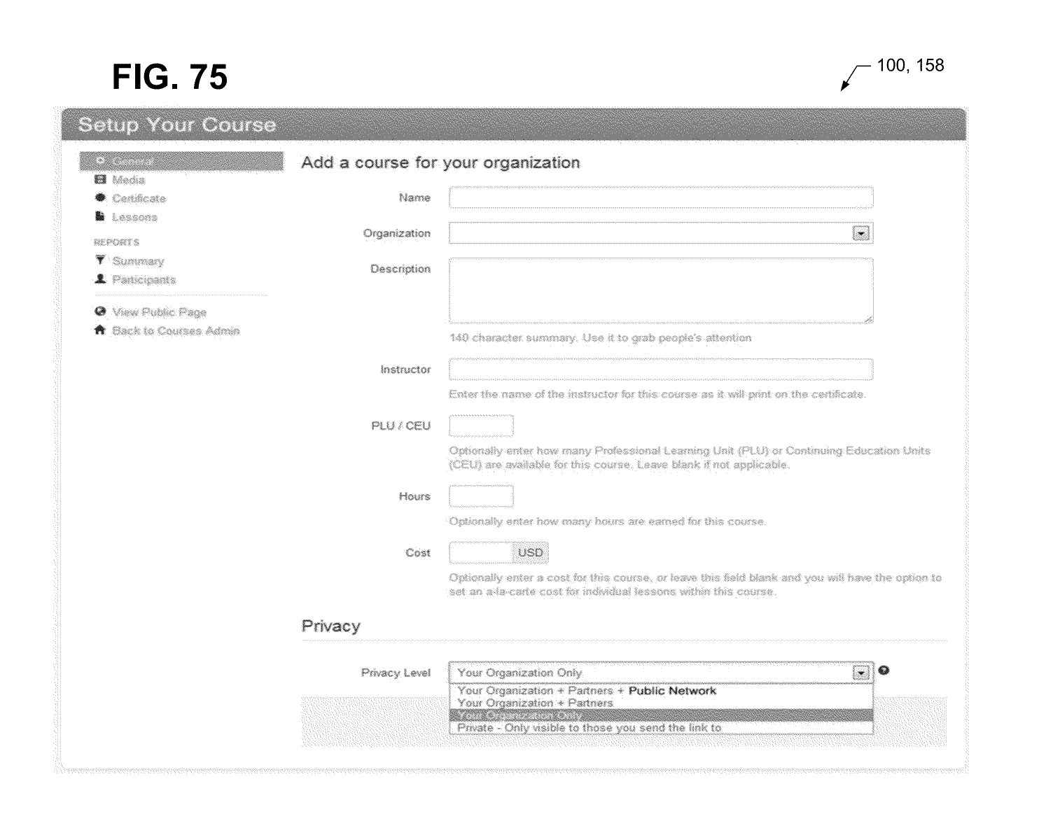

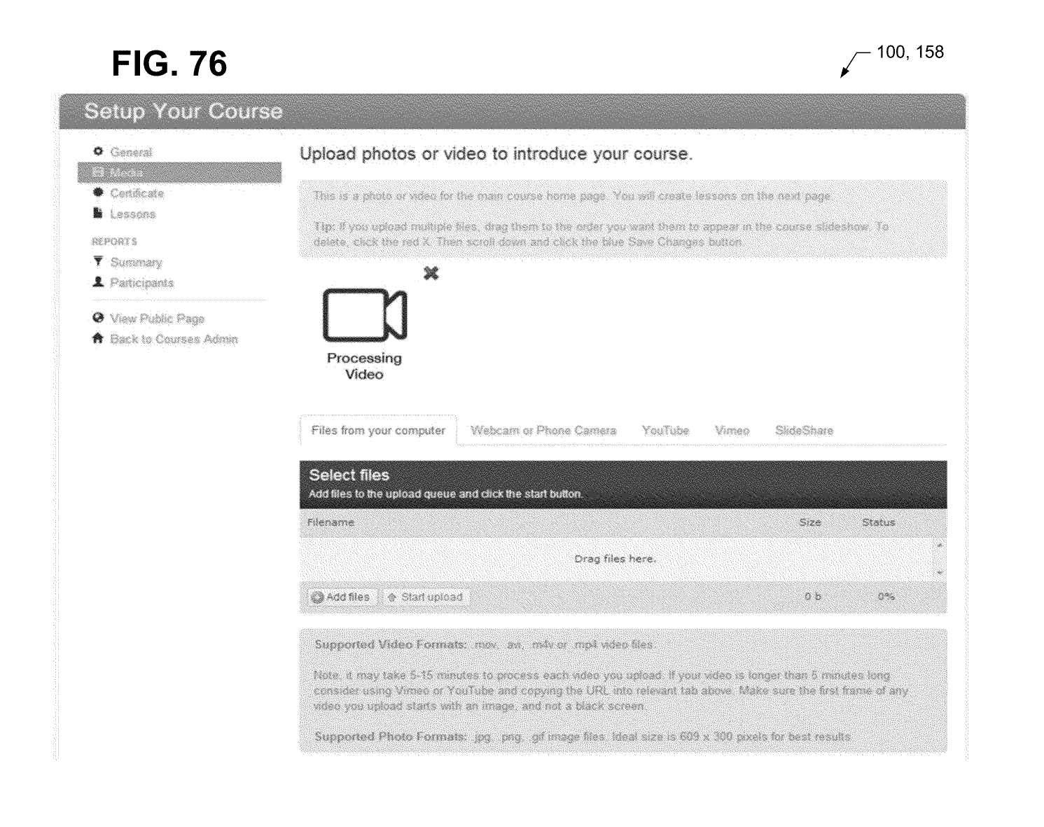

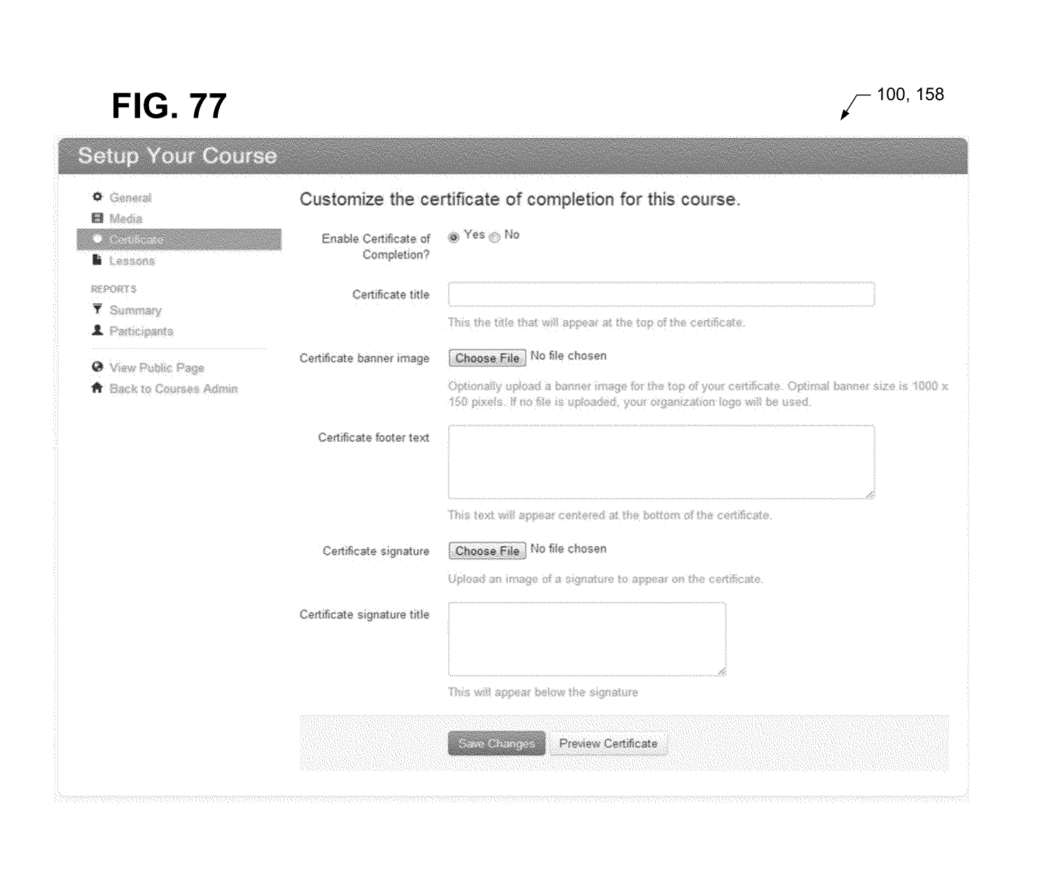

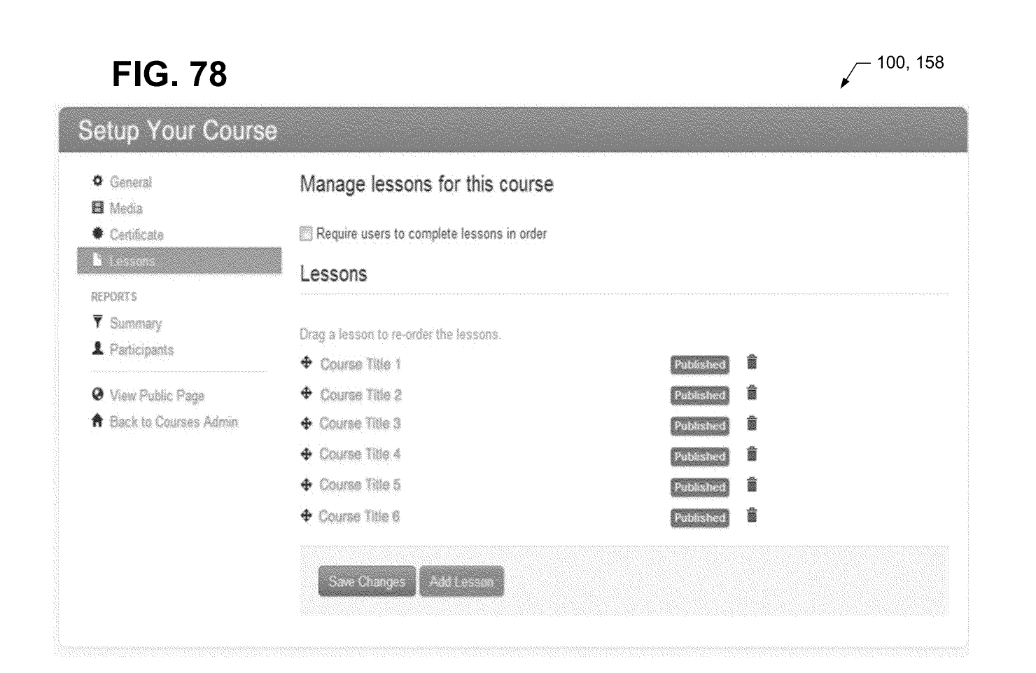

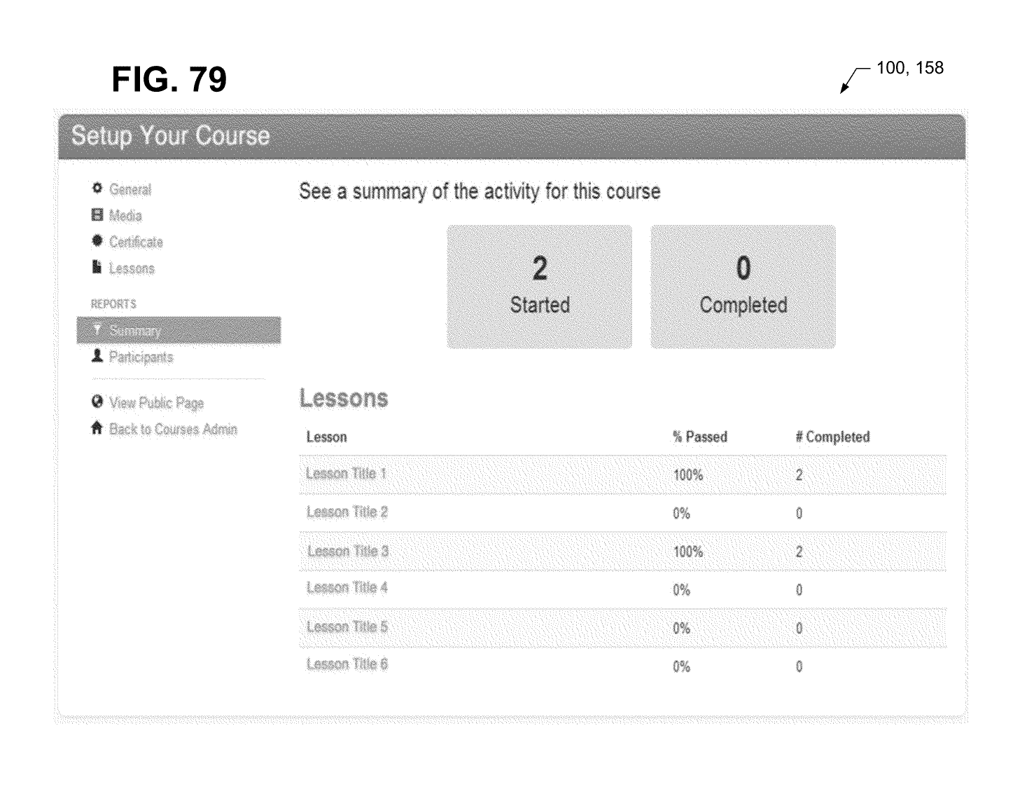

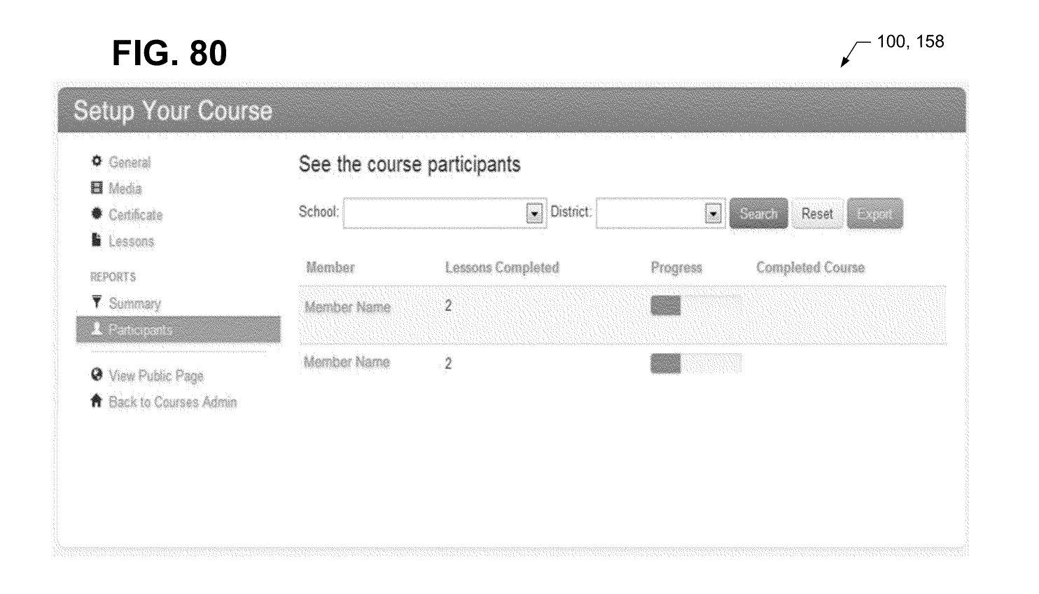

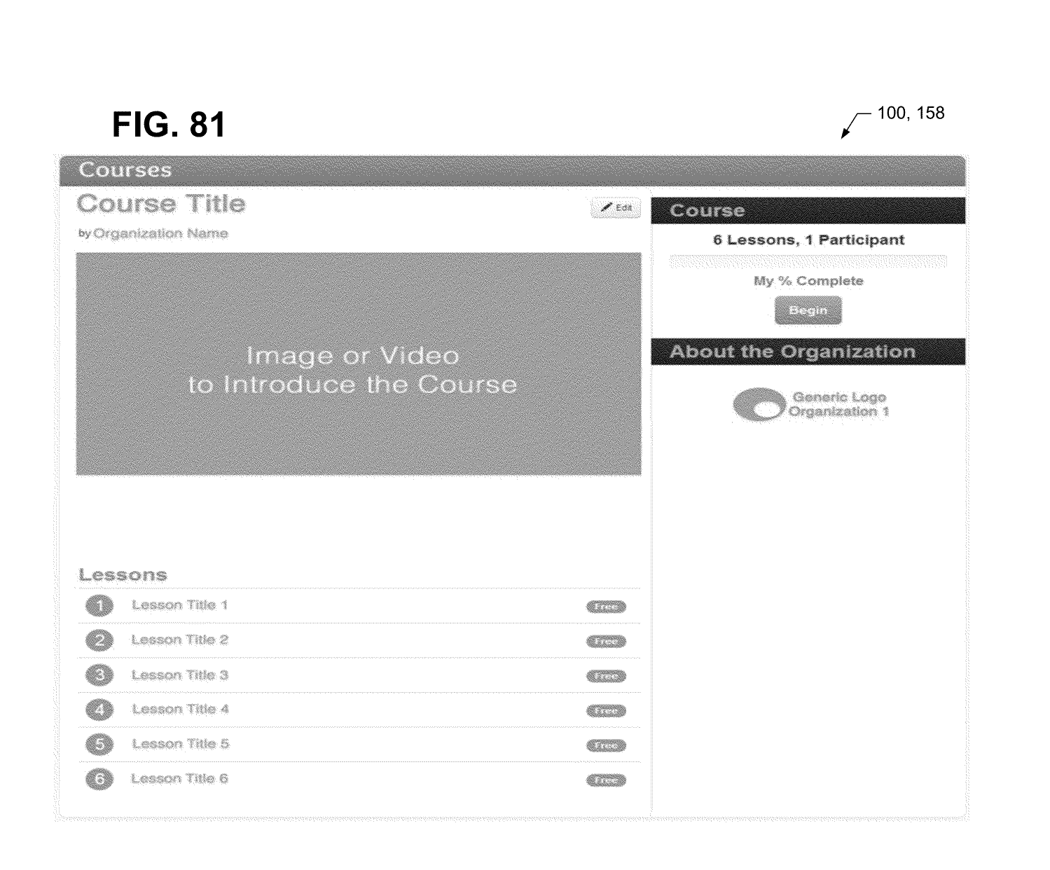

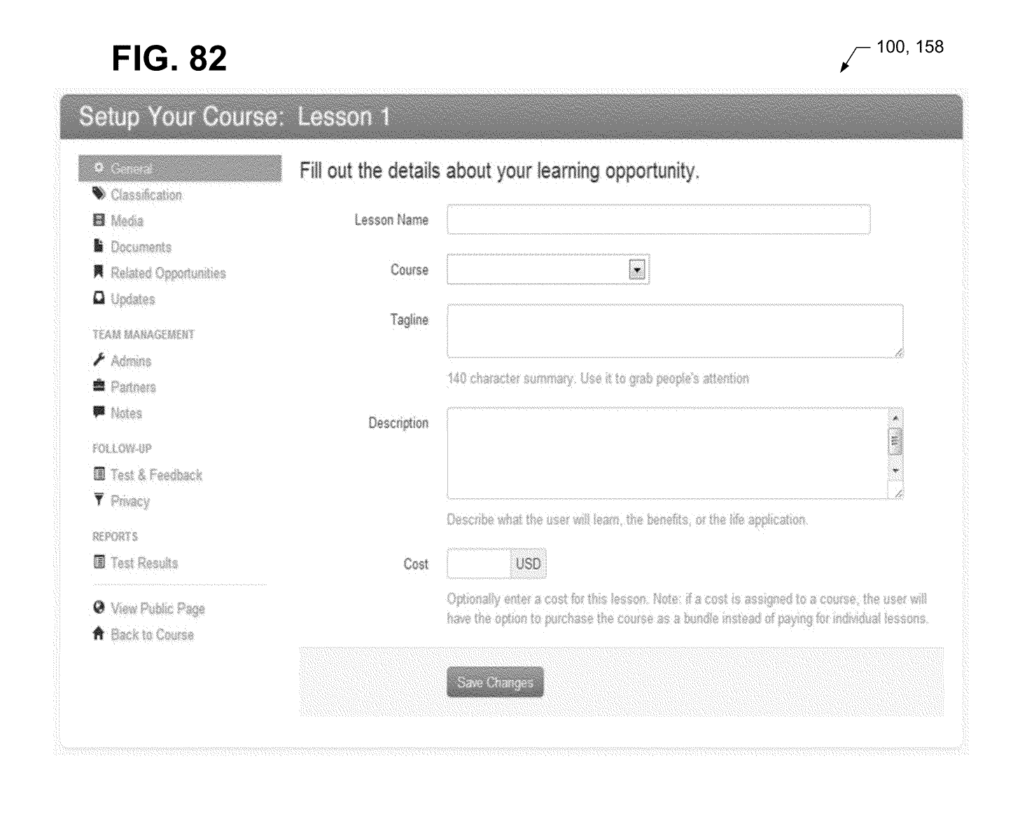

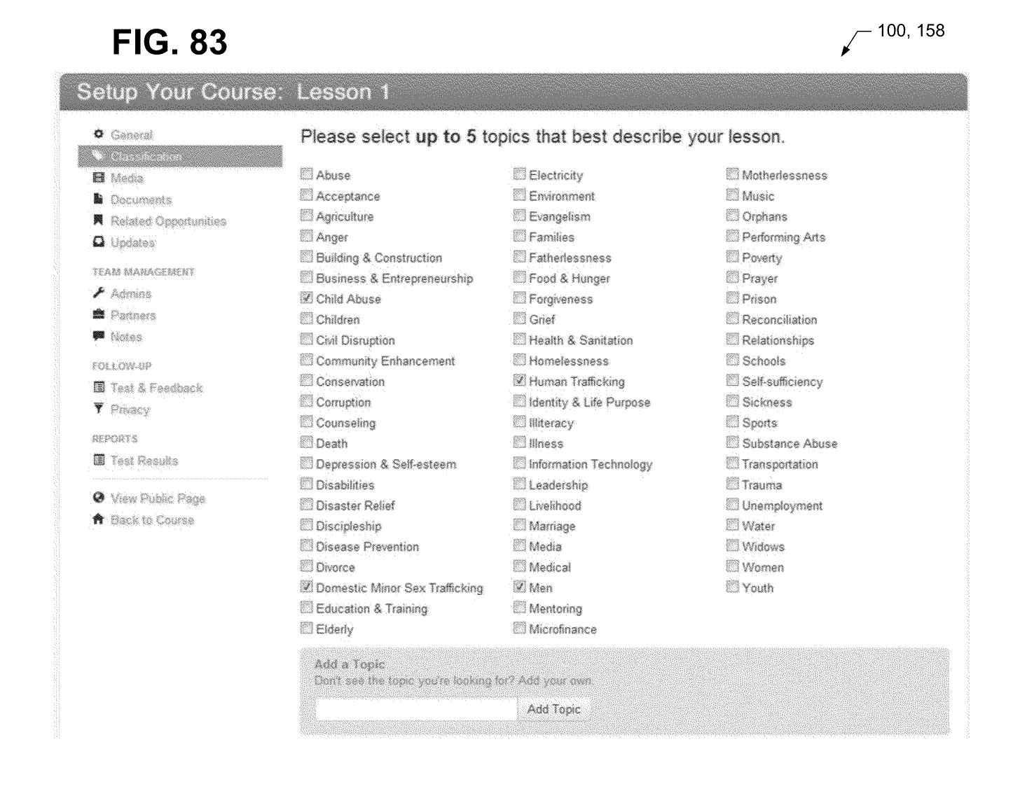

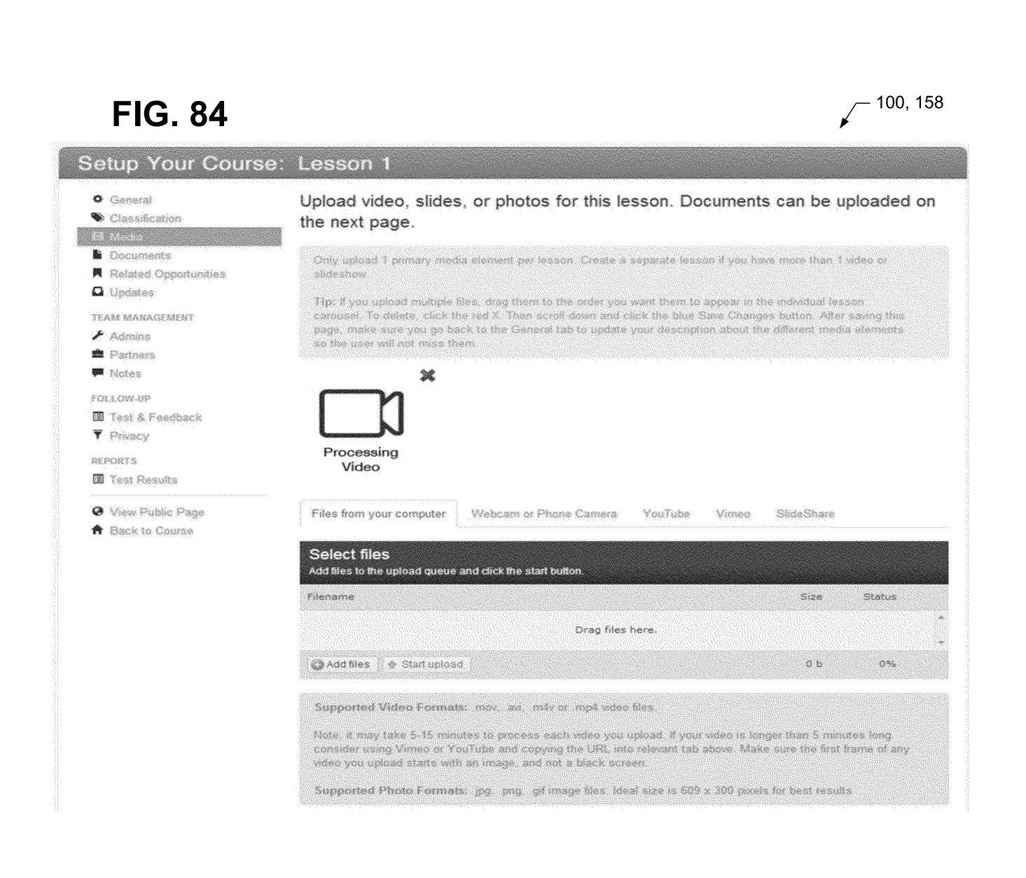

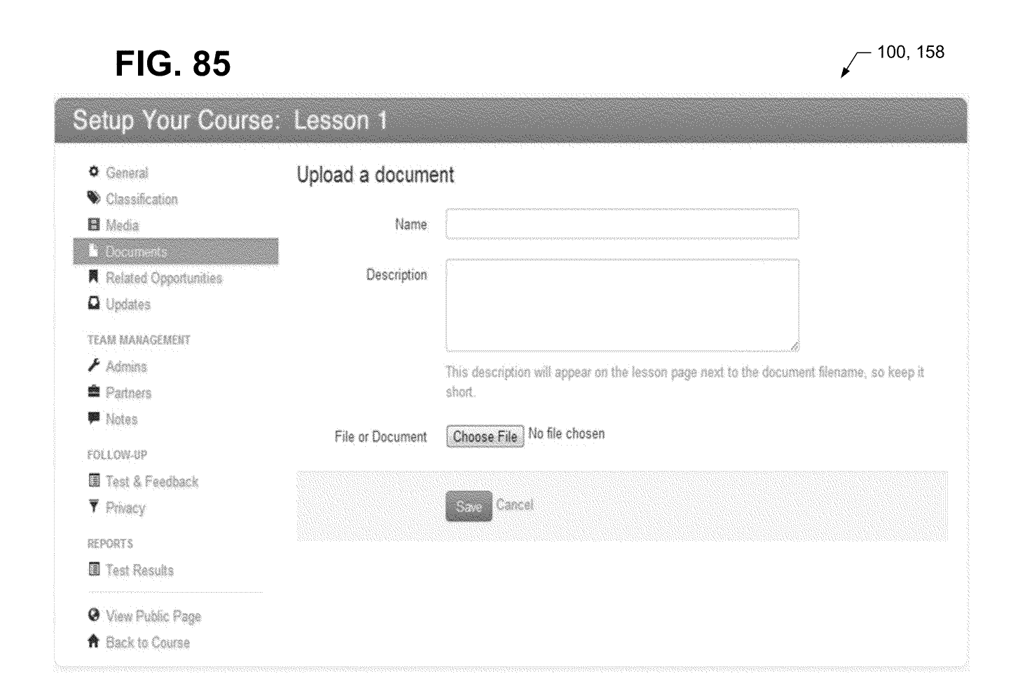

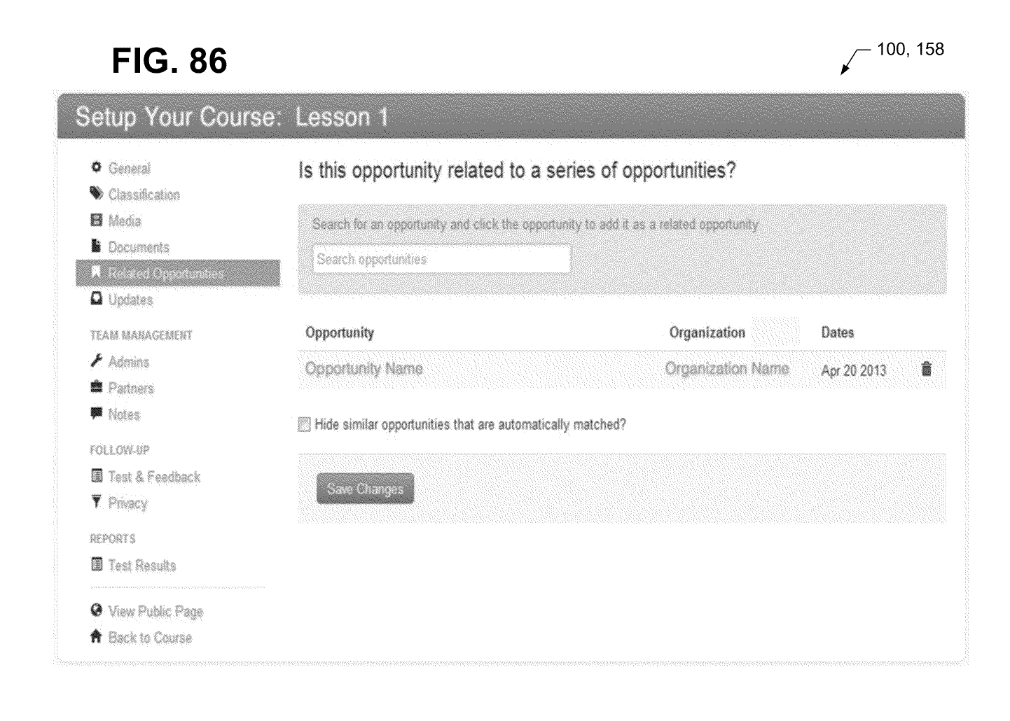

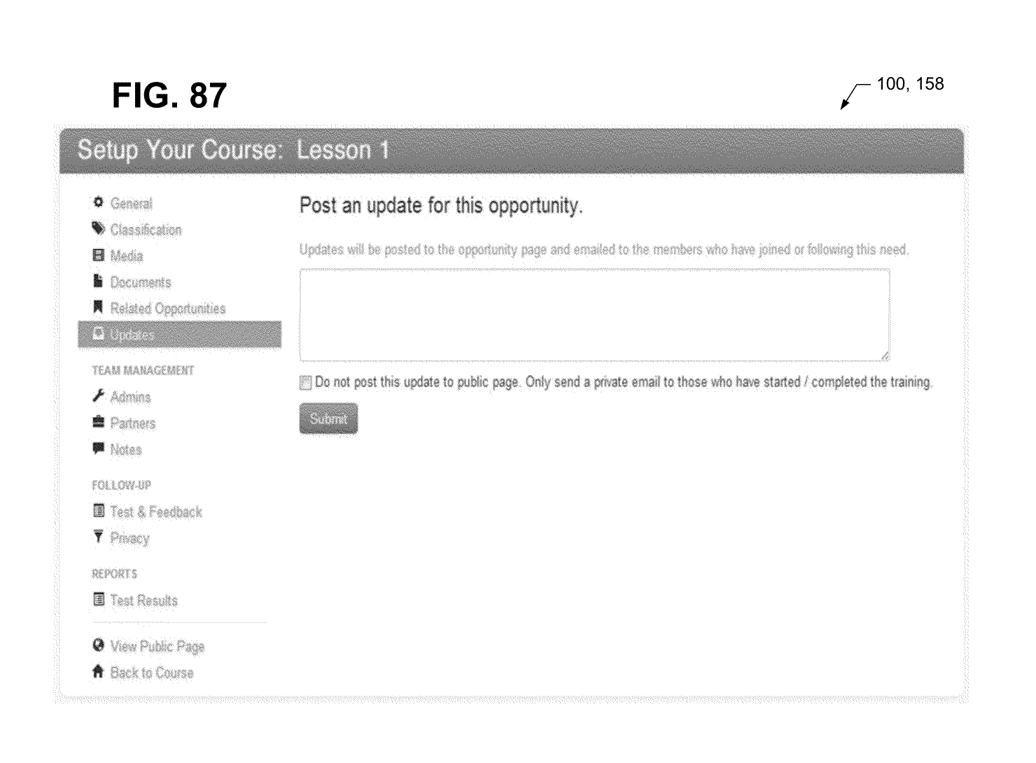

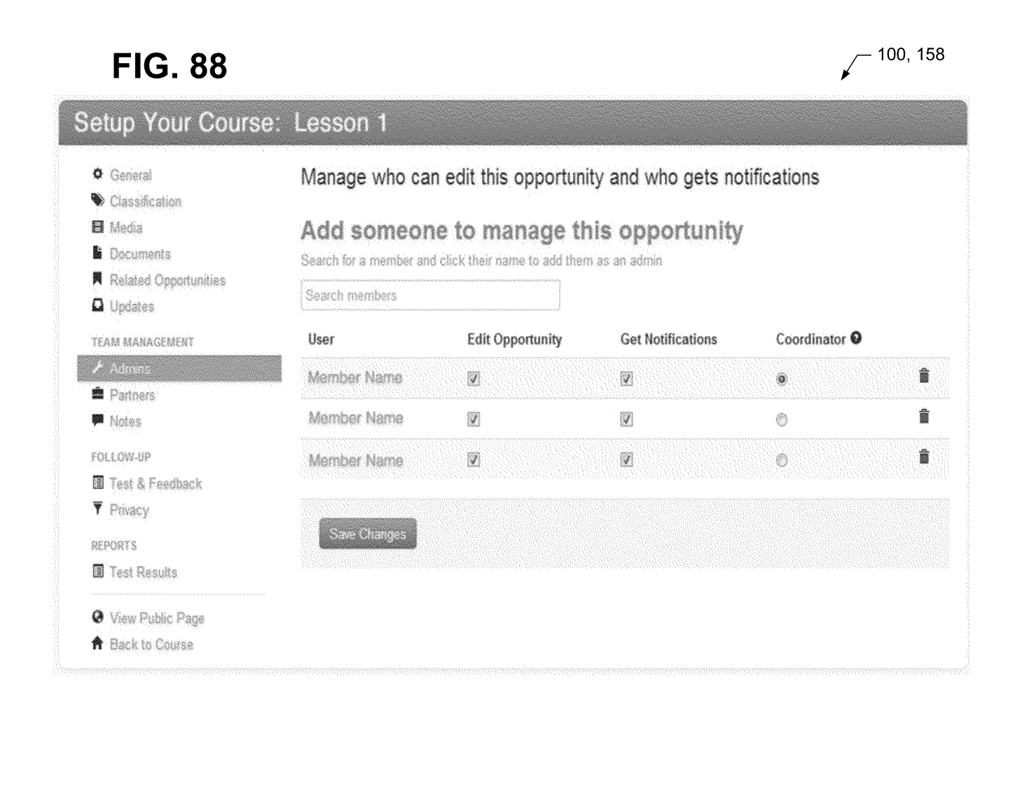

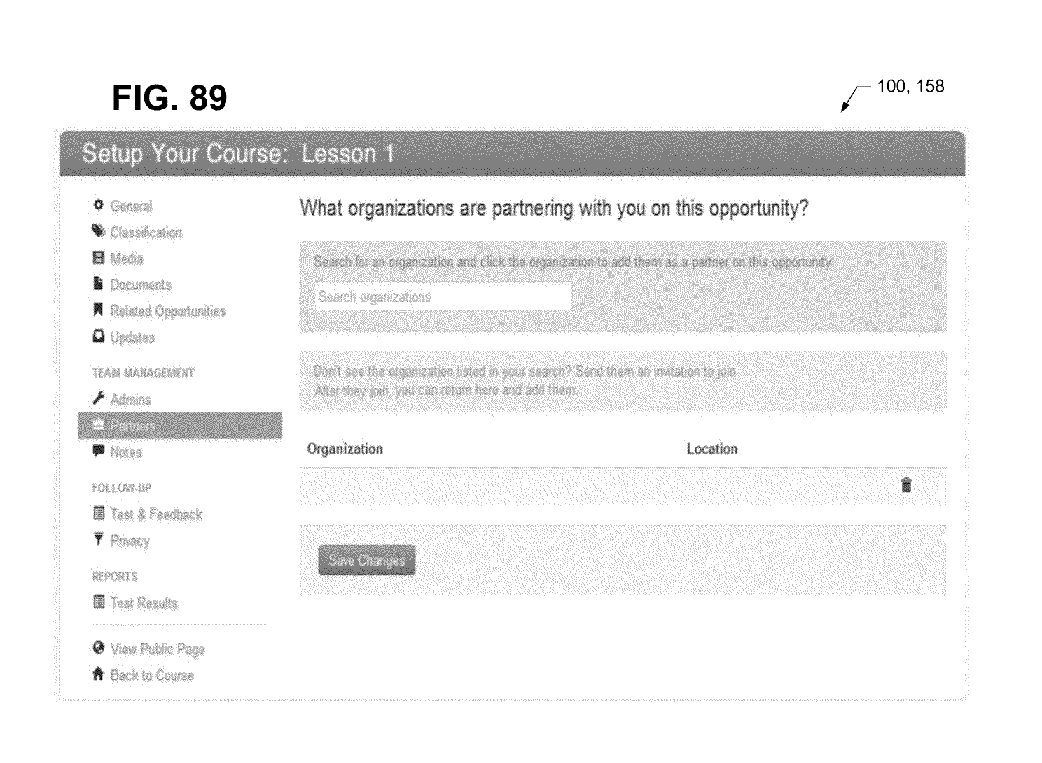

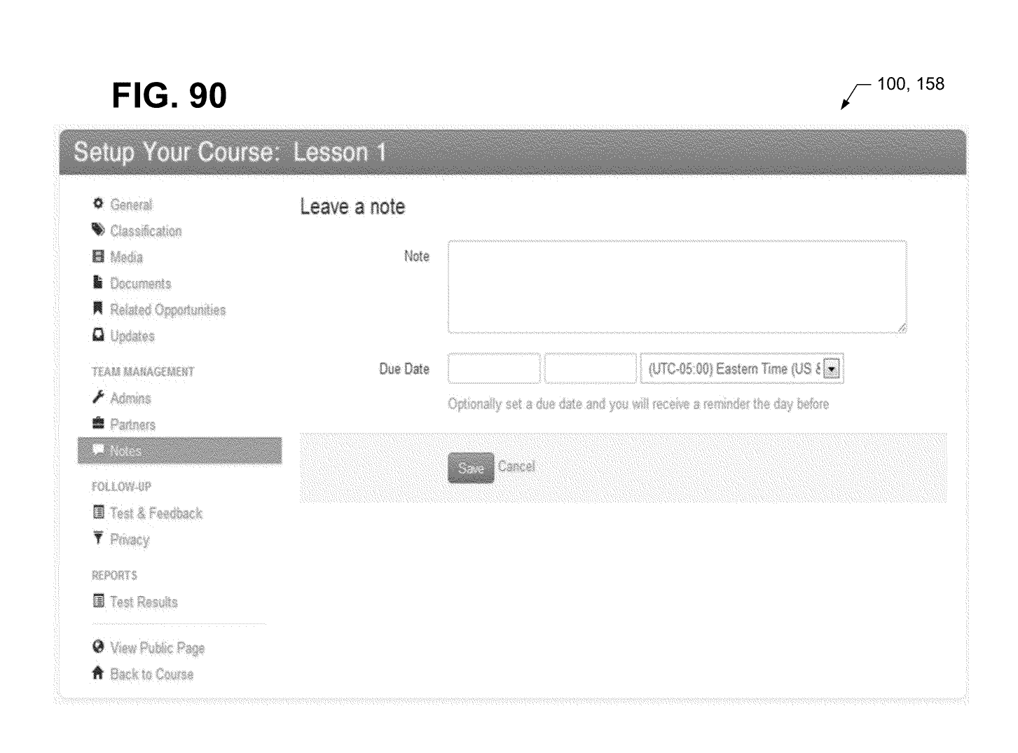

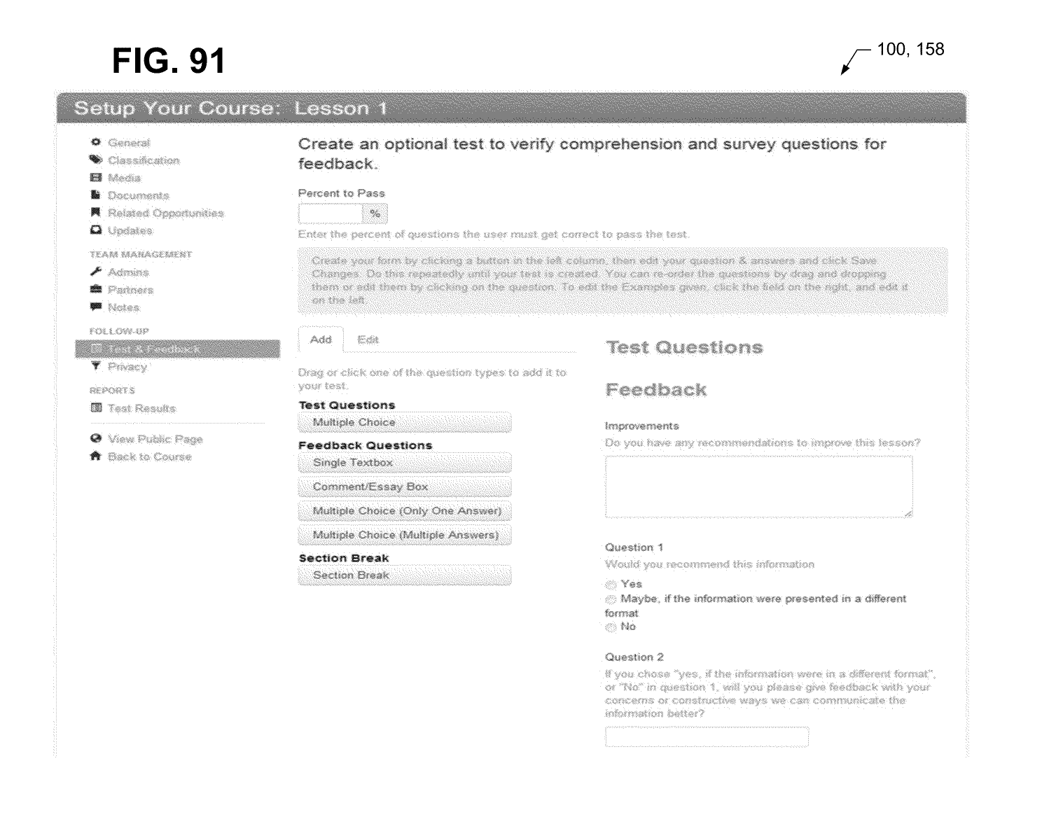

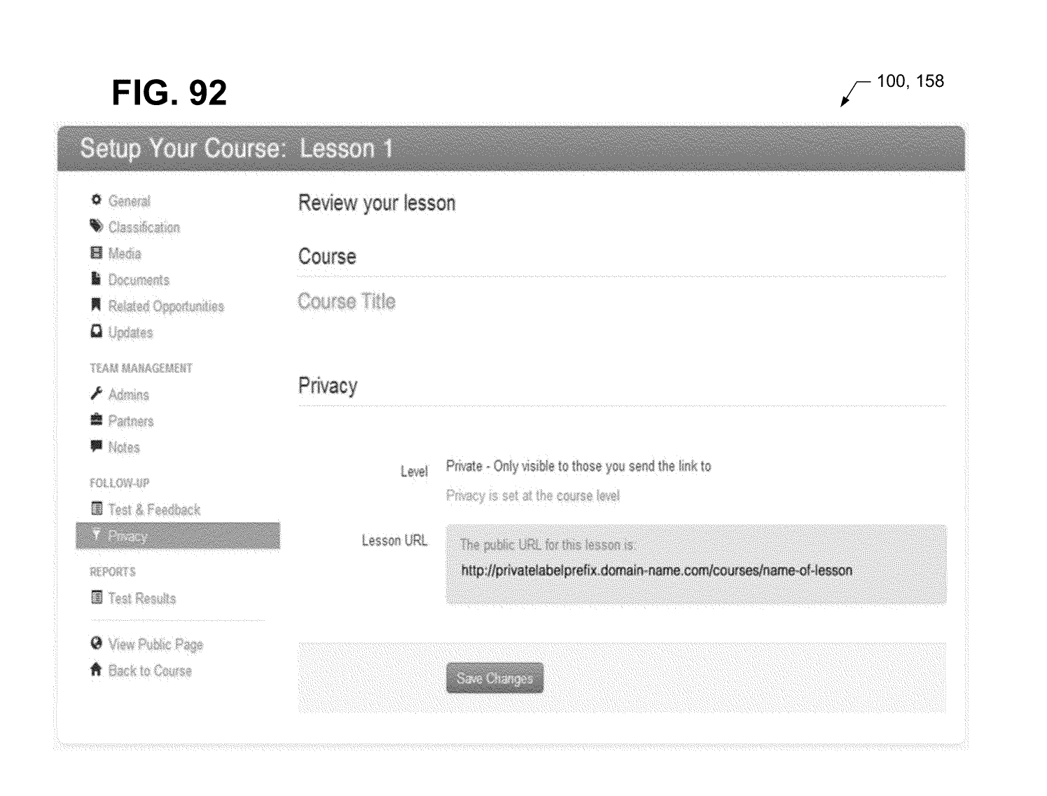

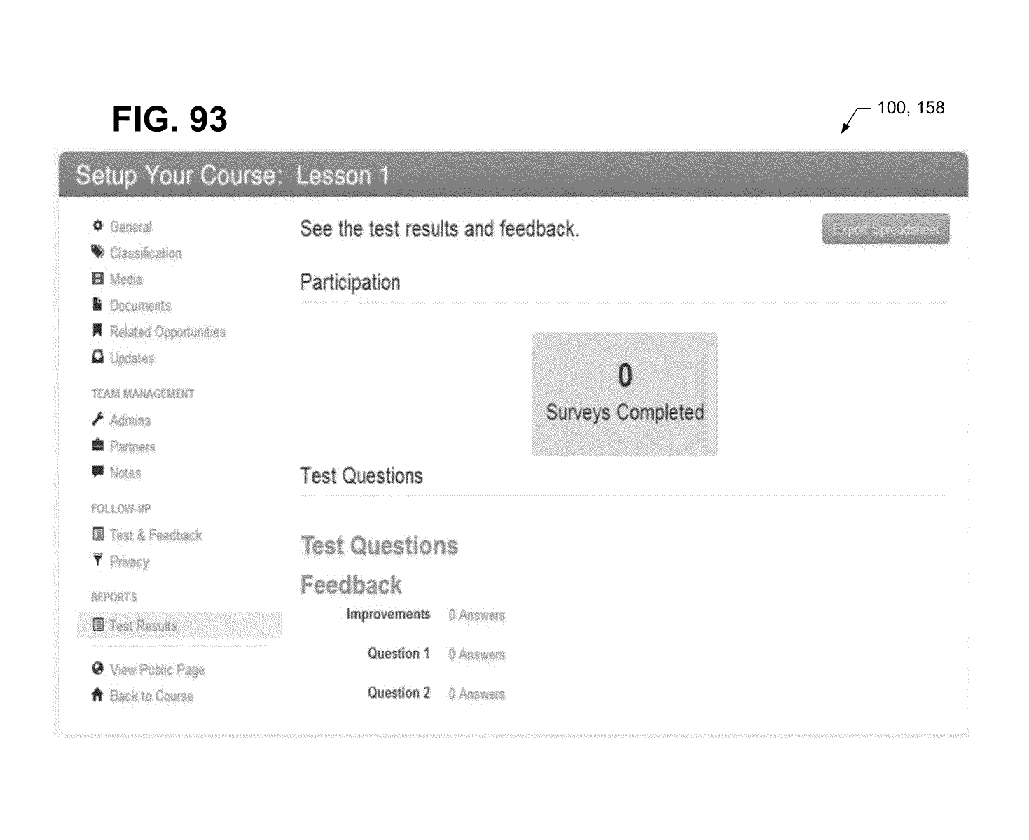

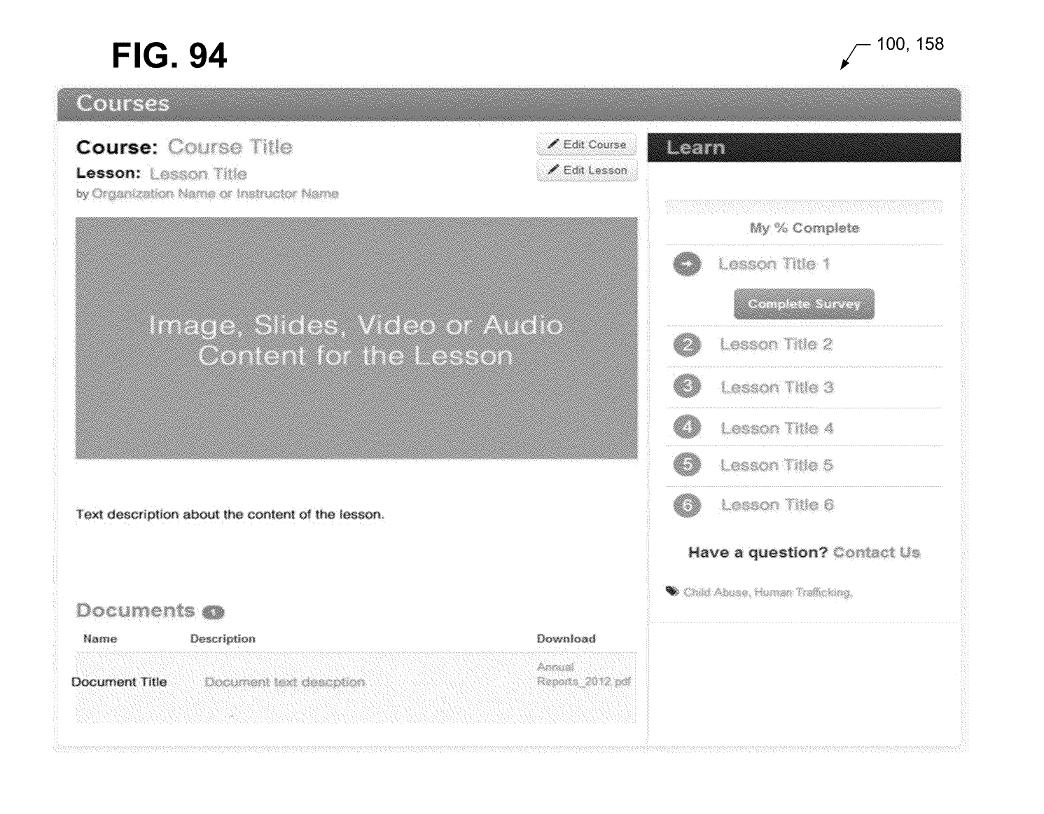

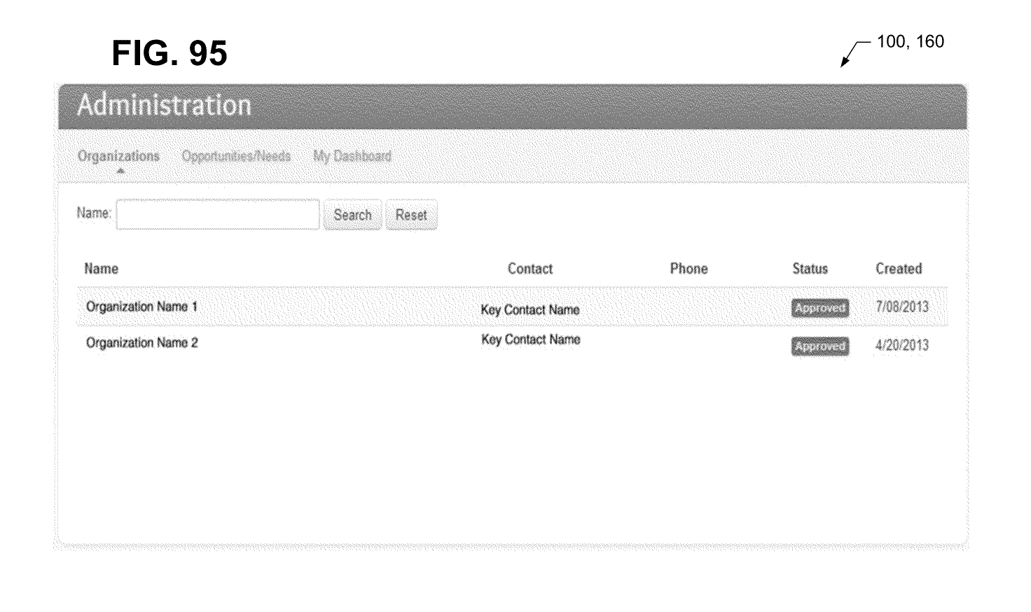

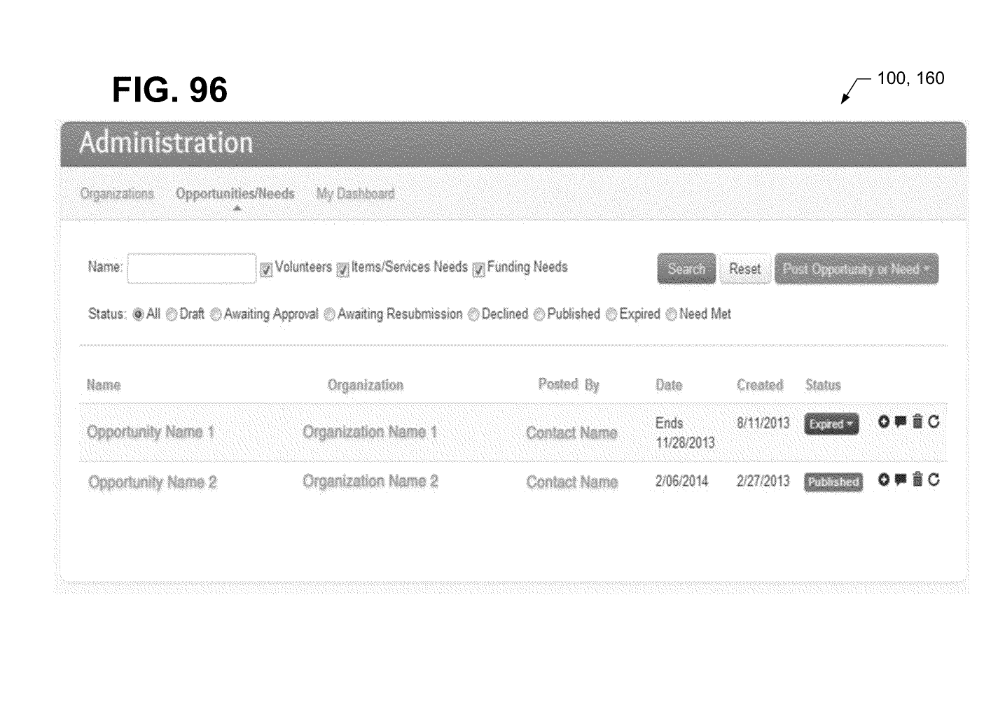

The software and data of the server computer system 100 logically comprises web application software 138, database manager software 140, and a database 142. According to the example embodiment, the web application software 138, when executed and used by the server computer system 100, causes the server computer system 130 to communicate programming (generally in the form of HTML, CSS, Javascript, or an equivalent) and/or data to the web browsers of user devices 132 during communication sessions therewith, with such web browsers executing the received programming and using the received data to provide respective graphical user interfaces in the form of user interface pages 150 (also sometimes referred to as “web pages 150”) to the users of the user devices 132. The user interface pages 150 include, without limitation: member dashboard user interface pages 152 (see FIGS. 4A-29) that are used by the system 100, for example, to interact with members 104 via their respective user devices 132 and to receive, edit and display member data 144; member user interface pages 154 (see FIGS. 30-43) that are used the system 100, for example, to interact with members 104 or other users in order to initiate searches for synergistic matches 110 with other members 104 and to present search results and related information; organization user interface pages 156 (see FIGS. 44-56) that are used the system 100, for example, to interact with members 104 or other users in order to initiate searches for synergistic matches 110 with organizations 106 and to present search results and related information; opportunity user interface pages 158 (see FIGS. 57-94) that are used the system 100, for example, to interact with members 104 or other users in order to initiate searches for synergistic matches 110 with opportunities 108 and to present search results and related information; and, administration user interface pages 160 (see FIGS. 95-96) that are used the system 100, for example, to interact with system administrators in order to receive/edit organization data 146 pertaining to organizations 106, and to post/establish opportunities 108 and collect opportunity data 148 related thereto.

Operation of the web application software 138 also causes the server computer system 130 to communicate commands and data with the database manager software 140 in order to store data in and retrieve data from the database 142. Additionally, the web application software 138 causes the server computer system 130 to evaluate the persons 104, organizations 106, and opportunities 108 and identify certain persons 104, organizations 106, and/or opportunities 108 as having one or more synergies, commonalities, or alignments with a user, and to order matches 110 based at least on the extent, or number, of their synergies, commonalities, or alignments as described herein. In addition, the web application software 138 causes the server computer system 130 to track the impact that members 104 by collecting key performance indicator data indicating or reflecting the performance of persons 104 on opportunities with which they are involved or engaged, by collecting weights for key performance indicators from persons 104 and/or organizations 106, by applying the collected weights as appropriate to produce key performance indicator data weighted for persons 104 or organizations 106, and by aggregating and presenting the weighted and non-weighted key performance indicator data for persons 104, organizations 106, opportunities 108, or globally for the entire system 100. In accordance with the example embodiment, the web application software 138 is implemented using the Application Service Provider web application framework with the Model-View-Controller pattern version 4 (“ASP.NET MVC4”) and Windows Server 2012 with Internet Information Services version 8 (“IIS 8”) available from Microsoft Corporation of Redmond, Washington. It should be understood and appreciated that other frameworks, extended frameworks, software, and/or technology may be used in connection with alternate embodiments.

The database manager software 140, when executed by the server computer system 130, causes the server computer system 130 to store or retrieve data from the database 142 in response to receiving an appropriate command and/or data from the web application software 138. According to the example embodiment, the database manager software 140 comprises a relational database manager such as, for example, SQL Server 2008 available from Microsoft Corporation of Redmond, Washington. The database 142 includes multiple data tables to store the data required for operation and use of the system 100. From a logical perspective and without limitation, the data tables store member data 144, organization data 146, and opportunity data 148.

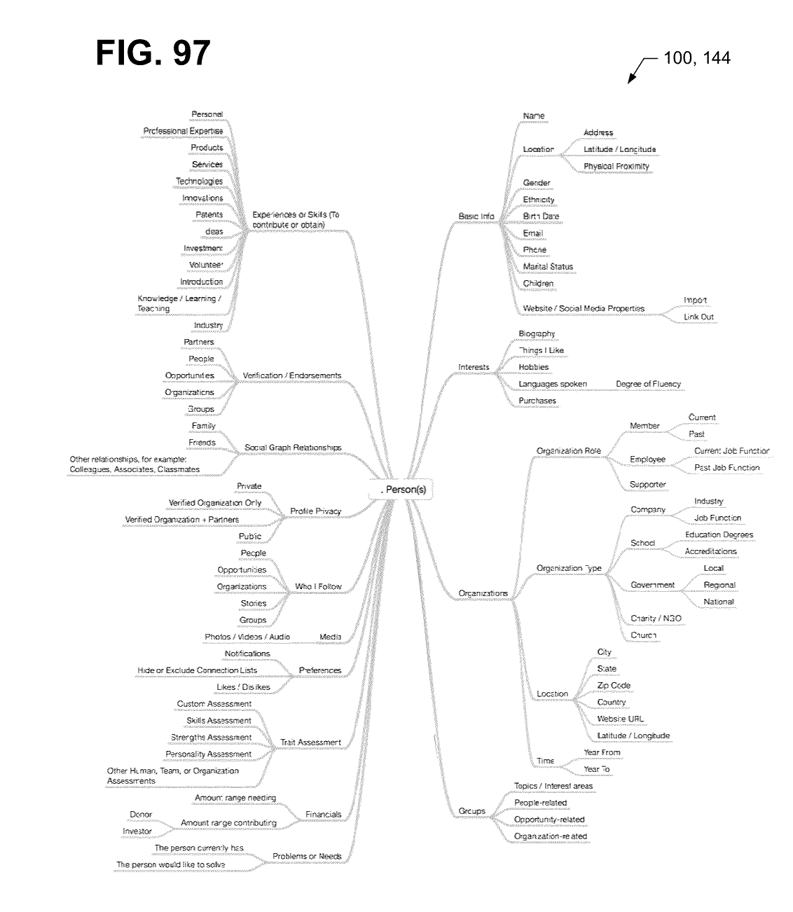

The member data 144, illustrated in FIG. 97, comprises data related to members 104 that is received by and/or stored on a data storage device of the server computer system 130. For each member 104, the member data 144 includes, but is not limited to: (i) basic data such as the member's name, contact information, birth date, gender, ethnicity, and the latitude/longitude for the member's location; (ii) data describing the member's interests, hobbies, and spoken languages; (iii) data pertaining to organizations such as the member's past and current employers, schools attended, churches attended, and charities; (iv) groups to which the member 104 belongs or is associated; (v) data identifying skills or expertise that the member 104 has or desires to obtain; (vi) data identifying members 104, organizations 106, opportunities 108, groups, and partners that have verified/endorsed the member 104 or that the member 104 has verified/endorsed; (vii) data representing the member's profile privacy setting; (viii) data identifying members 104, organizations 106, opportunities 108, groups, and stories followed by the member 104; (ix) data corresponding to the member's preferences such as likes/dislikes; (x) data assessing the member's traits; (xi) financial data defining a range of money needed by the member 104 or a range of money that the member 104 can contribute; and (xii) data describing the problems/needs that the member 104 has or that the member 104 would like to solve.

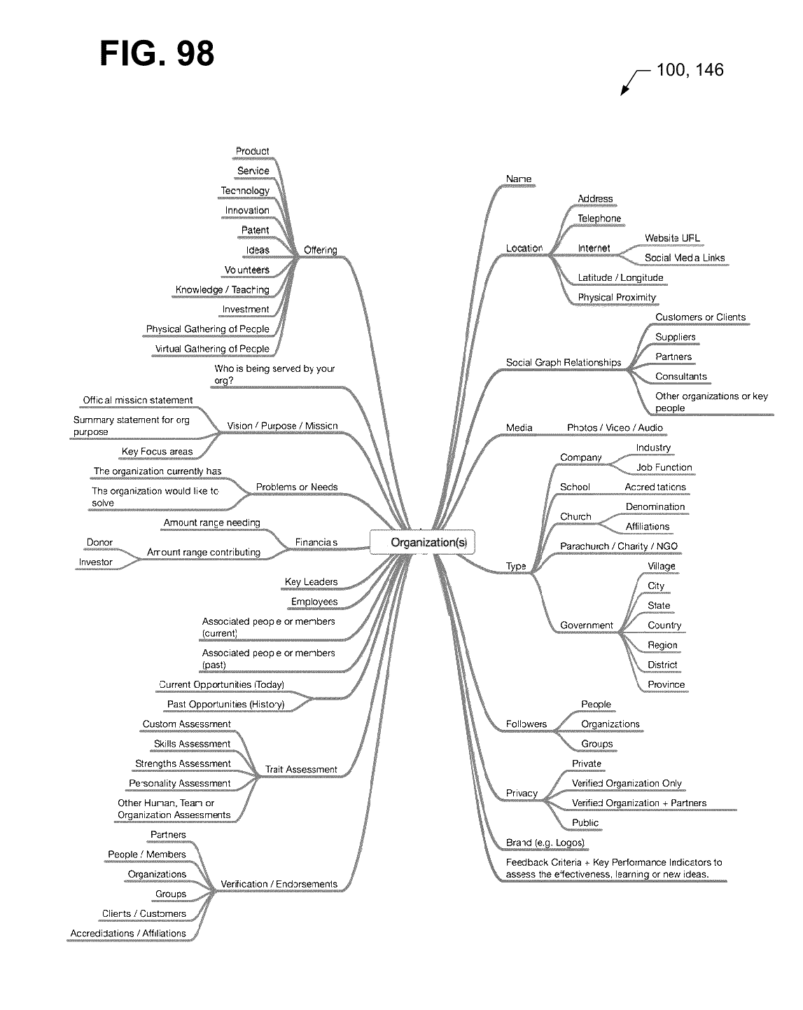

The organization data 146, displayed in FIG. 98, comprises data related to organizations 106 that is received by and/or stored on a data storage device of the server computer system 130. For each organization 106, the organization data 146 includes, but is not limited to: (i) the organization's name; (ii) the organization's contact information and location, including the latitude/longitude of such location; (iii) data identifying other parties with which the organization 106 has relationships such as, for example, customers, clients, suppliers, partners, and others; (iv) data corresponding to media; (v) data describing the organization's type; (vi) data identifying the organization's followers; (vii) data representing the organization's profile privacy setting; (viii) data corresponding to logos or branding; (ix) key performance indicator data and feedback data used to assess the organization's impact; (x) data identifying the organization's offerings such as, for example, products, services, technology, innovations, patents, ideas, volunteers, knowledge, investments, and physical and virtual gatherings of people; (xi) data describing the organization's mission, vision or purpose; (xii) data identifying who is being served by the organization 106; (xiii) data describing the organization's problems/needs and problems/needs the organization 106 would like to solve; (xix) financial data defining a range of money needed by the organization 106 or a range of money that the organization 106 can contribute; (xx) data identifying past and current associated members 104; (xxi) data describing the organization's past and current opportunities 108; (xxii) data assessing the organization's traits; and (xxiii) data identifying members 104, organizations 106, opportunities 108, groups, partners, clients and customers that have verified/endorsed the organization 106 or that the organization 106 has verified/endorsed.

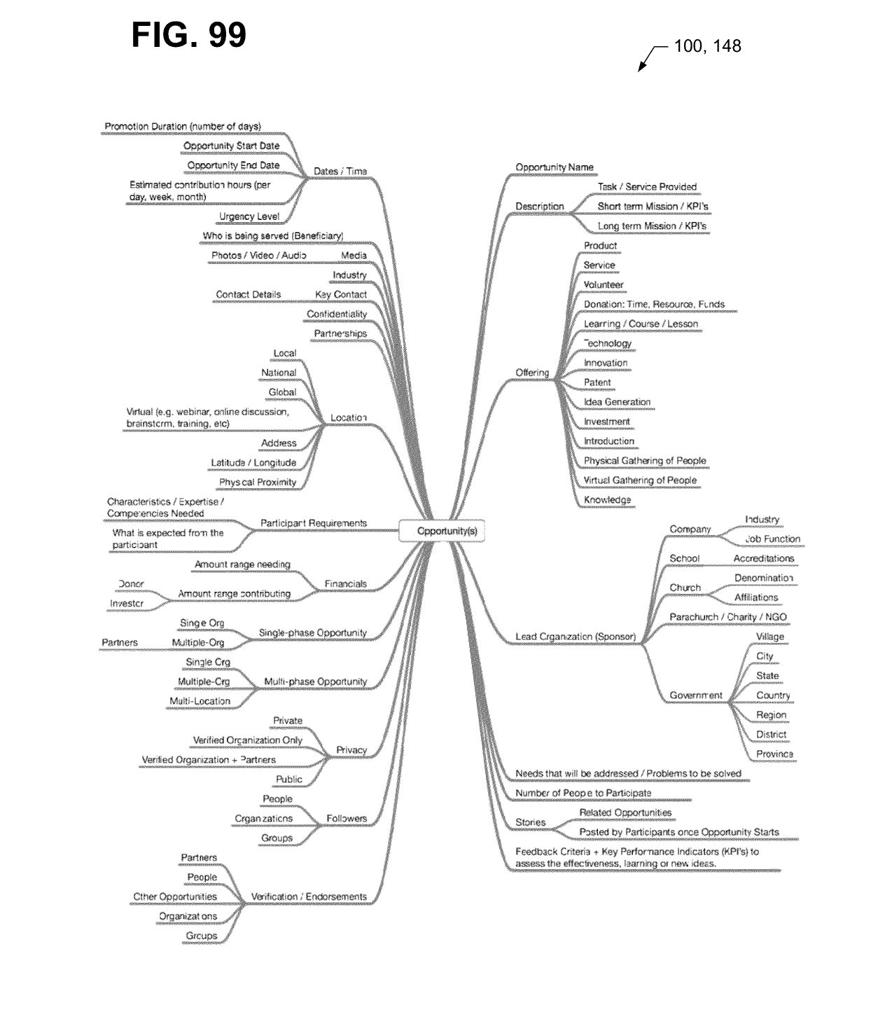

The opportunity data 148, displayed in FIG. 99, comprises data related to opportunities 108 that is received by and/or stored on a data storage device of the server computer system 130. For each opportunity 108, the opportunity data 148 includes, but is not limited to: (i) the opportunity's name; (ii) data describing the task or services provided as part of the opportunity 108; (iii) data describing what the offering of the opportunity 108, such as products, services, donations of time/resources/funds, learning/courses/lessons, technology, innovation, patent, idea generation, investment, introduction, and physical or virtual gatherings of persons 104; (iv) data identifying and describing the lead sponsoring organization 108; (v) data describing the needs to be addressed or problems to be solved; (vi) data defining the number of persons 104 to participate; (vii) key performance indicator data and feedback data used to assess the opportunity's impact; (viii) data defining the opportunity's duration, start date, end data, and estimated number of hours of contribution required; (ix) data describing the opportunity's beneficiary; (x) the opportunity's key contact and location, including the latitude/longitude; (xi) data identifying requirements for the participants, such as skills, competencies, and expectations; (xii) financial data defining a range of monetary contributions required by the opportunity 108 or a range of monetary contributions needed; (xiii) data identifying the opportunity 108 as a single-phase or multi-phase opportunity together with the organizations 108 and/or partners involved; (xiv) data identifying the opportunity's followers, such as persons 104, organizations 106, and groups; (xv) data identifying members 104, organizations 106, opportunities 108, groups, and partners that have verified/endorsed the opportunity 108; and (xvi) data representing the opportunity's profile privacy setting.

As described above, each of the member data 144, organization data 146, and opportunity data 148 include data representing and defining the privacy setting for the respective member 104, organization 106, or opportunity 108. The system 100 and, more specifically, the server computer system 130 uses the privacy setting to control the viewing of, and data for, the subject member 104, organization 106, or opportunity 108 by a system user. Generally, the system 100 is adapted to receive input relating to a member 104, organization 106, opportunity 108 or group which determines whether the same will be discoverable or synergy-matched within the set privacy levels. Thus, a member 104, organization 106, opportunity 108, or group may be discoverable or not, and information pertaining thereto may be kept fully private.

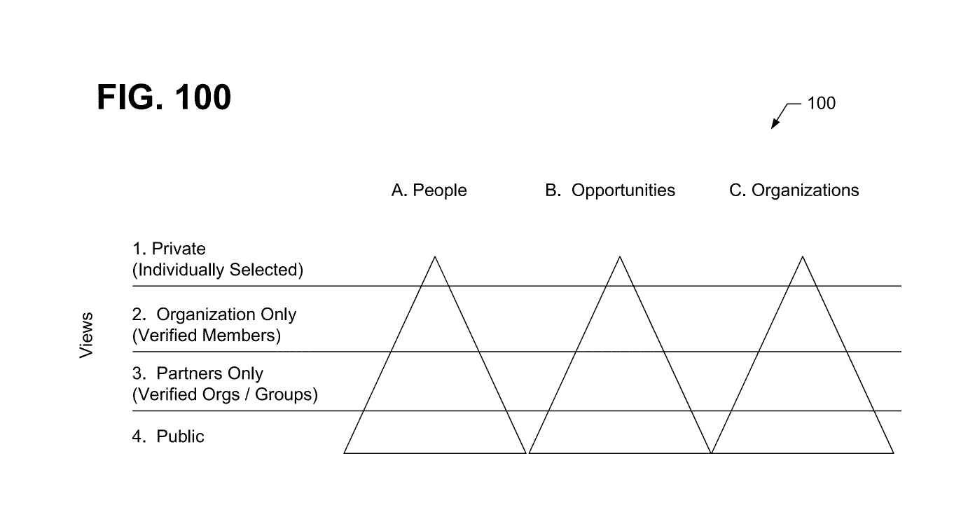

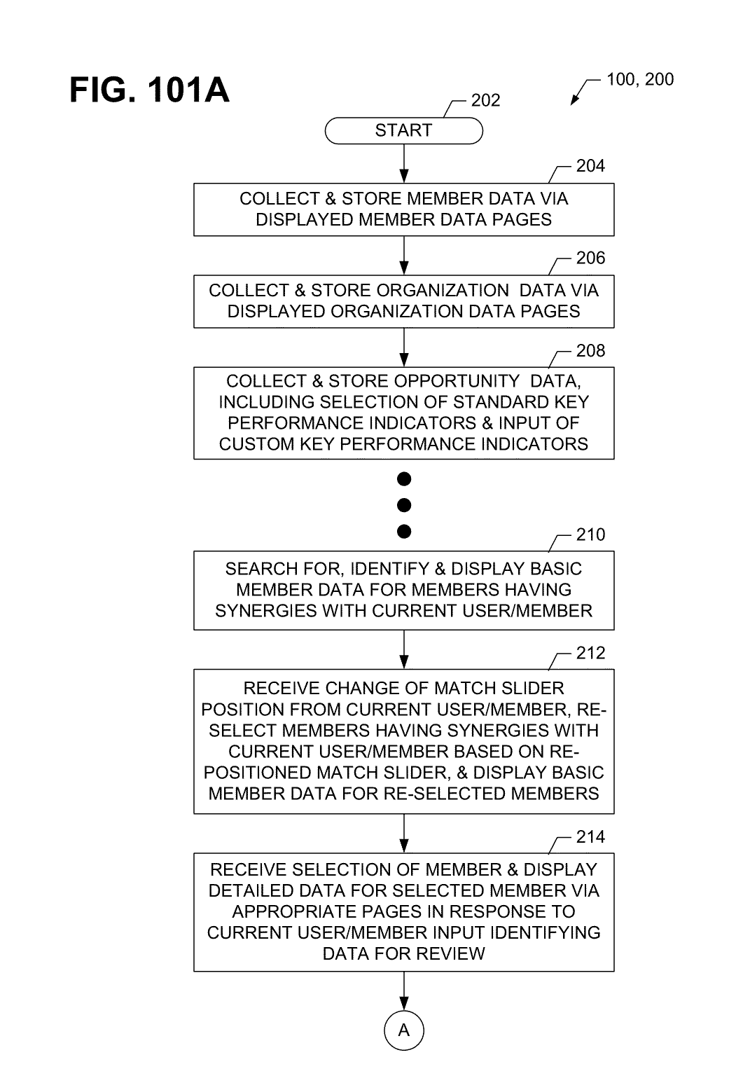

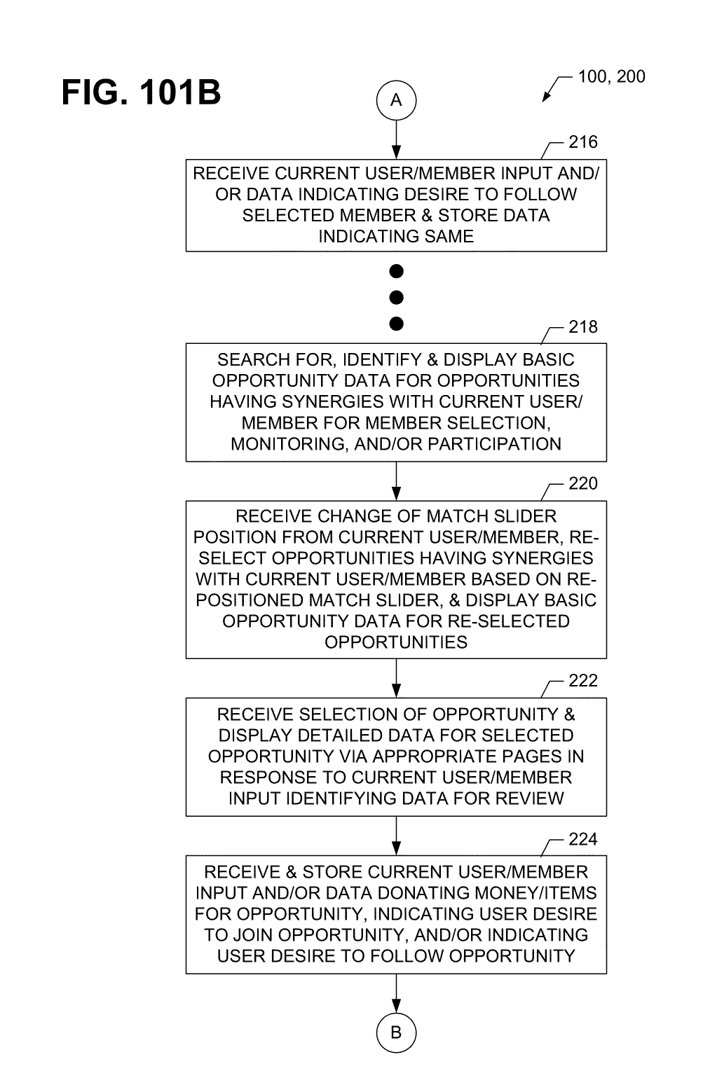

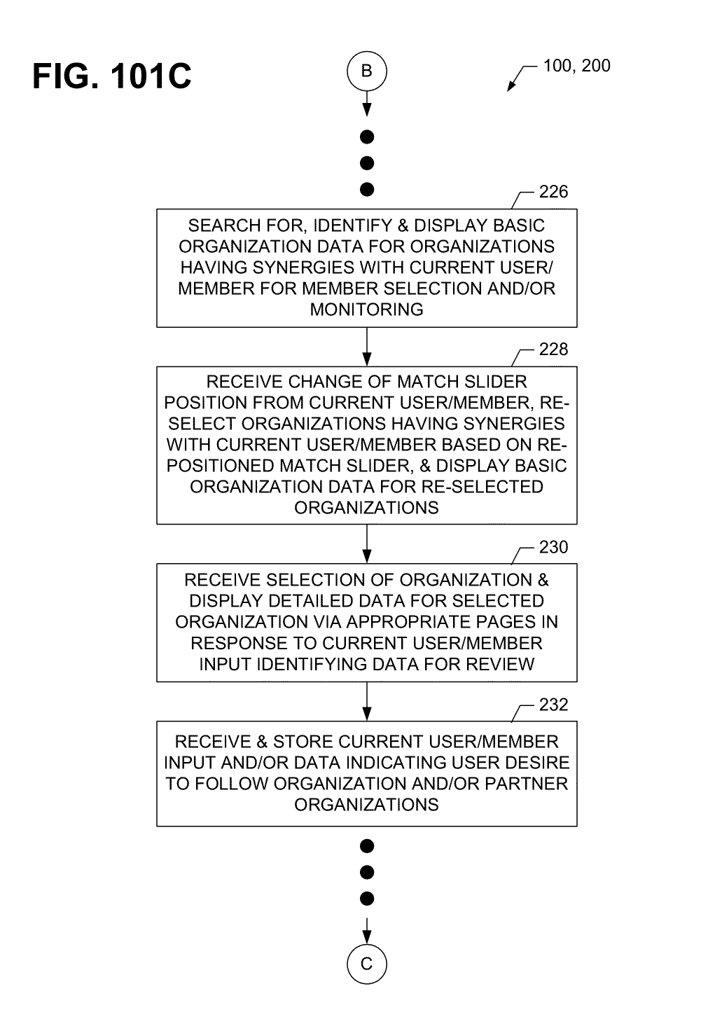

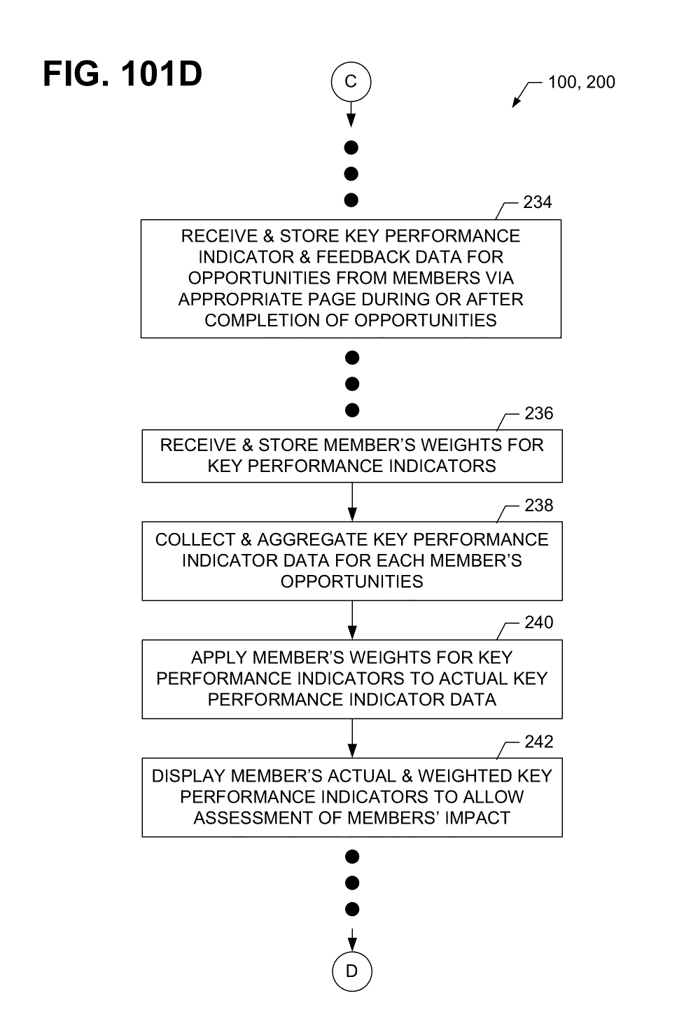

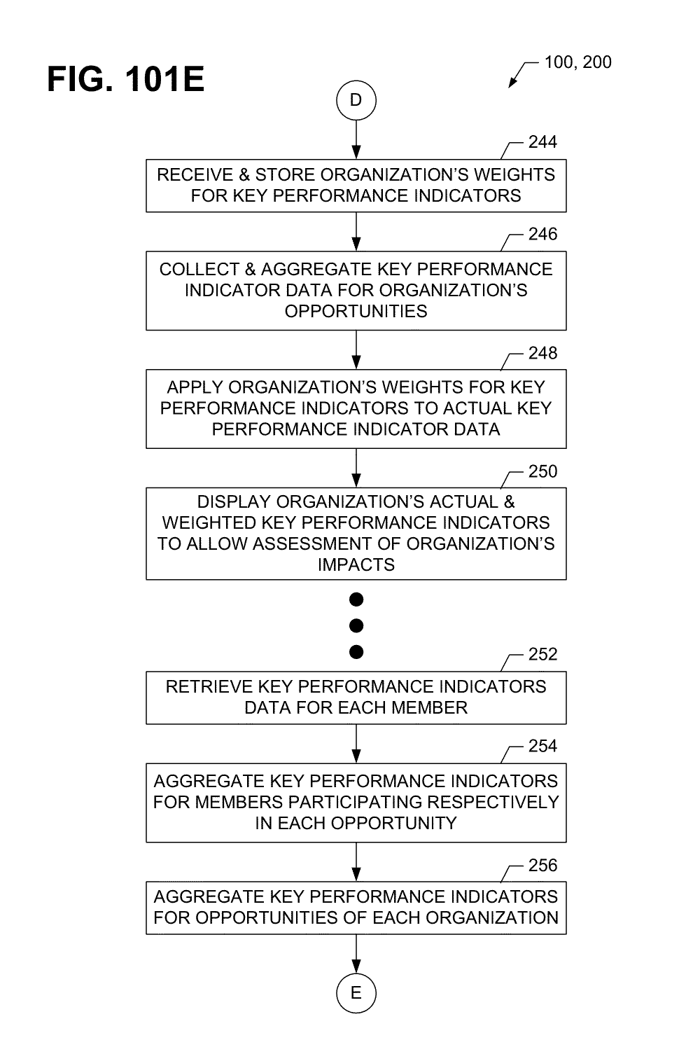

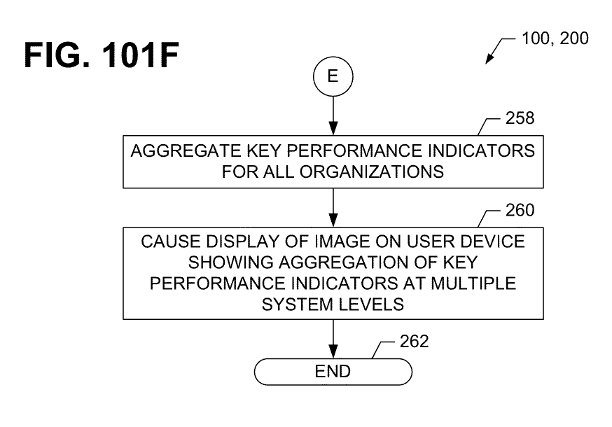

FIG. 100 illustrates an effect of the privacy setting. As seen in FIG. 100, the privacy setting may be set to (i) private, (ii) organization only, (iii) partners only, or (iv) public. If the privacy setting set to “private”, then viewing of the subject member 104, organization 106, or opportunity 108 is limited to a member 104, organization 106, or opportunity 108 included in the owner's private layer. If the privacy setting is set to “organization only”, then the subject member 104, organization 106, or opportunity 108 may only be viewed by verified members 104 of an organization 106. If the privacy setting is set to “partners only”, then the subject member 104, organization 106, or opportunity 108 may only be viewed by partners comprising verified organizations or groups. If the privacy setting is set to “public”, then the subject member 104, organization 106, or opportunity 108 may only be viewed by all system users. It should be understood and appreciated that the privacy setting may be established with many different variations as necessary or appropriate to control or limit access to the data of members 104, organizations 106, or opportunities 108.

As also described above, the member data 144, organization data 146, and opportunity data 148 each include data pertaining to verification or endorsement. The system 100 utilizes such data, in conjunction with the privacy setting data, to control access to and viewing of members 104 and member data 144, organizations 106 and organization data 146, and opportunities 108 and opportunity data 148, and to include or exclude the contributions of partners in evaluating impacts. Additionally, by being verified or endorsed, a member 104, organization 106, opportunity 108, or group may be viewed as having more credibility than others.

One example of verification occurs when a member 104 adds an organization 106 or group to the member's profile. In response to the system 100 receiving a selection or identification of an organization 106 or group from a member 104 to add the selected organization 106 or group to the member's profile, the system 100 delivers an alert that someone is attempting to add them to their profile and lists the member 104 in the organization's or group's admin dashboard. When a representative of the organization 106 or group verifies/endorses the member 104 by clicking on a “verify” button, the system 100 adds an icon to the member's profile adjacent to the organization's name indicating the verification/endorsement. The system 100 also adds the verified organization 106 to the member's list of verified by organizations 106. By virtue of being verified by the organization 106, the member 104 is granted the right to see any opportunities 108 or groups that the organization 106 has posted to the system 100 that have been designated for “verified” users only.

Another example of verification occurs when an organization 106 desires to partner with another organization 106. When the system 100 receives a selection from a first organization 106 of a second organization 106 to be added to the first organization's profile, the system 100 displays the name of the first organization 106 for verification by the second organization 106. Upon receiving verification of the first organization 106, the system 100 adds an icon next to the name of the second organization 106 in the first organization's profile indicating that the first organization 106 has been verified/endorsed by the second organization 106. Also, the system 100 adds the name of the first organization 106 to the second organization's list of organizations 106 that have been verified by the second organization 106. The system 100 automatically lists each organization 106 in the other's partner list where the collective impact metrics are displayed for further weighting, sorting, searching, and ranking. Additionally, when opportunities 108 are added to the system 100 by one of the organizations 106, the system 100 displays the opportunities 108 of the other organization 106 when the privacy setting for the opportunity 108 is set to “display to partners”.

Still another example of verification occurs when a group wants verification by an organization 106 or verifies organizations 106, members 104, opportunities 108, or other groups. In such event, the system 100 operates substantially similar to the process described above with respect to one organization 106 verifying another organization 106. The system 100 optionally displays the names of those organizations 106, members 104, opportunities 108 or other groups verified by a group.

Yet another example of verification occurs with respect to opportunities 108. In this scenario, the organization 106 or group posting the opportunity 108 to the system 100 determines if the opportunity 108 will be visible for synergy matching with only their own members 104, to their verified partners, or to the public.

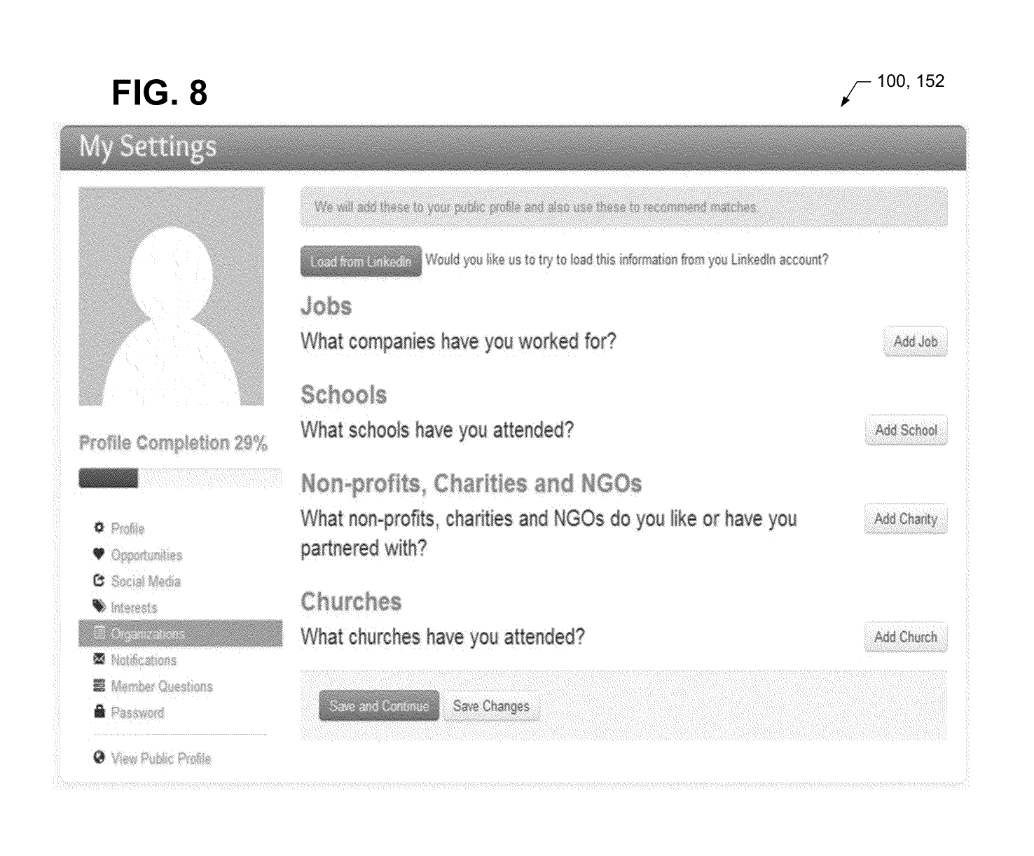

FIGS. 8A-8F displays a flowchart representation of a method of operation 200 of the system 100 in accordance with the example embodiment. The method of operation 200 (also referred to herein as the “operating method 200”) is implemented and followed by the system 100 through execution of the web application software 138, database manager software 140, and other related software by the server computer system 130 and interaction with the user devices 132. It should be understood and appreciated that while the server computer system 130 operates, generally, at all times, portions of the operating method 200 may be performed in an asynchronous manner at times as desired by system users and in response to input by users via user devices 132. Therefore, in FIGS. 8A-8F, ellipsis are present between various steps of the operating method 200 to indicate the possible passage of time between the performance of certain steps or groups of steps.

The server computer system 130 begins operation in accordance with operating method 200 at step 202 after initial configuration and set up of the web application software 138, database manager software 140, and database 142. Such initial configuration may include, among other things, receiving from a user device 132 of a system administrator and storing data identifying certain data elements of the member data 144, organization data 146, and opportunity data 148 as classification tags to be used by the system 100 in evaluating the synergies, commonalities, and/or alignments between members 104, organizations 106, and opportunities 108. Such initial configuration may also include receiving from a user device 132 of a system administrator and storing data identifying standard key performance indicators and default weighting factors to be used by the system 100 in determining the impacts of actions taken by users in connection with opportunities 108 with which the users are engaged.

Once initial configuration and set up is complete, operation of the system 100 advances to step 204 where the server computer system 130 collects, via interaction with a user device 132 during a communication session, and stores member data 144 from a system user who desires to become a member 104. The server computer system 130 does so by causing display of the user interface pages illustrated in FIGS. 4A-10 on the user device 132 as appropriate and in response to received user input, and by storing the data input by and received from the user via the user interface pages and user device 132. Generally, the server computer system 130 collects data that describes the member 104 in terms of the system's classification tags including, but not limited to, the member's interests, experiences or skills, traits, organizations with which the member 104 is involved or participates, problems/needs that the member 104 has or desires to solve, financial information related to the amount of money the member 104 needs or can contribute, and the member's geographical location. The collected member data 144 comprising classification tags is subsequently used by the system 100 when the server computer system 130 considers other members 104, organizations 106, and opportunities 108 while searching for synergistic matches 110 with/for the member 104. Collectively, the received member data 144 defines a portion of a profile of/for the member 104 sometimes referred to as a “member profile”.

After collecting member data 144, the system's operation moves to step 206 where the server computer system 130 collects, via interaction with a user device 132 during a communication session, and stores organization data 146 from a representative of an organization, association, government, non-profit, or for-profit entity desiring to establish the same for participation in the system 100. The server computer system 130 collects the organization data 146 by causing display of the user interface pages illustrated in FIGS. 95-96 on the representative's user device 132 as appropriate and in response to received user input, and by storing the data input by and received from the representative via the user interface pages and user device 132. The server computer system 130 collects data that, generally, describes the organization 106 in relation to the system's classification tags. Such data comprises, without limitation, the organization's name and type, mission/vision/purpose, product or service offerings, technology offerings, ideas, investments, who the organization serves, problems/needs that the organization has or desires to solve, financial information describing the organization's monetary needs or range of possible contributions, traits, and the organization's geographical location. The collected organization data 146 corresponding to the classification tags used by the system 100 is used later when the server computer system 130 searches for synergistic matches 110 with/for members 104, other organizations 106, or opportunities 108. Similar to a member profile, the received organization data 146 defines a portion of a profile of/for the organization 106 that may be referred to as an “organization profile”.

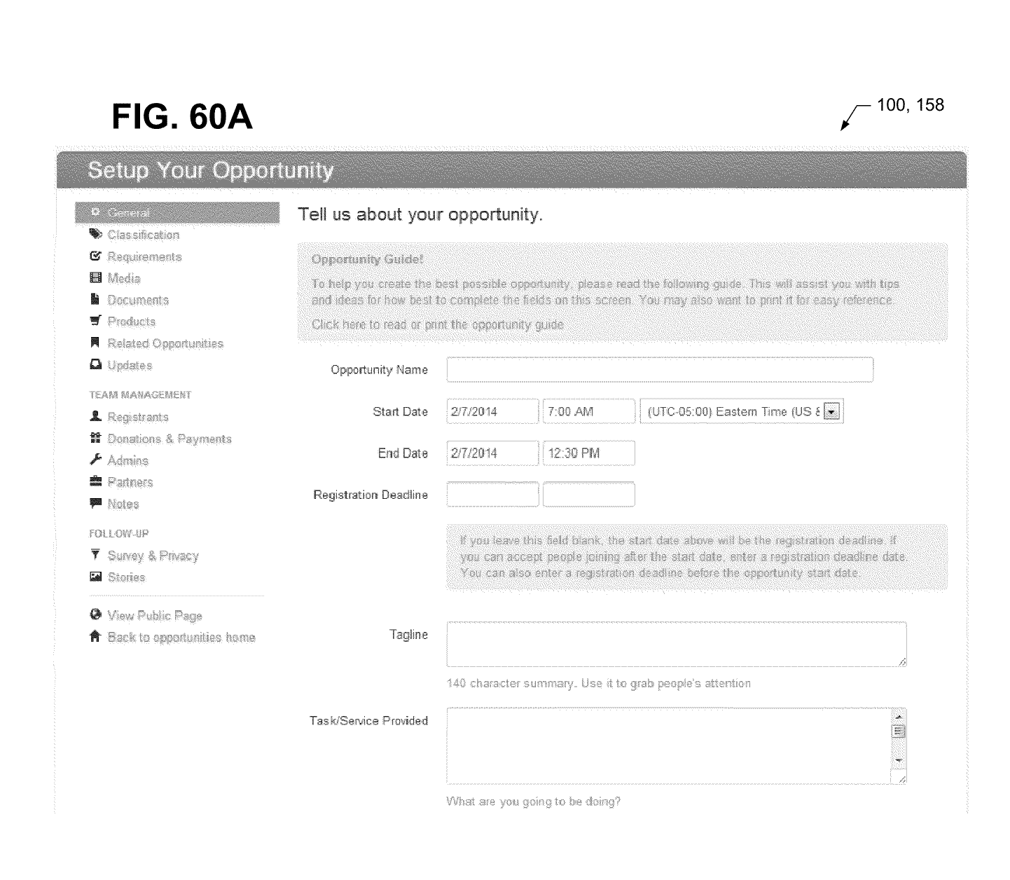

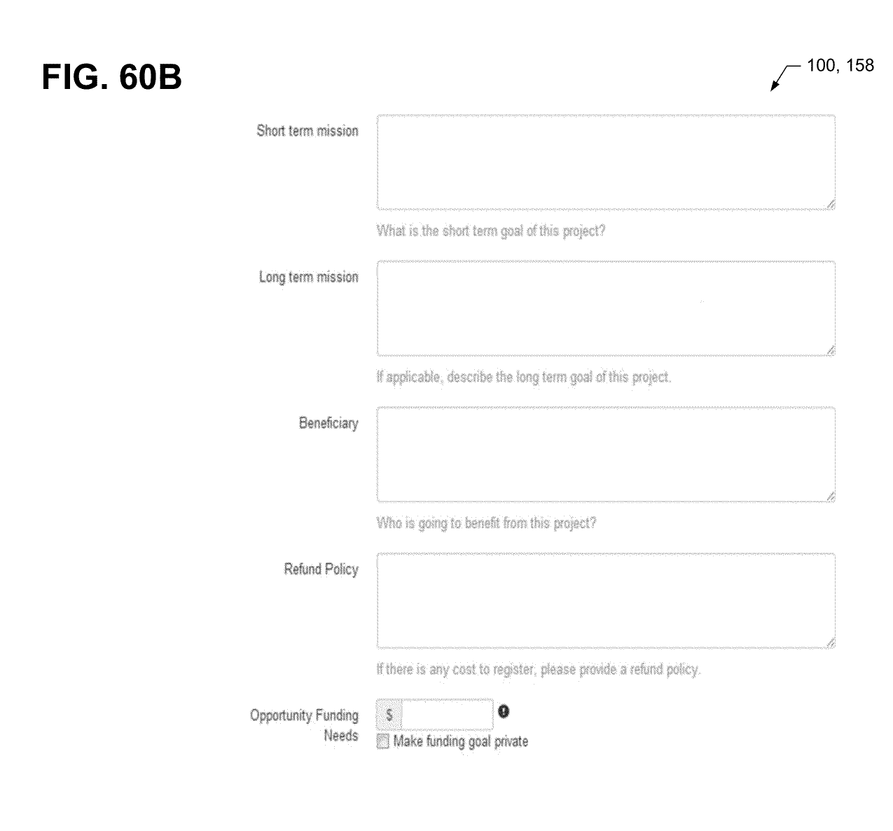

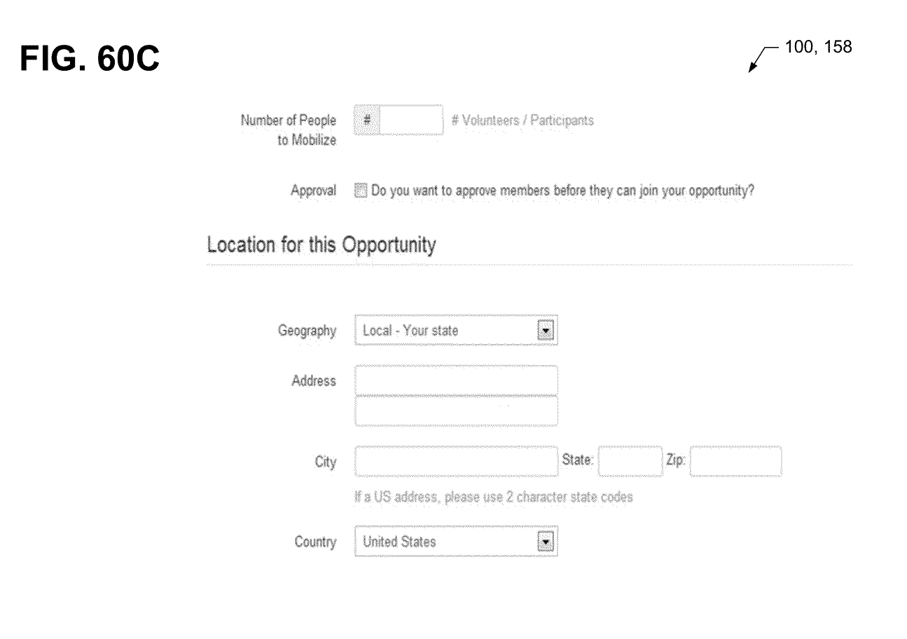

Having collected member data 104 and organization data 106, operation of the system 100 advances to step 208 of operating method 200 where the server computer system 130 collects, through interaction with a user device 132 during a communication session, and stores opportunity data 148 from a member 104 or organization 106 desiring to post an opportunity 108 on the system 100. The server computer system 130 does so by causing display of the user interface pages illustrated in FIGS. 60A-74 on the user device 132 as appropriate and in response to received user input, and by storing the data input by and received from the member 104 or organization 106 via the user interface pages and user device 132. Generally, the server computer system 130 collects data that describes the opportunity 108 in terms of the task/service provided in connection with the opportunity 108, product/service offerings, donation related information, learning/course/lesson information, ideas, investments, needs that are to be addressed or problems to be solved, number of people required, the date/time/duration of the opportunity 108, the characteristics/expertise/competencies/knowledge required, expectations for participants, financial requirements or contributions, identity and type of the lead organization, and the geographical location of the opportunity 108. The collected opportunity data 148 comprising classification tags is subsequently used by the system 100 when the server computer system 130 considers other members 104, organizations 106, and opportunities 108 while searching for synergistic matches 110 with/for a member 104 or organization 106.

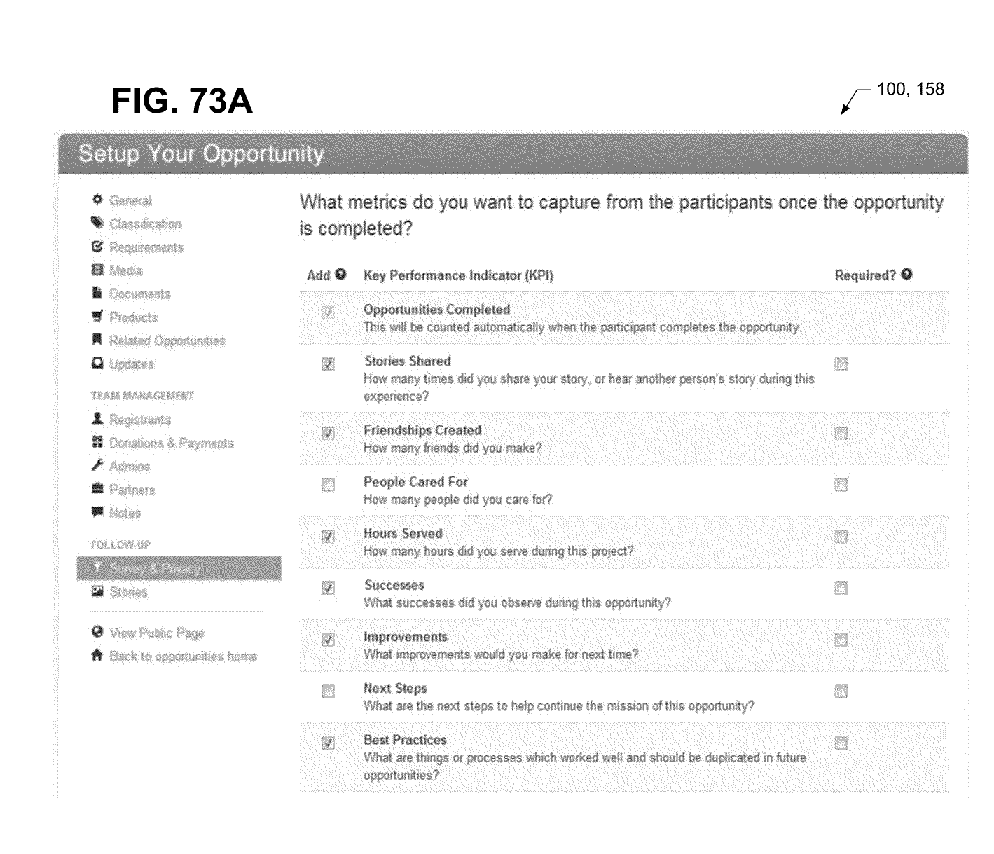

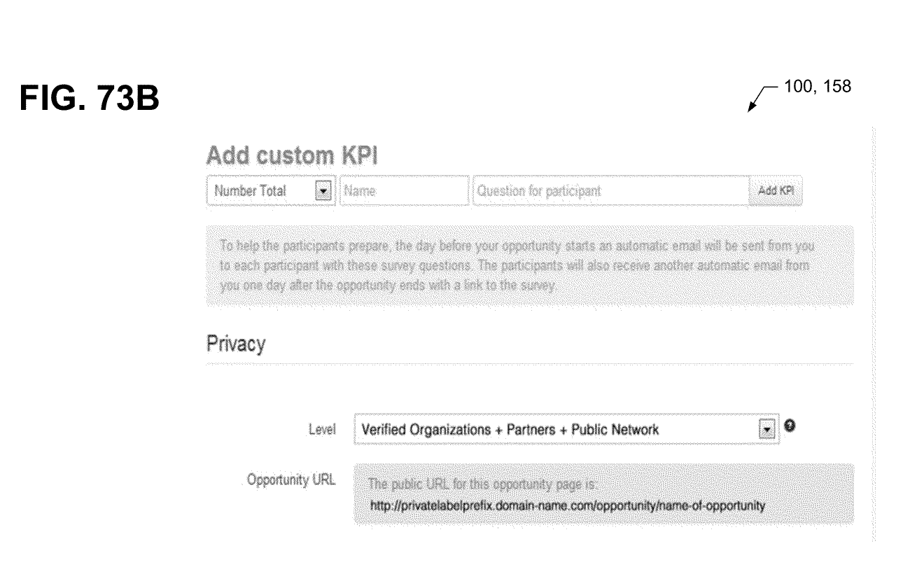

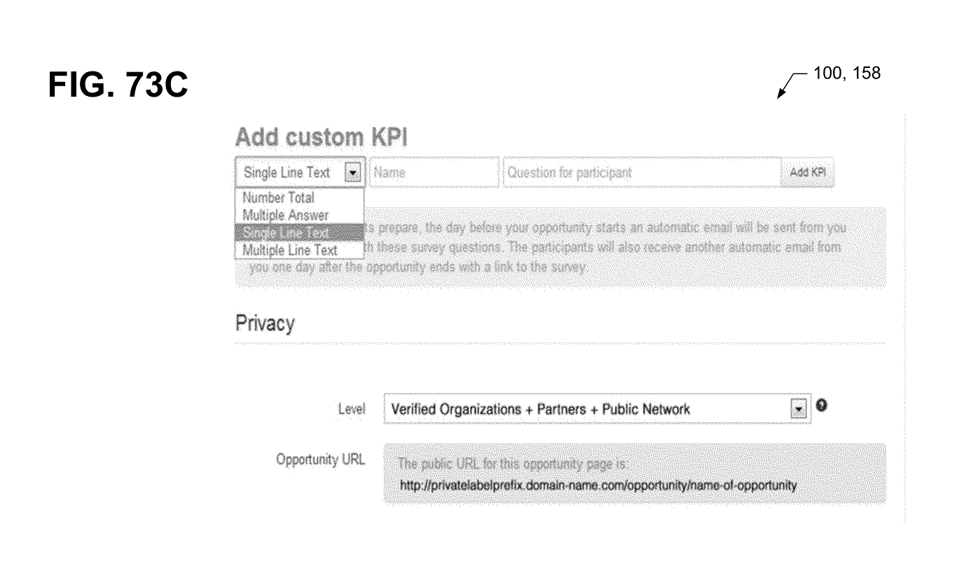

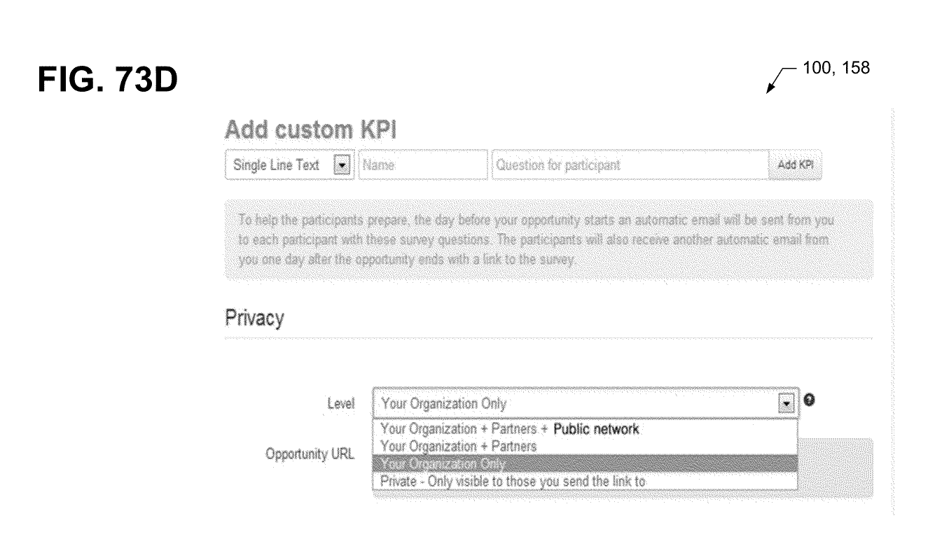

The server computer system 130 also collects data identifying key performance indicators (also sometimes referred to as “KPIs” or “metrics”) for the opportunity 108. To do so, the server computer system 130 causes the user device 132 to display a user interface page similar to that illustrated in FIGS. 73A-73D. Via the user interface pages, the user may select one or more standard, pre-defined key performance indicators provided by the system 100 or may input data describing and/or defining one or more custom key performance indicators. By providing the user with the ability to pick and choose between standard, pre-defined key performance indicators or to define custom key performance indicators, the system 100 permits the user to assign a set of key performance indicators that are relevant to the opportunity 108 to which they are assigned. Upon receiving the selection of the “save” button by the user via the user interface page, the server computer system 130 stores data identifying the selected pre-defined key performance indicators and data defining/describing the custom key performance indicators in the opportunity data 148 for the opportunity 108. Together the describing the opportunity 108 and the key performance indicators for the opportunity 108 define a portion of a profile of/for the opportunity 108 sometimes referred to as an “opportunity profile”.

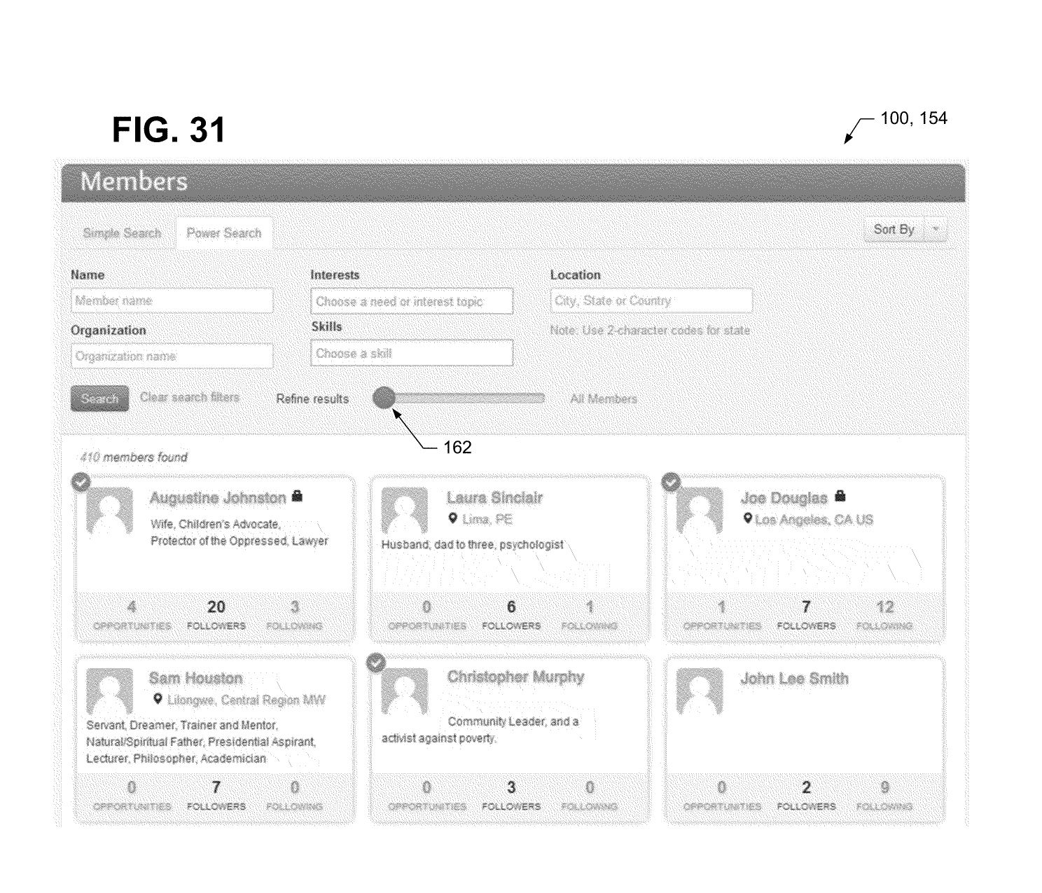

Once the system 100 has collected member data 144, organization data 146, and opportunity data 148 and in response to a member 104 indicating a desire to search for other members 104 having synergies, commonalities, or alignments with the member 104 through receipt of a selection of the “members” option from the header portion of virtually any of the system's user interface pages. Upon receiving such a selection, the system 100 advances to step 210 of operating method 200 where the server computer system 130 causes the member's user device 132 to display the user interface page of FIG. 30 for a simple search. If the server computer system 130 receives member input (selection of the power search tab) indicating the member 104 desires for the system 100 to perform a power search, the server computer system 130 causes the member's user device 132 to display the user interface page of FIG. 31 and receives further member 104 input providing one or more additional selection criteria (generally, name, interest, organization, skills, and/or location) for use during the search in filtering possible matches 110. The server computer system 130 then searches the member data 144 for other members 104 having synergies, commonalities, or alignments with the member 104 and identifies matches 110 using the classification tags and additional selection criteria (if the search is a power search). After identifying matches 110 and determining the number of classification tags that the member 104 has in common with the identified other members 104, the server computer system 130 orders the identified members 104 based on the number of classification tags in common. Then, the server computer system 130 retrieves certain basic information (generally, the member's name, descriptive information, geographical location, number of opportunities that the member 104 is engaged with, the member's number of followers, and the number of other members 104 that the member 104 is following) for each identified member 104 and causes such information to be displayed on the member's user device 132 in tiles as illustrated in FIGS. 30 and 31, with each identified member 104 corresponding in one-to-one correspondence with a tile.

After identifying matches 110 to the member 104 via the member's user device 132, the system 100 moves forward to step 212 of operating method 200 where the server computer system 130 receives data from the user device 132 indicating the member 104 has changed the position of the match slider 162 of the user interface page. Initially, when the server computer system 130 causes the user interface page of FIGS. 30 and 31 to be displayed on a user device 132, the match slider 162 is positioned in a leftmost position that corresponds to all of the matches 110 being displayed to the member 104 regardless of the number of classification tags in common. As the member 104 moves, slides or drags the match slider 162 toward a rightmost position that corresponds to no matches 110 being displayed to the member 104, the server computer system 130 responds by progressively reducing the number of matches 110 to be displayed according to the number of classification tags that identified matches 110 have in common. The position of the match slider 162 indicates the number of classification tags that an identified match 110 must have in common with the member 104 in order to be displayed on the user device 132. Thus, based on the relative position of the match slider 162, the server computer system 130 re-selects which identified matches 110 to present to the member 104 and causes the user interface page of the member's user device 132 of the member 104 to be updated accordingly with a greater or lesser number of identified matches 110 being displayed than were previously displayed. It should be understood and appreciated that in other embodiments, the match slider 162 may comprise an alternative user interface element or member having substantially the same or improved functionality.

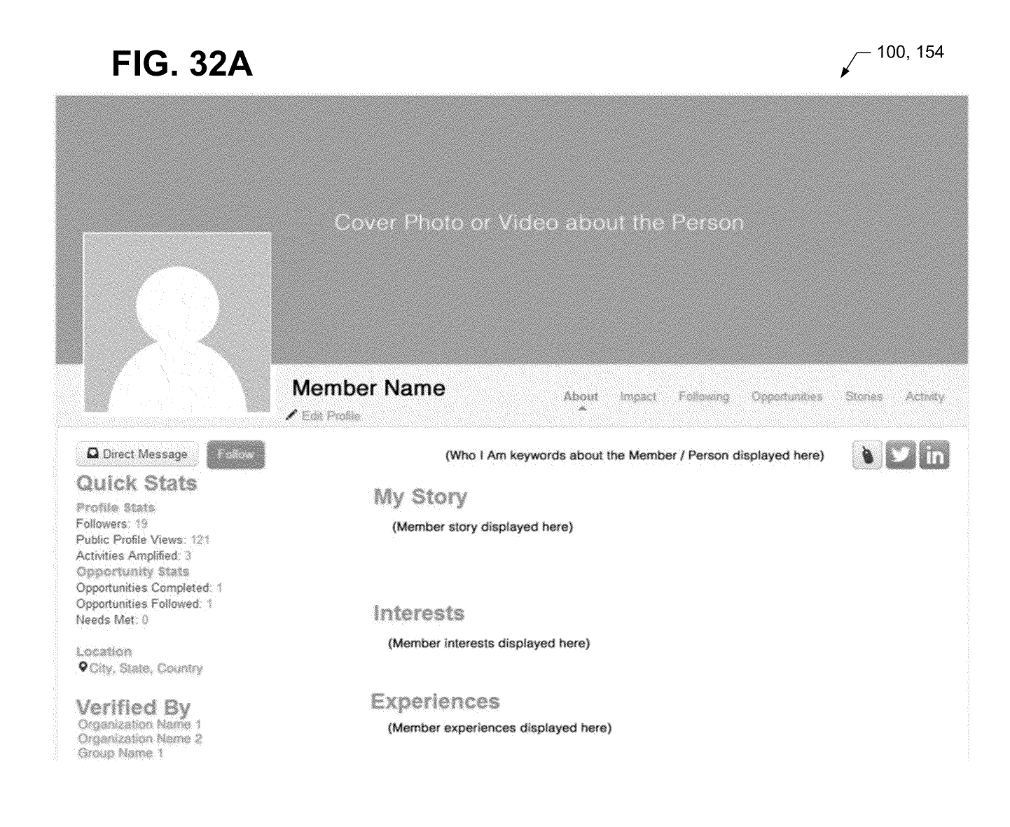

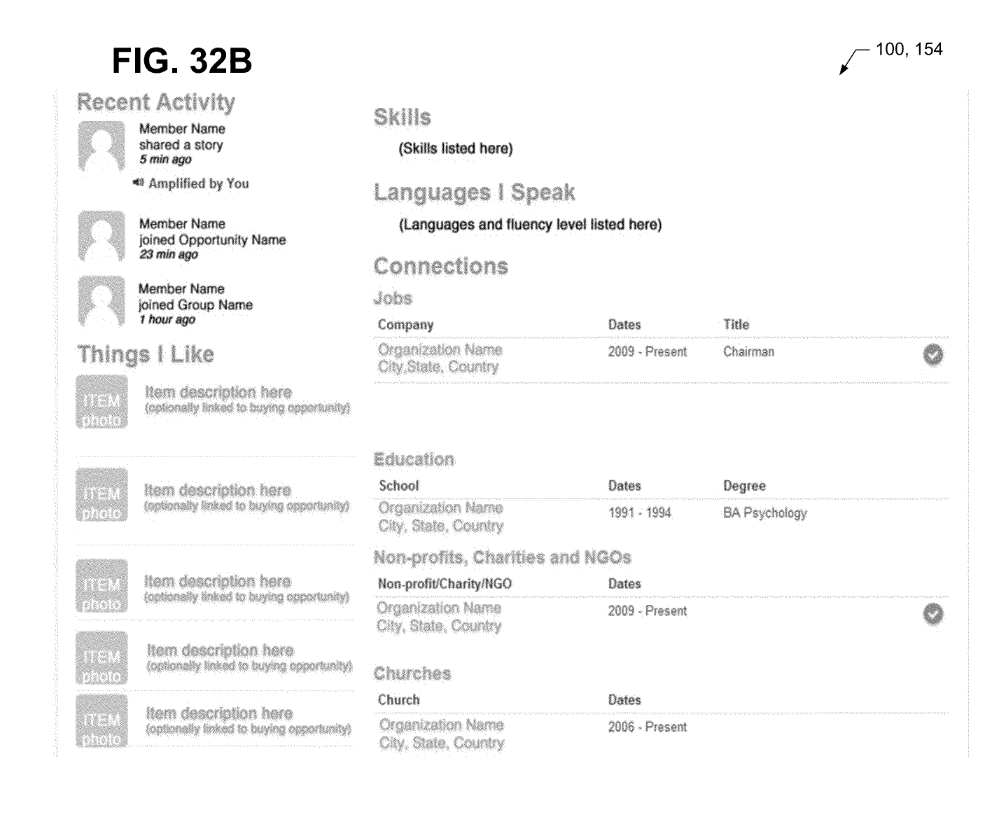

At step 214 of the operating method 200, the server computer system 130 receives data identifying a match 110, or other member 104, from the user device 132 in response to the member 104 selecting a match 110 for further review and/or consideration. The server computer system 130 then retrieves more detailed information from the member data 144 for the selected other member 104 and causes the member's user device 132 to display the same on appropriate user interface pages as illustrated in FIGS. 32A-43 in accordance with, and in response to, receiving further input from the member's user device 132 requesting the display of different types of information such as, for example and not limitation, the impacts made by the selected member 104, the members 104 being followed by the selected member 104, the opportunities 108 in which the selected member 104 is engaged, stories posed by the selected member 104, and/or activities of the selected member 104.

The member 104 may consider the selected member 104 and then decide if he/she desires to follow the selected member 104. If so, the member 104 selects the pop-up “follow” button/icon on the selected member's tile displayed in the user interface pages of FIGS. 30 and 31, or the “follow” button/icon present on the user interface page of FIG. 32A. In response to receiving the member's input, at step 216, the server computer system 130 updates and stores the member data 144 in the database 142 for both members 104 accordingly. After selecting a member 104 to follow, the member 104 may engage in other activities with the system 100.

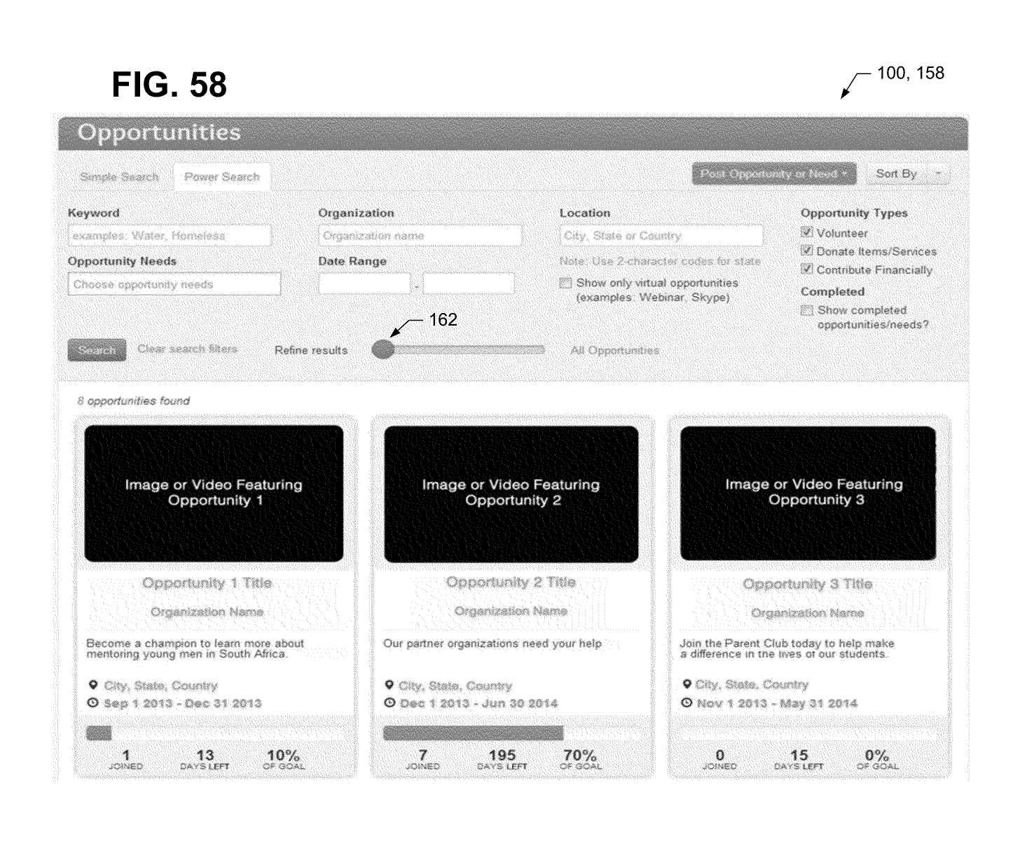

The server computer system 130 continues operation according to operating method 200 when, perhaps after the passage of a period of time, a member 104 initiates a communication session with the server computer system 130 via a user device 132 to identify an opportunity 108 in which to engage or participate. In response to receiving input via the user device 132 indicating selection of the “opportunity” option from the header portion of the system's user interface pages, the system 100 moves to step 218 of operating method 200 where the server computer system 130 causes the user device 132 to display the user interface page of FIG. 57 for a simple search. The server computer system 130 may then receive user input, via the user interface page and user device 132, indicating that the user desires to search for synergistic opportunities 108 that involve volunteer work, financial contribution, the donation of items or services, and/or other types of opportunities. If the server computer system 130 receives user input (selection of the power search tab) indicating the user desires for the system 100 to perform a power search, the server computer system 130 causes the user device 132 to display the user interface page of FIG. 58 and receives further user input providing one or more additional selection criteria (generally, keywords, an organization name, dates, opportunity needs, and/or location) for use during the search in filtering possible matches 110. The server computer system 130 then searches the opportunity data 148 for opportunities 108 having synergies, commonalities, or alignments with the member 104 or organization 106, and identifies matches 110 using the classification tags and additional selection criteria (if the search is a power search).

During the process of evaluating the synergies, commonalities and alignments of the member 104 with opportunities 108 and identifying matches 110, the server computer system 130 considers the classification tags, including availability and geographical location, which are pre-configured and/or pre-identified for such use. With regard to availability, the server computer system 130 compares the date range of each opportunity 108 previously received and stored by the system 100 in opportunity data 148 when the opportunity 108 was posted or subsequently edited with the availability of the member 104 to participate in opportunities 108 as indicated by the calendar dates of member availability for the member 104 previously collected from the member 104 and stored by the system 100 in member data 144. If the opportunity's data range falls within one of the calendar data ranges when the member 104 has availability to participate, the classification tag corresponding to availability is matched and is treated by the system 100 as are the other classification tags.

Regarding geographical location, the server computer system 130 similarly treats geographical location or “proximity” as any other classification tag. However, since the geographical location of the member 104 may be dynamically changing with movement or travel of the member 104, the proximity of the member 104 to possible opportunities 108 is determined by the server computer system 130 immediately prior to performing a search for synergistic matches 110 with the member 104. To do so, the system 100 may employ a variety of different technologies and/or methods to determine the member's then current geographical location. For example, if the member 104 is interacting with the system 100 via a user device 132 that comprises a smartphone device 132A, a pad/table device 132B, or portable computer 132C equipped with operating global positioning system (GPS) hardware/software, the server computer system 130 may query the user device 132 and receive the then current latitude/longitude of the user device 132 therefrom. In another example, if the member 104 is interacting with the system 100 via a user device 132 that is Bluetooth equipped or that is otherwise capable of determining its position relative to a beacon using radio, optical, or other wireless technologies, the server computer system 130 may cause the user device 132 to determine and send its geographical location to the server computer system 130. Alternatively, if the member 104 is interacting with the system 100 through a user device 132C that does not move such as a desktop computer, the server computer system 130 may use a uniform resource locator (URL) associated with the desktop computer (or the location where the desktop computer is present) to ascertain the geographical location of the member 104, or may use member data 104 received from the member 104 when the system 100 collected member data 144 for the member's profile.

After identifying matches 110 and determining the number of classification tags that the member 104 has in common with the identified opportunities 108, the server computer system 130 orders the identified opportunities 108 based on the number of classification tags in common. Then, the server computer system 130 retrieves certain basic information (generally, the opportunity's name, an associated image, brief description, geographical location, date range/starting date/ending date, number of members 104 who have joined the opportunity 108, the number of days left in the opportunity, and the percentage of the opportunity's goal that has been met so far) for each identified opportunity 108 and causes such information to be displayed on the member's user device 132 in tiles as illustrated in FIGS. 57 and 58, with each identified opportunity 108 corresponding in one-to-one correspondence with a tile.

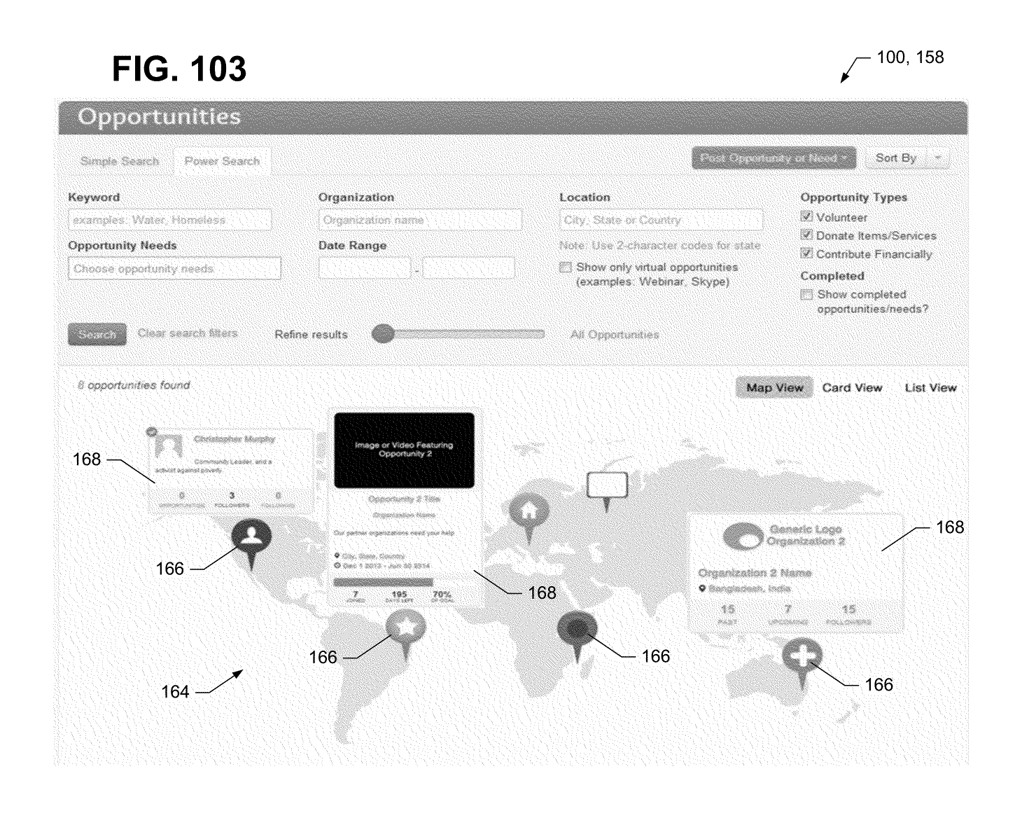

In an alternate embodiment, the server computer system 130 generates a map 164 displaying the geographical locations of the identified opportunities 108 as illustrated in FIG. 103. The map 164 includes pins 166 identifying the geographical locations of the identified opportunities 108 (or other members 104 or organizations 106, as the context may require or necessitate). The pins 166 are color coded to identity the type of match 110, such as another member 104, organization 106, or opportunity 108. The pins 166 may be grouped closely and in response to receiving user input requesting that the system 100 “zoom in” on a particular pin 166, the server computer system 130 updates the display with more detailed information on the match 110 corresponding to the pin 166. The map 164 may also include a card 168 for each identified opportunity 108 (or other member 104 or organization 106) displaying basic information about the identified opportunity 108 similar to the tiles shown in FIGS. 57 and 58, or may toggle between the map 164 and tiles. Additionally, upon detecting hovering over a pin 166 or card 168, the server computer system 130 may dynamically display more detailed information about the respective match 110 or allow selection of a link to another user interface page displaying more detailed information. In addition and upon receiving an appropriate user input, the server computer system 130 may look up and present the latitude/longitude for a pin 166 or match 110.

In still another alternate embodiment in which the member 104 is moving and has a user device 132 that is moving with the member 104, the server computer system 130 continually tracks the geographic location of the user device 132 and dynamically performs and updates the search for synergistic matches 110 as the member 104 changes geographical location, and correspondingly continually and dynamically updates the synergistic matches 110 displayed via the tiles illustrated in FIGS. 57 and 58 and/or the pins 166 and cards 168 on the map 164 illustrated in FIG. 103 based on the proximity to the member's geographic location. By tracking the member's geographic location and dynamically updating the search results, the system 100 is capable of identifying and displaying synergistic matches 110, for example, within an input distance (which the system 100 may receive from the user) or within a certain governmental area such as a city, county, or township. Thus, for example, a member 104 may walk down an aisle at a trade show and be alerted to the locations of vendors along the aisle who provide a product or service of interest to the member 104 via a map 164 including cards 168 having pictures of vendor representatives. Conversely, if not blocked by the members' privacy settings, vendors may identify members 104 walking down the aisle who have an interest in the vendors' product or services. In another example use of the system's dynamic identification and proximity matching capability, a neighbor having a need may post an opportunity 108 on the system 100 and a member 104 could be alerted visually and audibly of the need.

In yet another alternate embodiment, the server computer system 130 may inform a member 104 that synergistic matches 110 (including other members 104, organizations 106, or opportunities 108) have been identified by pushing an alert notification to the member 104. Such push alert notifications may include or be provided by, for example and not limitation: email notifications; mobile application extension notifications; text messaging; telephone call/message; a dashboard displaying synergistic matches 110; dynamic feeds personalized to each member 104 depending on what other members 104, organizations 106, or opportunities 108 they are following with such dynamic feeds being grouped by the system 100 into customized categories (such as friends, family, business, or other group), and filtered and/or sorted by group, chronology, proximity, and included media; and, dynamic feeds received from external sources (including, but not limited to, social networks) that may be combined, grouped, filtered, and/or sorted alone or together with other alert notifications.

Returning to the example embodiment, once matches 110 have been identified to the member 104 via the member's user device 132, the system 100 moves forward to step 220 of operating method 200 where the server computer system 130 receives data from the user device 132 indicating the member 104 has changed the position of the match slider 162 of the user interface page. As described above, the position of the match slider 162 indicates the number of classification tags that an identified match 110 must have in common with the member 104 in order to be displayed on the user device 132. Thus, based on the new relative position of the match slider 162, the server computer system 130 re-selects which identified opportunity matches 110 to present to the member 104 and causes the user interface page of the member's user device 132 of the member 104 to be updated accordingly with a greater or lesser number of identified opportunity matches 110 being displayed than were previously displayed. In an alternate embodiment, a similar slider may be configured to adjust the distance used by the server computer system 100 in identifying synergistic matches 110 or in displaying synergistic matches 110.

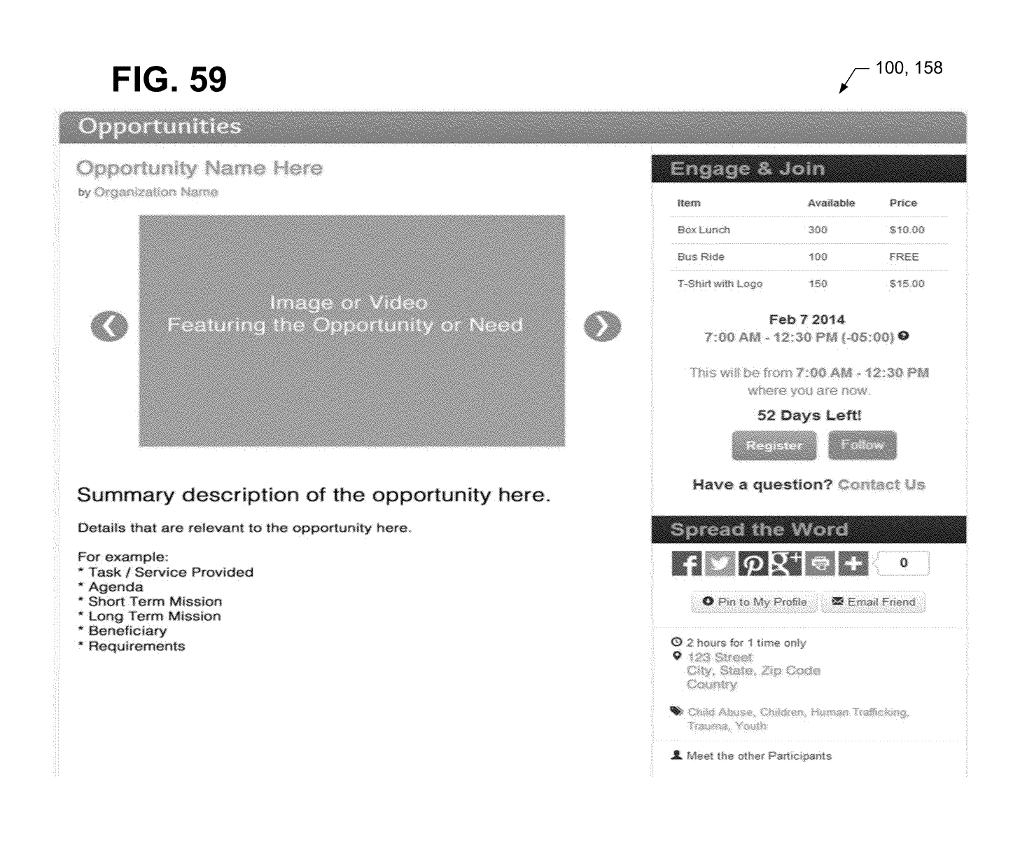

Continuing operation at step 222, the server computer system 130 receives data identifying an opportunity match 110 from the user device 132 in response to the member 104 selecting a match 110 for further review and/or consideration. The server computer system 130 then retrieves more detailed information from the opportunity data 148 for the selected opportunity 108 and causes the member's user device 132 to display the same on a user interface page similar to that illustrated in FIG. 59. The more detailed information generally includes a more detailed description of the opportunity 108, the identity of the sponsor and/or leader for the opportunity 108, the requirements for participation in the opportunity 108, stories related to the opportunity 108, the number of members 104 who have already joined the opportunity 108 and the number of member 108 still needed, the opportunity's date range, the opportunity's location, and a listing of other similar opportunities 108.

The member 104 may consider the selected opportunity 108 and then decide if he/she desires to follow, but not engage in, the selected member 104. If so, the member 104 selects the pop-up “follow” button/icon on the selected opportunity's tile displayed in the user interface pages of FIGS. 57 and 58, or the “follow” button/icon present on the user interface page of FIG. 59. The member 104 may also decide to donate money/items to the opportunity 108 by entering a donation amount or identifying an item to donate if the opportunity 108 is for donations, or may decide to invest or pay into a non-charitable opportunity 108, or may decide to join the opportunity 108 if the opportunity 108 requires participation other than by investment or donation. In response to receiving the member's input, at step 224, the server computer system 130 updates and stores the member data 104 and opportunity data 148 in database 142 accordingly. After taking or not taking such actions, the member 104 may engage in other activities with the system 100.

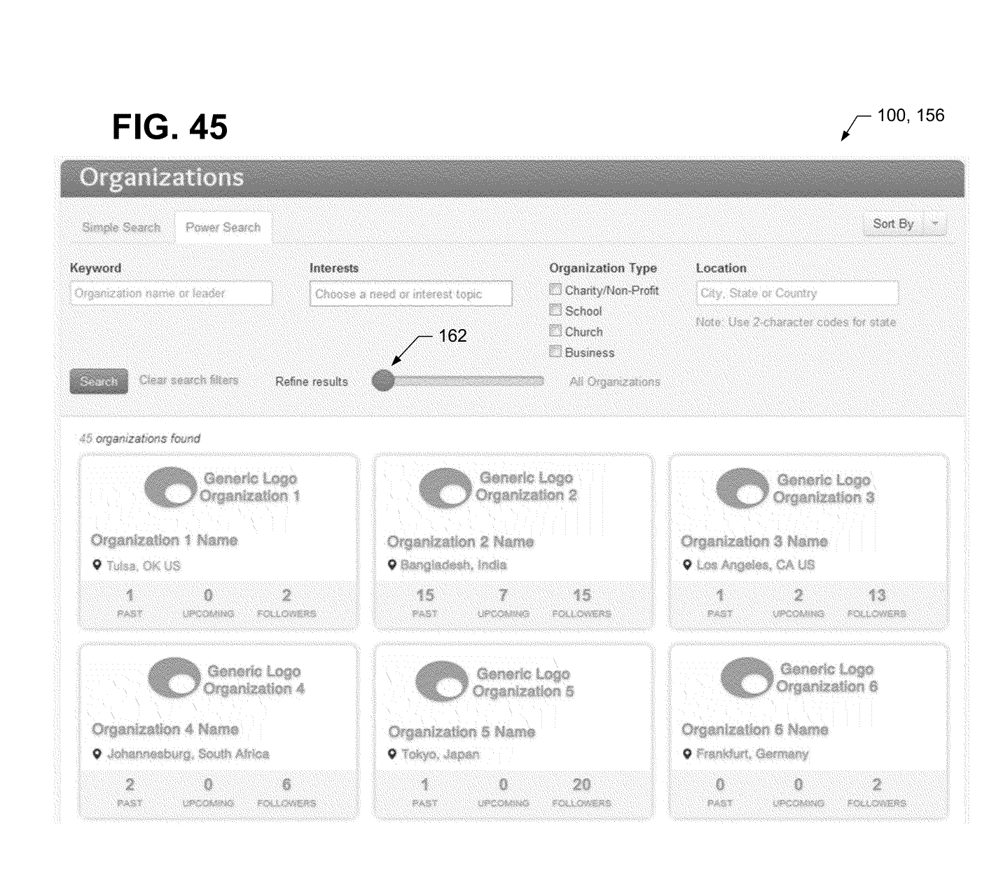

Once again, the server computer system 130 continues operation according to operating method 200 when, perhaps after the passage of a period of time, a member 104 initiates a communication session with the server computer system 130 via a user device 132 to identify an organization 106 in which to engage or participate, or with which to partner. In response to receiving input via the user device 132 indicating selection of the “organization” option from the header portion of the system's user interface pages, the system 100 moves to step 226 of operating method 200 where the server computer system 130 causes the user device 132 to display the user interface page of FIG. 44 for a simple search. If the server computer system 130 receives user input (selection of the power search tab) indicating the user desires for the system 100 to perform a power search, the server computer system 130 causes the user device 132 to display the user interface page of FIG. 45 and receives further user input providing one or more additional selection criteria (generally, keywords, interests or needs, the organization's type such as, for example, charity/non-profit, school, church, government or business, and/or location) for use during the search in filtering possible matches 110. The server computer system 130 then searches the organization data 146 for organizations 106 having synergies, commonalities, or alignments with the member 104, and identifies matches 110 using the classification tags and additional selection criteria (if the search is a power search).

When evaluating the synergies, commonalities and alignments of the member 104 with organizations 106 and identifying matches 110, the server computer system 130 considers the classification tags, including geographical location, that are pre-configured and/or pre-identified for such use. With respect to geographical location, the server computer system 130 similarly treats geographical location or “proximity” as any other classification tag. However, since the geographical location of the member 104 may be dynamically changing with movement or travel of the member 104, the proximity of the member 104 to possible opportunities 108 is determined by the server computer system 130 immediately prior to performing a search for synergistic matches 110 with the member 104 in a manner substantially similar to that described above with respect to searching for matching opportunities 108.

After identifying matches 110 and determining the number of classification tags that the member 104 has in common with the identified organizations 106, the server computer system 130 orders the identified organizations 106 based on the number of classification tags in common. Then, the server computer system 130 retrieves certain basic information (generally, the organization's name, an associated image, the organization's location, the number of past opportunities 108 with which the organization 106 has sponsored, the number of upcoming opportunities 108 that the organization 106 is sponsoring, and the number of followers of the organization 108) for each identified organization 106 and causes such information to be displayed on the member's user device 132 in tiles as illustrated in FIGS. 44 and 45, with each identified organization 106 corresponding in one-to-one correspondence with a tile.

Once matches 110 have been identified to the member 104 via the member's user device 132, the system 100 moves forward to step 228 of operating method 200 where the server computer system 130 receives data from the user device 132 indicating the member 104 has changed the position of the match slider 162 of the user interface page. As described above, the position of the match slider 162 indicates the number of classification tags that an identified match 110 must have in common with the member 104 in order to be displayed on the user device 132. Thus, based on the new relative position of the match slider 162, the server computer system 130 re-selects which identified organization matches 110 to present to the member 104 and causes the user interface page of the member's user device 132 of the member 104 to be updated accordingly with a greater or lesser number of identified organization matches 110 being displayed than were previously displayed.

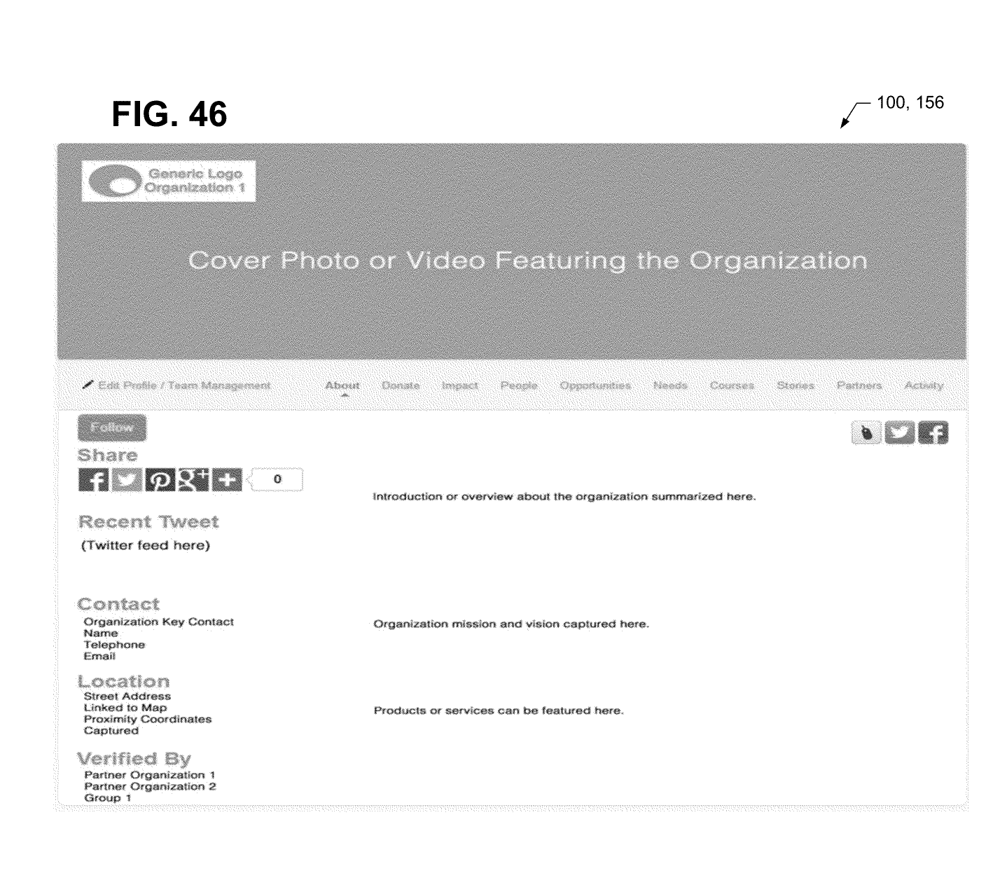

Continuing operation at step 230, the server computer system 130 receives data identifying an organization match 110 from the user device 132 in response to the member 104 selecting a match 110 for further review and/or consideration. The server computer system 130 then retrieves more detailed information from the organization data 146 for the selected organization 106 and causes the member's user device 132 to display the same on appropriate user interface pages as illustrated in FIGS. 46-56 in accordance with, and in response to, receiving further input from the member's user device 132 requesting the display of different types of information such as, for example and not limitation, a description of the selected organization 106, the selected organization's mission statement, the organization's contact person and contact information therefore, the impacts made by the selected organization 106, the members 104 who are following the organization 106 or who are verified members 104 of the organization 106, the past and/or upcoming opportunities 108 that the organization 106 has been or will be involved, the organization's current needs and needs that have been met, stories about the impacts that the organization 106 had made, the identities of partner organizations 106 and organizations 106 that have verified/endorsed the selected organization 106, and activities related to the organization 106.

The member 104 may consider the selected organization 106 and then decide if he/she desires to follow the selected organization 106. If so, the member 104 selects the pop-up “follow” button/icon on the selected organization's tile displayed in the user interface page of FIG. 44 or 45 or the “follow” button/icon present on the user interface page of FIG. 46. In response to receiving the member's input, at step 232, the server computer system 130 updates and stores the member data 144 and organization data 146 in the database 142 accordingly. After selecting an organization 106 to follow, the member 104 may engage in other activities with the system 100.

The server computer system 130 continues to operate in accordance with operating method 200 and, at some time during its operation, a member's involvement with or participation in an opportunity 108 comes to an end or the opportunity 108 itself is completed or ends. At such times, the member 104 initiates a communication session with the server computer system 130 via a user device 132 to provide input to the system 100 indicative of the member's efforts and the successful completion, in whole or in part, of the opportunity 108. In response to appropriate input received from the member 104 via the member's user device 132, the server computer system 130 causes the display of a user interface page. Through the member's inputs via the user interface page, the server computer system 130 receives key performance data and other feedback information for the opportunity 108 at step 234. Upon receiving this data and information, the server computer system 130 stores the same in the opportunity data 148 associated with the opportunity 108 for future use in evaluating impacts of the member 104, the opportunity 108, and the organization 106 that sponsored the opportunity 108.

At some time either during an opportunity 108 or after completion of an opportunity 108, the member 104 or representative of the organization 106 sponsoring or responsible for the opportunity 108 may subsequently desire to monitor the impact that the opportunity 108 is having. Additionally, a member 104 who participates in the opportunity 108 may desire to monitor his/her own impact. Because the sponsor (a member 104 or organization 106) and the participating member 104 may view what is important and/or the impacts differently, the system 100 permits the sponsor and the participating member 104 to assign their own weights to the various key performance indicators for the opportunity 108. Therefore, at step 236 of operating method 200, the server computer system 130 causes the display of a user interface page on a user device 132 of the member 104, and receives relative weights for each key performance indicator via the user interface page and user device 132. The system 100 requires that the weights for all of the key performance indicators must combine to equal one hundred percent (100%). After receiving acceptable weights, the server computer system 130 stores the received weights for future use, including, but not limited to, analysis and assessment, sorting, and scoring.

Subsequently at step 238, when the member 104 desires to monitor or review his/her impact, the server computer system 130 retrieves and aggregates the then current values of the key performance indicators for the opportunities in which the member 104 has been involved. Then, at step 240, the server computer system 130 retrieves the weights previously provided by the member 104 from the database 142 and applies the weights to the actual values of the key performance indicators (such as, for example, by multiplying the decimal equivalent (and not the percentage) of the weights and the actual values) to determine the weighted values of the key performance indicators. Next, at step 242, the server computer system 130 causes the user device 132 of the member 104 to display both the actual and weighted values of the key performance indicators for review and consideration by the member 104.

Similarly, for a sponsoring organization 106, the server computer system 130 causes the display of a user interface page on a user device 132 of the organization 106, and receives relative weights for each key performance indicator via the user interface page and user device 132 at step 244. After receiving weights for all of the key performance indicators that combine to equal one hundred percent (100%), the server computer system 130 stores the received weights for future use. When the sponsoring organization 106 desires to monitor or review its impact, the server computer system 130 retrieves and aggregates the then current values of the key performance indicators for the opportunities 108 that the organization 108 has sponsored at step 246. Then, at step 248, the server computer system 130 retrieves the weights previously provided by the sponsoring organization 106 from the database 142 and applies the weights to the actual values of the key performance indicators as described above to determine the weighted values of the key performance indicators. Next, at step 250, the server computer system 130 causes the user device 132 of the sponsoring organization 106 to display both the actual and weighted values of the key performance indicators for review and consideration by the organization 106.

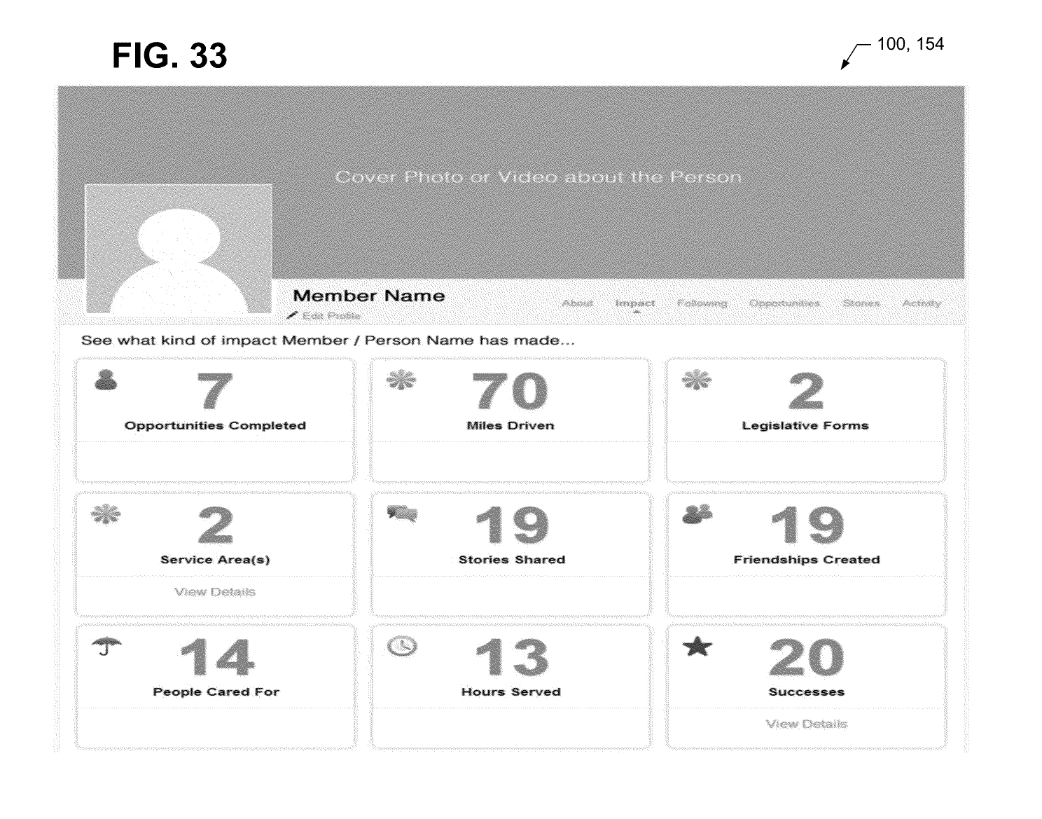

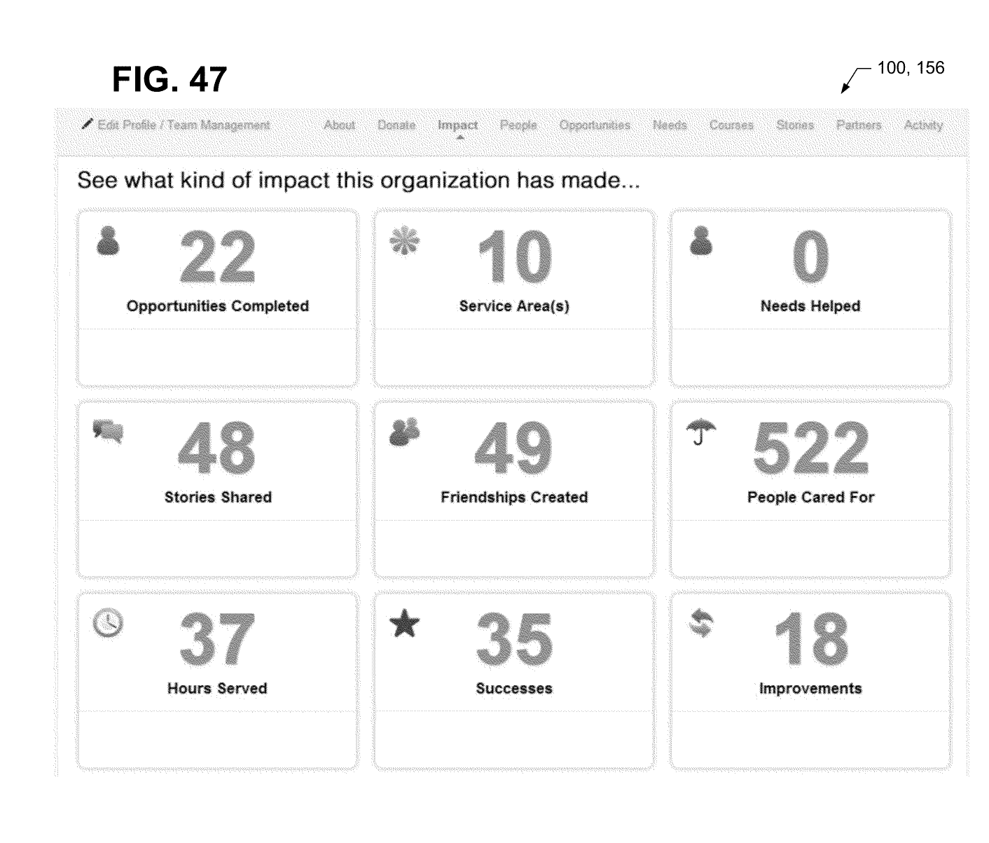

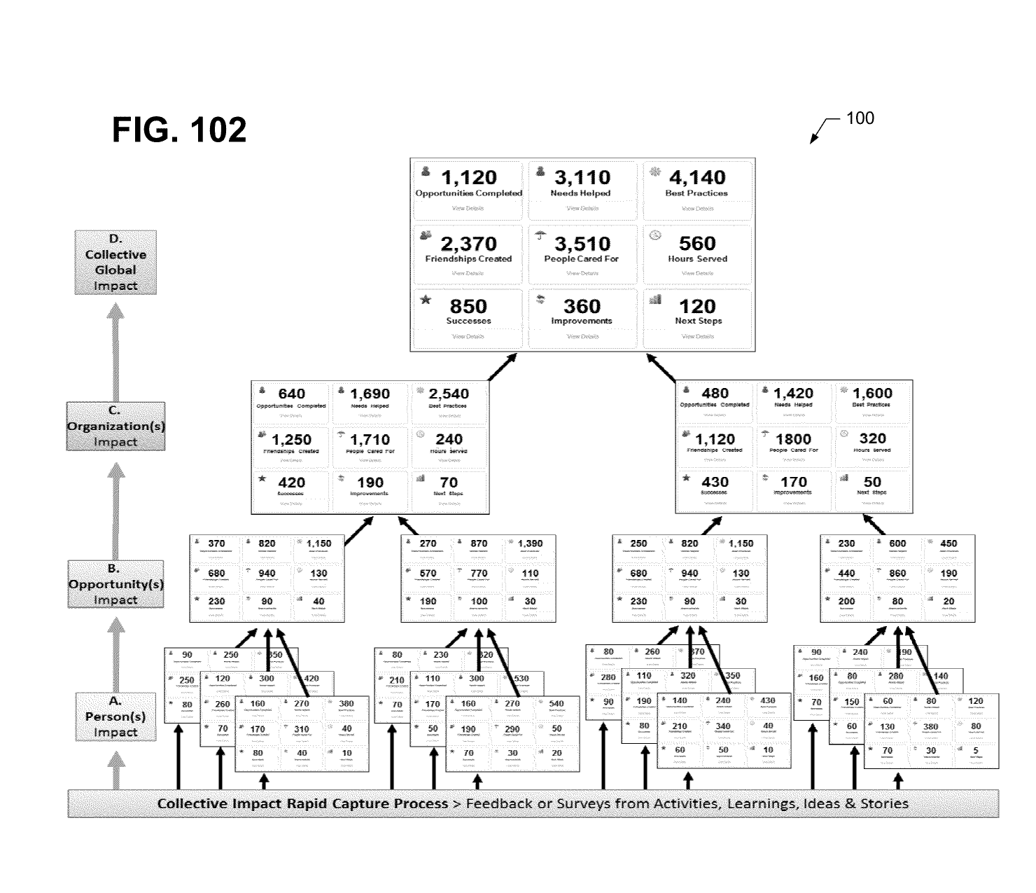

Notably, the system 100 enables impact to be monitored and assessed collectively. When such monitoring and assessment is desired, a system user may instruct the system 100 via a user device 132 and the server computer system 130 receives such instruction to produce and display a multi-level view of the system's impact as illustrated in FIG. 102. In response to receiving such instruction, the server computer system 130 retrieves the values of the key performance indicators for each of the system's members 104 (see FIG. 33) at step 252. Then, at step 254, the server computer system 130 determines the values of the key performance indicators for each of the system's opportunities 108 by aggregating the values of the key performance indicators for the respective opportunities 108 in which the members 104 participated (similar to FIG. 33, but for opportunities 108), thereby enabling an assessment of each opportunity's impact. Subsequently, at step 256, the server computer system 130 aggregates the values of the key performance indicators for the opportunities 108 sponsored by an organization 106 (see FIG. 47) in order to determine the impact of the organization 106. And, at step 258, the server computer system 130 determines the collective impact of the system 100 (see FIG. 102) by aggregating all of the key performance indicators for the sponsoring organizations 106. Then, at step 260, the server computer system 130 causes the display of an image substantially similar to that of FIG. 102 on the user device 132 of the user showing the various levels of aggregation and roll-up of key performance indicators used to determine the impacts of members 104, opportunities 108, organizations 106, and the system 100. At step 262, operation of the system 100 according to operating method 200 ends.

Whereas the present invention has been described in detail above with respect to example embodiments thereof, it should be appreciated that variations and modifications might be effected within the spirit and scope of the present invention, as described herein before and as defined in the appended claims.

What is claimed is:

1. A method performed by a computer or mobile device for operating a service wherein a person, an organizational entity, and an opportunity are identified as potentially having synergy, commonality or alignments, whereby the subsequent collaboration results in an impact.

2. The method of claim 1, wherein the result of a synergy, commonality or alignment between a person and another person results in an association for collaboration.

3. The method of claim 1, wherein the result of a synergy, commonality or alignment between a person and an organization results in an association for collaboration.

4. The method of claim 1, wherein the result of a synergy, commonality or alignment between a person and an opportunity results in results in an association for collaboration.

5. The method of claim 1, wherein the result of a synergy, commonality or alignment between a person and an organization and an opportunity results in an association for collaboration.

6. The method of claim 1, wherein the result of a synergy, commonality or alignment between a person and an organization and an opportunity is identified automatically using a number of common intersection points.

7. The method of claim 1, wherein the system receives feedback from a person, opportunity owner, or organization on criteria to assess the impact of the person, opportunity or organization.

8. The method of claim 7, wherein the feedback criteria are assembled into a format to collectively roll-up this criterion into a visual representation of the impact.

9. The method of claim 7, wherein the system receives feedback from the person to assess the effectiveness, learning or new ideas as a result of the activities from the interaction with other people, organizations or opportunities.

10. The method of claim 7, wherein the system receives feedback from the opportunity owner to assess the effectiveness, learning or new ideas as a result of the activities from the interaction with other people, organizations or opportunities.

11. The method of claim 7, wherein the system receives feedback from the organization to assess the effectiveness, learning or new ideas as a result of the activities from the interaction with other with other people, organizations or opportunities.

12. The method of claim 1, wherein the presentation or visualization of the primary links prominently within the computer or mobile device is constructed in a manner for easy identification for the synergies and commonalities between a person or persons, organization or organizations, and opportunity or opportunities.
